(19) United States
(12) Patent Application Publication
(10) Pub. No.: US 2010/0021166 A1
(43) Pub. Date: Jan. 28, 2010

(54) Spectrally Efficient Parallel Optical WDM Channels for Long-Haul MAN and WAN Optical Networks

(76) Inventor: Winston I. Way, Irvine, CA (US)

Correspondence Address: FISH & RICHARDSON, PC, P.O. BOX 1022, MINNEAPOLIS, MN, 55440-1022, US

(21) Appl. No.: 12/391,256

(22) Filed: Feb. 23, 2009

Related U.S. Application Data
(60) Provisional application No. 61/030,936, filed on Feb. 22, 2008.
(60) Provisional application No. 61/096,730, filed on Sep. 12, 2008.

(51) Int. Cl. H04J 14/02

(52) U.S. Cl. 398/79

(57) ABSTRACT

Techniques, apparatus and systems for optical WDM communications that use spectrally efficient parallel optical WDM channels for WAN and MAN networks.

### PRIORITY CLAIM

This document claims the benefits of U.S. Provisional Application No. 61/030,936 entitled “SPECTRALLY EFFICIENT PARALLEL OPTICAL WDM CHANNELS FOR LONG-HAUL MAN AND WAN OPTICAL NETWORKS” and filed on Feb. 22, 2008, and U.S. Provisional Application No. 61/096,730 entitled “SPECTRALLY EFFICIENT PARALLEL OPTICAL WDM CHANNELS FOR LONG-HAUL MAN AND WAN OPTICAL NETWORKS” and filed on Sep. 12, 2008, which are incorporated by reference as part of the disclosure of this document.

### BACKGROUND

This document relates to optical communications based on optical wavelength-division multiplexing (WDM).

Optical WDM communication systems transmit multiple optical channels at different WDM carrier wavelengths through a single fiber. The infrastructures of many deployed optical fiber networks today are based on 10 Gb/s per channel. As the demand for higher transmission speeds increases, there is a need for optical networks at 40 Gb/s, 100 Gb/s or higher speeds per channel. For short-haul transmission distances of less than 40 km, various proposals in the IEEE 802.3ba provide short-haul 100 GbE and 40 GbE interfaces including use of parallel or serial optical channels in the form of different optical WDM wavelengths carried in a single fiber, or different parallel optical signals that are respectively carried in different parallel optical ribbon cables. It is unclear at this time how 100 GbE/40 GbE transmission should be carried out in a metropolitan area network (MAN) or wide area network (WAN) beyond 40 km.

### SUMMARY

This document describes techniques, apparatus and systems for optical WDM communications that use spectrally efficient parallel optical WDM channels for WAN and MAN networks.

In one aspect, an optical WDM communication device for providing communications between client side equipment and a fiber network includes client side optical receivers as client side input ports to receive from the client side equipment, respectively, parallel client side optical signals each having a client side data rate at approximately 10 Gb/s and to produce electrical signals that respectively correspond to the optical WDM signals. The sum of the client side data rates of the client side optical WDM signals is comparable to or greater than 40 Gb/s. This device includes signal processing circuits that respectively receive and process the electrical signals, and line side optical transmitters that receive the electrical signals from the signal processing circuits, respectively, to produce a plurality of line side optical WDM signals at different WDM wavelengths carrying the electrical signals at a data symbol rate with a total capacity comparable to or greater than 40 Gb/s and with a total bandwidth within an International Telecommunication Union (ITU) spectral window. A WDM multiplexer is included in this device to multiplex the line side optical WDM signals to produce a line side output WDM signal for transmission over the fiber network. A WDM demultiplexer is included in this device to receive from the fiber network an input line side optical WDM signal containing line side optical WDM signals and separate the received input line side optical WDM signal into the line side optical WDM signals. This device also includes line side optical receivers to receive, respectively, the line side optical WDM signals and to produce line side electrical signals that respectively correspond to the line side optical WDM signals, signal processing circuits that respectively receive and process the line side electrical signals and client side optical transmitters that receive the line side electrical signals from the line side signal processing circuits, respectively, to produce a plurality of client side parallel optical signals to the client side equipment carrying the line side electrical signals each at the client side data rate of approximately 10 Gb/s.

In another aspect, an optical WDM communication device for providing communications between client side equipment and a fiber network includes client side electrical input ports to receive from the client side equipment, respectively, a plurality of client side electrical signals each having a client side data rate at approximately 10 Gb/s, and signal processing circuits that respectively receive and process the electrical signals. The sum of the client side data rates of the client side electrical signals is comparable to or greater than 40 Gb/s. This device includes line side optical transmitters that receive the electrical signals from the signal processing circuits, respectively, to produce a plurality of line side optical WDM signals at different WDM wavelengths carrying the electrical signals at a data symbol rate with a total capacity greater than 40 Gb/s. The line side optical WDM signals at different WDM wavelengths are located within a spectral window of 50 GHz or 100 GHz under the International Telecommunication Union, Telecommunication Sector (ITU-T) and have a frequency spacing between two adjacent optical WDM signals comparable to the symbol date rate or greater than the symbol data rate up to approximately two times of the data symbol rate. This device includes a WDM multiplexer that multiplexes the line side optical WDM signals to produce a line side output WDM signal. A WDM demultiplexer is included in this device to receive an input line side optical WDM signal containing line side optical WDM signals at the data symbol rate comparable to a frequency spacing between two adjacent optical WDM signals or less than the frequency spacing but greater than one half of the frequency spacing and separates the received input line side optical WDM signal into the plurality of line side optical WDM signals. Line side optical receivers are provided in this device to receive, respectively, the line side optical WDM signals and to produce line side electrical signals that respectively correspond to the line side optical WDM signals. This device also includes signal processing circuits that respectively receive and process the line side electrical signals from the line side optical receivers to produce client side electrical signals each at the client side data rate of approximately 10 Gb/s; and client side electrical ports that receive the client side electrical signals from the line side signal processing circuits, respectively.

In another aspect, an optical WDM communication device includes an electrical time-division-multiplexing (TDM) demultiplexer connected to receive a client side electrical signal having a client side data rate at approximately 40 Gb/s and to split the client side electrical signal into a plurality of parallel electrical signals at approximately 10 Gb/s, signal processing circuits that respectively receive and process the electrical signals, and line side optical transmitters that receive the electrical signals from the signal processing circuits, respectively, to produce a plurality of line side optical WDM signals at different WDM wavelengths. The line side optical WDM signals at different WDM wavelengths are located within an ITU spectral window and each line side optical WDM signal carries data in log₂M different client side electrical signals so that a number of the line side optical WDM signals is 1/log₂M of a number of client side electrical signals where M is the number of constellations. This device also includes a WDM multiplexer that multiplexes the line side optical WDM signals to produce a line side output WDM signal, a WDM demultiplexer that receives an input line side optical WDM signal containing line side optical WDM signals and separates the received input line side optical WDM signal into line side optical WDM signals, line side optical receivers to receive, respectively, the line side optical WDM signals and to produce line side electrical signals from the line side optical WDM signals, signal processing circuits that respectively receive and process the line side electrical signals, and a TDM multiplexer with skew control that combines the line side electrical signals into a client electrical signal at a data rate that is a sum of data rates of the line side electrical signals.

In another aspect, a method is provided for providing long-haul optical communications at data bit rates of 40 Gb/s or higher in a fiber system designed for low data bit rates approximately at 10 Gb/s. This method includes performing low-pass signal filtering to each of low rate electronic signals with a data bit rate approximately at 10 Gb/s to produce a plurality of filtered electronic signals, thus reducing adjacent-channel interference and an inter-symbol-interference effect, and applying a spectrally efficient signal modulation scheme to modulate CW laser beams at different optical carrier wavelengths by using the filtered electronic signals to produce optical WDM channel signals that respectively carry data of low rate electronic signals and have a channel spacing comparable to a data symbol rate of the low speed electronic signals or greater than the data symbol rate up to approximately twice the data symbol rate. This method also includes controlling polarization of each of the optical WDM channel signals to make two optical WDM channel signals adjacent in optical frequency orthogonally polarized to each other, and combining the optical WDM channel signals into a single fiber connected to the fiber system designed for the low data bit rate to transmit the optical WDM channel signals in the fiber system.

In another aspect, a method is provided for upgrading a long-haul optical fiber communication system designed for aggregating 10 Gb/s signals to transmit signals at high data bit rates of 40 Gb/s or higher. This method includes maintaining existing fiber network infrastructure without modification, converting a high speed signal at a high data bit rate of 40 Gb/s or higher to be transmitted in the system, in each communication node in the system, into low speed electronic signals at the low data bit rate, and applying a spectrally efficient signal modulation scheme to modulate a plurality of optical carriers at different optical carrier wavelengths to produce optical WDM channel signals that carry the low speed electronic signals at a data symbol rate approximately equal to 10 Gbaud and with a total capacity greater than 40 Gb/s. The optical WDM channel signals at different WDM wavelengths are located within an ITU spectral window under ITU-T and have a frequency spacing between two adjacent optical WDM channel signals comparable to the symbol date rate or greater than the symbol data rate up to approximately two times of the data symbol rate. This method also includes combining the optical WDM channel signals into a single fiber connected to the fiber system to transmit the optical WDM channel signals through the existing fiber network infrastructure to another node.

In another aspect, an optical WDM communication device is provided to include client side optical receivers as client side input ports to receive, respectively, client side optical WDM signals at different WDM wavelengths and to produce client side electrical signals that respectively correspond to the optical WDM signals, a transmitter signal processing circuit that receives and processes the client side electrical signals to produce a different number of line side electrical signals each at a line side data rate that is different from a data rate of each client side electrical signal, line side optical transmitters that receive the line side electrical signals, respectively, to produce line side optical WDM signals at different WDM wavelengths carrying the electrical signals at a data symbol rate with a total capacity greater than 40 Gb/s, and a WDM multiplexer that multiplexes the line side optical WDM signals to produce a line side output WDM signal. The line side optical WDM signals at different WDM wavelengths are located within a spectral window of 50 GHz or 100 GHz and have a frequency spacing between two adjacent optical WDM signals comparable to the symbol date rate or greater than the symbol data rate up to approximately two times of the data symbol rate. This device also includes a WDM demultiplexer that receives an input line side optical WDM signal containing line side optical WDM signals at the data symbol rate comparable to a frequency spacing between two adjacent optical WDM signals or less than the frequency spacing but greater than one half of the frequency spacing and separates the received input line side optical WDM signal into line side optical WDM signals, line side optical receivers to receive, respectively, the line side optical WDM signals and to produce line side electrical signals that respectively correspond to the line side optical WDM signals, a receiver signal processing circuit that receives and processes the line side electrical signals to produce a different number of client side electrical signals each at the client side data rate that is different from the line side data rate of each line side electrical signal, and client side optical transmitters that receive the client side electrical signals, respectively, to produce client side optical WDM signals at different WDM wavelengths carrying the client side electrical signals.

In another aspect, an optical fiber communication system is provided for long-haul communications at high data bit rates of 40 Gb/s or higher and includes an optical fiber transport network including long-haul fiber communication links that are designed for transmitting optical WDM signals at 10 Gb/s with acceptable signal transmission quality under optical impairments caused by optical effects including at least chromatic dispersion, polarization mode dispersion and optical noise associated with the low data bit rate, a first communication node connected to the optical fiber transport network, and a second communication node connected to the optical fiber transport network. The first communication node includes an electronic communication device that produces a high-speed electronic signal at a high data bit rate of 40 Gb/s or higher to be transmitted in the optical fiber transport network, an electronic time-division-multiplexing (TDM) demultiplexer connected to receive the high-speed electronic signal and splits the high-speed electronic signal into parallel low-speed electronic signals at a data rate of approximately 10 Gb/s, short-haul electronic-to-optical conversion modules that respectively receive the parallel low-speed electronic signals and respectively convert the received parallel low-speed electronic signals into parallel optical signals that respectively carry the parallel low-speed electronic signals, a short-haul optical link that connects to the short-haul electronic-to-optical conversion modules to transmit the parallel optical signals, short-haul optical-to-electronic conversion modules connected to the short-haul optical link to respectively receive and convert the parallel optical signals into intermediate parallel low-speed electronic signals at approximately 10 Gb/s, and long-haul electronic-to-optical conversion modules that respectively receive the parallel intermediate low-speed electronic signals at approximately 10 Gb/s and respectively convert the received parallel intermediate low-speed electronic signals into parallel long-haul optical signals of different optical WDM wavelengths at a predetermined low data bit rate of approximately 10 Gb/s that respectively carry the parallel intermediate low-speed electronic signals. The long-haul electronic-to-optical conversion modules perform a spectrally efficient signal modulation in either the electronic domain or the optical domain at the predetermined low data bit rate of approximately 10 Gb/s and a predetermined data symbol rate of approximately 10 Gbaud in producing the parallel long-haul optical signals. The frequency spacing between two adjacent WDM wavelengths is comparable to 10 GHz or greater than the data symbol rate up to approximately twice the data symbol rate. An optical WDM multiplexer is provided to receive the parallel long-haul optical signals from the long-haul electronic-to-optical conversion modules and combine the parallel long-haul optical signals into a single optical fiber link to the optical fiber transport network. The second communication node includes an optical WDM demultiplexer that receives the parallel long-haul optical signals from the optical fiber transport network and separates the parallel long-haul optical signals along parallel optical paths, one long-haul optical signal per path, respectively, long-haul optical-to-electronic conversion modules that are respectively connected in the parallel optical paths to convert the parallel long-haul optical signals into low-speed electronic signals at approximately 10 Gb/s, respectively, short-haul electronic-to-optical conversion modules that respectively receive the parallel 10 Gb/s electronic signals and respectively convert the received parallel 10 Gb/s electronic signals into parallel optical signals that respectively carry the parallel 10 Gb/s electronic signals, a short-haul optical link that connects to the short-haul electronic-to-optical conversion modules to transmit the parallel optical signals, short-haul optical-to-electronic conversion modules connected to the short-haul optical link to respectively receive and convert the parallel optical signals into intermediate parallel 10 Gb/s electronic signals, and an electronic TDM multiplexer with skew control connected to receive the intermediate low-speed electronic signal and combine the intermediate 10 Gb/s electronic signal into a high-speed electronic signal at a high data rate greater than the predetermined low data bit rate.

In another aspect, an optical DWDM optical transceiver is provided for optical communications at data bit rates of 40 Gb/s or higher per ITU-window and includes two or more optical transceivers arranged to collectively transmit and receive signals at 40 Gb/s or higher with each optical transceiver being operated at 20 Gb/s.

In yet another aspect, an optical fiber communication system for long-haul communications at high data bit rates of 40 Gb/s or higher is provided to include an optical fiber transport network comprising long-haul fiber communication links that are designed for transmitting optical WDM signals at a approximately 10 Gb/s with acceptable signal transmission quality under optical impairments caused by optical effects including at least chromatic dispersion, polarization mode dispersion and optical noise associated with the low data bit rate. This system includes first and second communication nodes connected to the optical fiber transport network. The first communication node includes an electronic communication device that produces a high-speed electronic signal at a high data bit rate of 40 Gb/s or higher to be transmitted in the optical fiber transport network, an electronic time-division-multiplexing (TDM) demultiplexer connected to receive the high-speed electronic signal and splits the high-speed electronic signal into parallel low-speed electronic signals at a data rate not greater than the predetermined low data bit rate; long-haul electronic-to-optical conversion modules that respectively receive the parallel low-speed electronic signals into a plurality of parallel long-haul optical signals of different optical WDM wavelengths at a data rate not greater than the predetermined low data bit rate of approximately 10 Gb/s, and an optical WDM multiplexer that receives the parallel long-haul optical signals from the long-haul electronic-to-optical conversion modules and combines the parallel long-haul optical signals into a single optical fiber link to the optical fiber transport network. The second communication node includes an optical WDM demultiplexer that receives the parallel long-haul optical signals from the optical fiber transport network and separates the parallel long-haul optical signals along parallel optical paths, one long-haul optical signal per path, respectively, long-haul optical-to-electronic conversion modules that are respectively connected in the parallel optical paths to convert the parallel long-haul optical signals into low-speed electronic signals, respectively, and an electronic TDM multiplexer connected to receive the low-speed electronic signal and combine the low-speed electronic signal into a high-speed electronic signal at a high data rate.

These and other aspects, and their implementations, variations and enhancements are described in details in the drawings, the description and the claims.

### BRIEF DESCRIPTION OF THE DRAWINGS

FIGS. 1A, 1B, 1C, 1D show examples of optical communication systems based on spectrally efficient parallel WDM signal paths.

FIGS. 2A, 2B, 2C and 2D show exemplary implementations of the systems in FIGS. 1A, 1B, 1C, 1D with specific exemplary designs for communication line cards connected between the client side equipment and line side network.

FIGS. 3 and 4 show examples of optical communication systems that use baseband signal modulation at the transmitter side and optical signal demodulation at the receiver side in implementing described ultra-dense WDM techniques and use of spectrally efficient signal modulation.

FIGS. 5A and 5B show an example of baseband signal modulation at the transmitter side and optical signal demodulation at the receiver side based on the differential quadrature phase shift keying (DQPSK) modulation.

FIG. 6 show an example of an optical communication system that uses microwave-millimeter-wave signal modulation at the transmitter side and optical signal demodulation at the receiver side in implementing described ultra-dense WDM techniques and use of spectrally efficient signal modulation.

FIGS. 7, 8, 9A, 9B, 10A, 10B and 10C show examples of optical communication systems that use microwave/millimeter-wave signal modulation at the transmitter side and microwave/millimeter-wave signal demodulation at the receiver side in implementing described ultra-dense WDM techniques and use of spectrally efficient signal modulation.

FIGS. 11, 12A and 12B show examples of optical communication systems that produce an optical local oscillator signal for optical heterodyne detection at the receiver in implementing described ultra-dense WDM techniques and use of spectrally efficient signal modulation.

FIGS. 13A and 13B shows examples of a protection mechanism in implementing described ultra-dense WDM techniques and use of spectrally efficient signal modulation.

FIGS. 14A-17 show examples of optical single sideband modulation (OSSB) based on microwave subcarrier modulation with a Mach-Zehnder optical modulator.

FIGS. 18-22 show examples of optical double sideband modulation (ODSB) based on microwave subcarrier modulation with a Mach-Zehnder optical modulator.

FIGS. 23A and 23B illustrate two modes of operations of two microwave/millimeter-wave mixers with a baseband leakage signal.

FIGS. 24A, 24B, 25A and 25B show two examples for generating spectrally efficient OSSB and ODSB modulation techniques.

FIGS. 26 and 27 illustrate a use of 20-G parallel optical channels to make 40 GbE equipment and 100 GbE equipment compatible.

FIG. 28 shows an example of a system where 20 G WDM units are used as building blocks for a 100 G transceiver line card.

FIG. 29 shows an example system where each optical transmitter implements both polarization multiplexing and polarization scrambling.

FIGS. 29A and 29B show, respectively, an example of an optical transmitter part and an example of an optical receiver part based on the polarization multiplexing design in FIG. 29.

FIG. 30 shows an example of microwave phase control of individual RF carriers in an optical comb generator for use in optical communication systems based on spectrally efficient parallel WDM signal paths.

FIG. 31 shows an example of a line card for producing spectrally efficient parallel WDM signal paths with a rate conversion mechanism.

### DETAILED DESCRIPTION

Optical fiber exhibits various optical effects that can degrade the signal quality of an optical signal in optical fiber. Such optical effects in optical fiber include chromatic dispersion (CD), polarization mode dispersion (PMD), polarization dependent loss (PDL), optical loss (e.g., optical absorption and scattering), and nonlinear optical effects. Various chromatic dispersion compensation devices and PMD compensation devices can be implemented in a fiber link to mitigate dispersion effects. For a given fiber link, as the data bit rate carried by the optical signal increases, the impact on the signal quality of these optical effects increases and leads to various system penalties. In addition, for a given data bit rate of an optical signal transmitting in a given fiber link, the impact on the signal quality of these optical effects increases with the transmission distance. Therefore, in order to achieve a certain optical signal to noise ratio (OSNR) and data bit error rate (BER) in transmitting an optical signal through a given fiber link, the transmission distance and the data bit rate of the signal need be balanced. For example, for a given data bit rate, there is a maximum transmission distance set by the various optical effects in order to maintain acceptable OSNR and BER for the transmission performance. As the data bit rate increases, the maximum transmission distance needs to decrease accordingly to maintain the acceptable OSNR and BER.

The apparatus, optical WDM networks and techniques described in this document can be used to transport optical signals at high data rates (e.g., 40 G or beyond) using parallel lower data rate signals over a fiber network such as a long-haul fiber network system that was originally designed for transporting lower data rate signals. In this document, the number associated with each of the symbol rates and data rates may vary around the stated rate within a range, e.g., about 10˜40% of the stated rate. For example, a client-side 10 Gb/s rate may vary from a rate of 9.953 Gb/s for OC-192 to a rate of 14 Gb/s for an enhanced FEC-encoded 10 Gb/s signal. For another example, a rate of 40 Gb/s may be implemented at a number between 36 Gb/s and 44 Gb/s based on the specific requirements and needs of a particular implementation. Such a long-haul parallel transmission system using parallel lower data rate signals can be structured to provide the same spectral efficiency and capacity as a long-haul serial transmission system carrying the high data rate at 40 G or beyond. Such a system can be structured to split a high data rate serial signal into parallel signals of lower data rates and allow a high data bit signal to be transmitted in form of parallel lower data bit rate signals in the optical domain over an incumbent long distance link originally designed for transmitting lower data bit rate signals. The incumbent long distance link may have a limited tolerance to signal degradation caused by CD, PMD and OSNR effects and of the systems described in this document use spectrally efficient optical channels to provide densely packed optical WDM channels to be transmitted within a given optical spectral bandwidth to increase the data capacity in the incumbent long distance fiber link.

Notably, the apparatus, optical WDM networks and techniques described in this document can reuse an existing incumbent fiber infrastructure that is originally designed for transmission of optical signals carrying signals at a lower data bit rate (e.g., 10 Gb/s) to transmit signals at a higher data bit rate (e.g., 40 Gb/s, 100 Gb/s or higher) without significantly changing the existing incumbent fiber infrastructure. Furthermore, as defined in IEEE 802.3ba, in which a short-haul local area network (LAN) in communication with the long-haul system uses parallel optical channels at different optical WDM wavelengths to carry a high data rate signal, such a long-haul WAN/MAN fiber system can implement the present spectrally-efficient parallel optical channels for 100 GbE/40 GbE transmission to interface with a short-haul LAN with parallel optical channels in an one-to-one correspondence between an LAN optical channel and an WAN/MAN optical channel. Such implementation can be used to eliminate the need for serializer/de-serializer modules used between parallel LAN and serial WAN/MAN. In this regard, this document provides various examples of optical communication system designs and transceiver line card designs based on wavelength-division multiplexing of parallel lower data rate optical channels and spectrally-efficient signal modulation techniques in generating such parallel lower data rate optical channels with a channel spacing in frequency that is comparable to or greater than the data symbol rate of each parallel optical channel. The channel spacing is comparable to the data symbol rate when the channel spacing is equal to or around the data symbol rate. A channel spacing greater than the data symbol rate can be up to approximately twice the symbol rate. In implementations, matching the channel spacing to the data symbol rate may require a synchronization mechanism which can complicate the hardware. When a channel spacing is around or greater than the data symbol rate without matching, the synchronization mechanism may be eliminated to simplify the hardware.

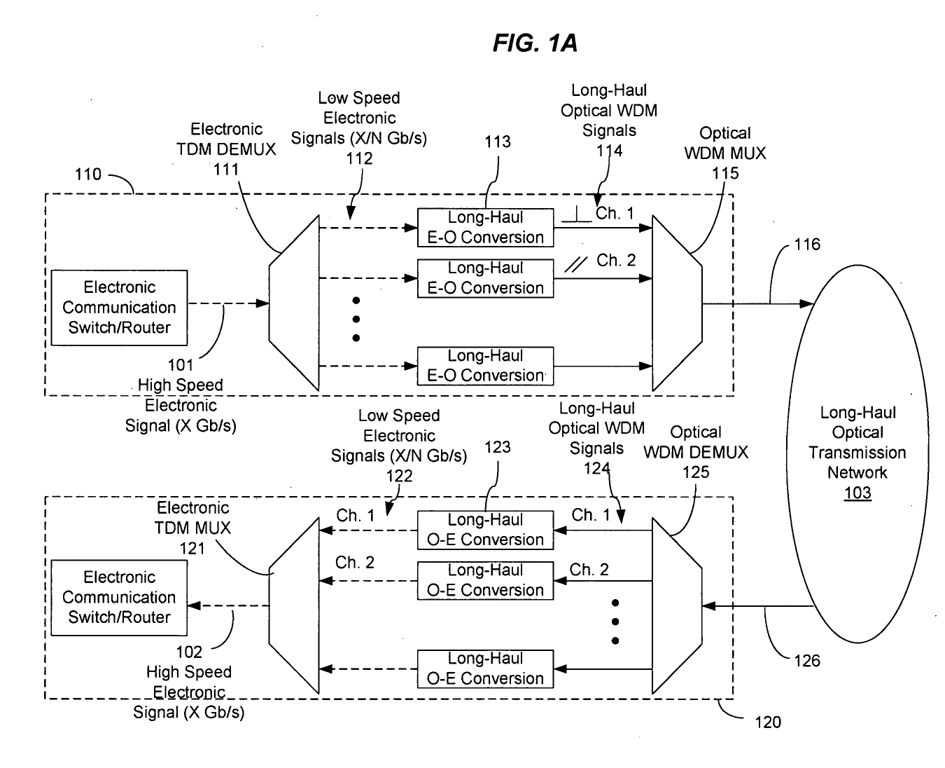

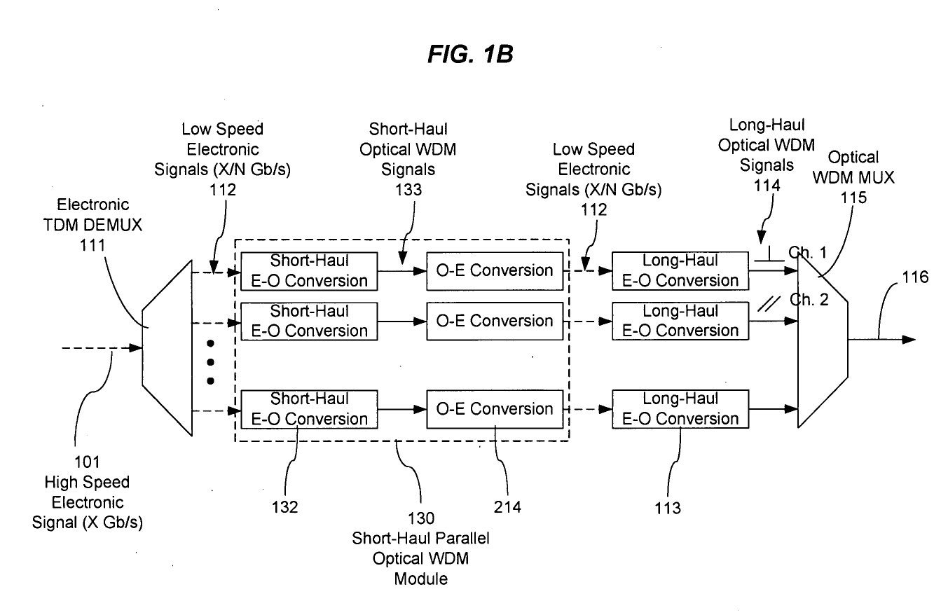

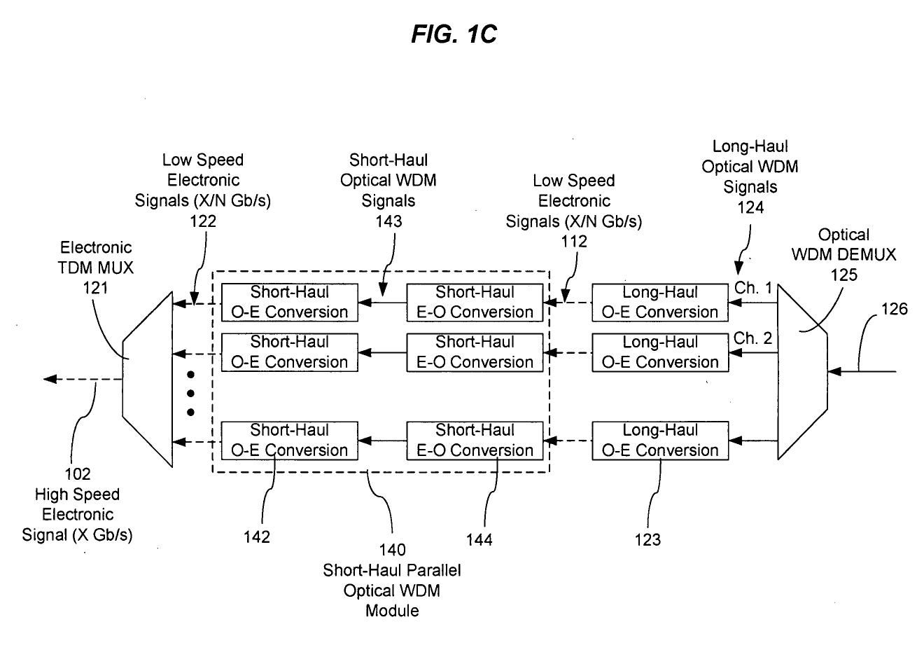

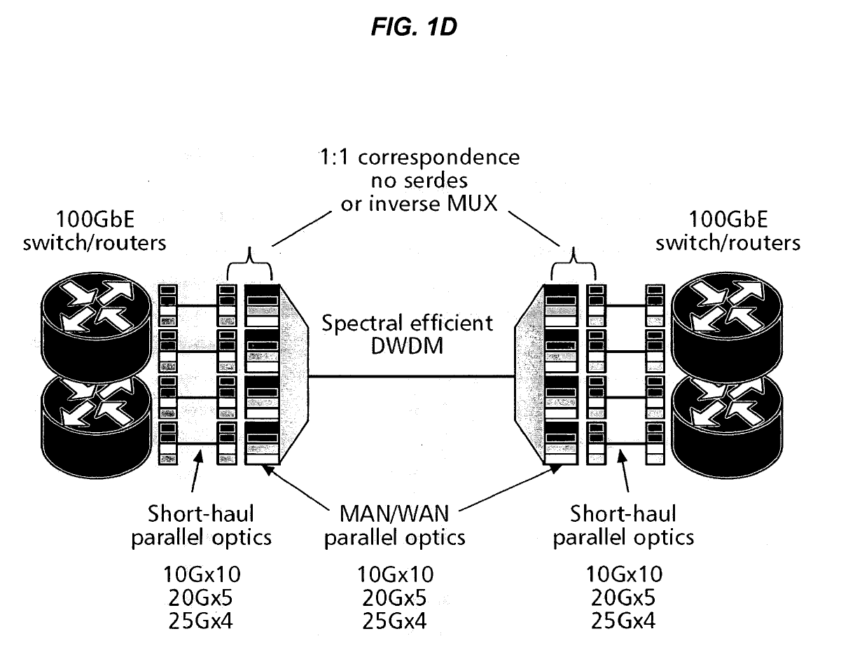

FIGS. 1A, 1B, 1C, 1D show examples of optical communication systems based on spectrally efficient parallel WDM signal paths. These examples show various devices, components and modules in the client side equipment, and transponder linecards between the client side equipment and line side fiber transmission network. Common to the illustrated systems is to provide a line side transmission at a high data rate based on parallel long-haul dense signals at the same wavelength or different wavelengths with a lower data rate for transmission in the fiber transmission network. Depending on the specific configurations on the client side equipment, lower rate parallel short-haul optical signals may also be used either in the client side equipment or for interfacing with the client side equipment. In some systems, the client side equipment may use parallel electronic signals at a lower data rate and thus eliminate the need for the lower rate parallel short-haul optical signals.

FIG. 1A shows an example of a long-haul WAN/MAN fiber system implementing parallel lower data rate optical channels and spectrally-efficient signal modulation for high speed transmission (e.g., 100 GbE/40 GbE). This example uses an optical transmitter subsystem 110 and an optical receiver subsystem 120 in communication with a long-haul optical transmission network 103. The subsystems 110 and 120 can be separated at two different locations or optical nodes in the long-haul network 103 or portions of the subsystems 110 and 120 can be integrated into an optical transceiver that includes the optical transmitter and receiver modules within an optical node in the long-haul network 103. Transponder linecards described in this document are examples of integrated interface devices that provide both transmit and receive functions to bridge client side equipment and the fiber network.

In the example in FIG. 1A, the optical transmitter subsystem 110 includes an electronic time division multiplexing (TDM) demultiplexer (DEMUX) or de-serializer 111 to receive a high speed electronic signal carrying data at a high data bit rate (X Gb/s). The TDM DEMUX 111 converts the signal 101 into multiple lower speed electronic signals 112 each at a low data bit rate of X/N (Gb/s) where N is the number of lower speed electronic signals 112. A skew control may be built into the TDM DEMUX 111 to re-align the parallel signal lanes. The parallel data after a long haul transmission may not be aligned in time due to fiber chromatic dispersion, and therefore skew control is needed. Such a skew control may add buffers to one or more fast lanes to slow down the signals in comparison with a signal in a slow lane. The TDM DEMUX 111 may be built into a DWDM transponder in some implementations and, in other implementations, the TDM DEMUX 111 may be built into a high speed switch or router, such as a 40 GbE/100 GbE switch/router defined by IEEE802.3ba. Long-haul electronic-to-optical conversion units 113 are used to directly receive the electronic signals 112 from the TDM DEMUX 111 and use the received electronic signals 112 to produce optical signals 114 at different optical WDM wavelengths that are modulated to carry lower speed electronic signals 112. This direct conversion from the parallel electronic signals 112 at a lower data bit rate to parallel optical signals 114 carrying the same or different lower data bit rate below the original data bit rate in the high speed signal 101 eliminates the need for short-haul parallel optical lanes used in other implementations described in this document.

The modulation of each signal 112 used in generating the optical WDM channel 114 uses a spectrally efficient modulation scheme in either the optical domain or the microwave/millimeter-wave domain for meeting the signal transmission requirements in the long-haul transmission so that the frequency spacing between two WDM wavelengths of the signals 114 can be comparable to a data symbol rate or greater than the data symbol rate up to approximately twice the data symbol rate under a dense WDM configuration while maintaining the optical cross talk between the two adjacent optical WDM channels below a threshold. In some implementations, there is a one to one correspondence between the electronic signals 112 and the optical signals 114. In other implementations, each optical signal 114 with a unique wavelength can carry two electronic signals 112 based on DQPSK, or log₂M electronic signals 112 based on M-PSK or M-QAM modulation.

As an example, each optical transmitter 113 cab be implemented to perform the signal modulation in a NRZ/OOK modulation format. The channel spacing between optical NRZ/OOK optical transmitters operating at approximately 10 Gb/s plus 7˜25% FEC overhead can be between 10 and 12.5 GHz

In addition, the optical polarizations or phases of the two adjacent optical WDM channels can be controlled to be orthogonal to each other to further reduce any optical coherent cross talk between adjacent optical WDM channels. As an example, the odd numbered optical WDM channels can be in a first linear polarization and the even numbered optical WDM channels can be in a second linear polarization perpendicular to the first linear polarization (polarization-interleaved). Polarization multiplexing (POLMUX) can also be carried out for two WDM channels with the same wavelength. As another example, a phase control among WDM channels in the microwave/millimeter-wave domain analogous to orthogonal frequency-division-multiplexing (OFDM) can be provided in such a way that the channel spacing is comparable to the data symbol rate but without resorting to digital discrete Fourier Transform (DFT) and inverse discrete Fourier Transform (IDFT) techniques. One example of the OFDM condition is described in Equation(1) in H. Sanjoh, et al, “Optical orthogonal frequency division multiplexing using frequency/time domain filtering for high spectral efficiency up to 1 bit/s/Hz”, Paper ThD1, Optical Fiber Communications Conference (OFC) 2002. In some implementations, POLMUX or polarization-interleaving can be combined with the present phase control of the WDM channels in the microwave/millimeter-wave domain to create a condition that two neighbor channels are not only polarization controlled, but also phase controlled.

Accordingly, the exemplary system in FIG. 1A provides an optical WDM multiplexer 115 to combine the different optical WDM channels 114 into a single fiber 116 in the optical transmission network 103. In the case of polarization-interleaving or POLMUX, the optical WDM multiplexer 115 may be implemented by one or multiple optical polarization beam combiners to combine the optical WDM channels 114 into the single fiber 116. Alternatively, a limited number of polarization-interleaved channels can be first combined via polarization combiners into a group, and each group is sent to a DWDM multiplexer that for further combination with other groups. For example, this DWDM multiplexer can be designed to have a channel spacing based on the ITU-T 100 GHz or 50 GHz grid.

The optical receiver subsystem 120 in this example is implemented to separate the different WDM channels in the received signal 126 and to perform signal demodulation to uncover the electronic signals 125 sent from a respective optical transmitter module 110. Various configurations for the optical receiver subsystem 120 are possible. The signal demodulation in the receiver subsystem 120 can be implemented, for example, by either optical demodulation or microwave-millimeter-wave demodulation. Detection at the receiver based on the optical demodulation can be implemented in various configurations, including, for example, (1) direct detection using optical demultiplexing to separate different WDM signals that carry data channels based on proper signal modulation such as duobinary and DQPSK and an array of photo-detectors to directly measure the WDM signals; (2) coherent homodyne detection where a local laser is used as a local oscillator whose wavelength is matched to the received wavelength; (3) coherent heterodyne detection where a local laser is used as a local oscillator whose wavelength is different from the received wavelength by a fixed difference; and (4) self-heterodyne coherent detection where a remote optical carrier is generated on the transmitter side and is sent to the receiver side to serve as a local oscillator at the receiver side. Detection at the receiver based on the microwave-millimeter-wave demodulation can be implemented in various ways, such as coherent heterodyne detection and self-heterodyne coherent detection.

In FIG. 1A, the optical receiver subsystem 120 includes an optical WDM DEMUX 125 to separate different optical WDM channels 124 in a fiber 126 in the network 103, long-haul optical-to-electronic conversion units 123 each operating to detect a respective optical WDM channel signal 124 and to produce a lower speed electronic signal 122 carried by the optical signal 124, and an electronic TDM MUX or serializer 121 (with skew control) to combine the lower speed electronic signals 122 into a high speed electronic signal 102. The optical DEMUX 125 in the receiver module 120 can separate different optical WDM channels with or without polarization discrimination. The long-haul optical-to-electronic conversion unit 123 can implement signal demodulation in either the optical domain or the microwave/millimeter-wave domain. The long-haul electronic-to-optical conversion module 113 can include a forward-error-correction (FEC) encoder and the long-haul optical-to-electronic conversion unit 123 can accordingly include a respective FEC decoder.

Under the above design in FIG. 1A, each optical WDM channel in the fiber network 103 carries data at the lower data bit rate so that the fiber infrastructure for the long-haul optical transmission network 103 can include fiber infrastructure designed for transmitting signals at the low data bit rate. The parallel lower data rate signals by the TDM DEMUX 111 and the spectrally efficient signal modulation by the long-haul electronic-to-optical conversion units 113 enable such a long-haul network 103 to transmit signals 101 at the higher data bit rate within an existing 50 or 100 GHz ITU-T window without changing its fiber infrastructure. This feature is significant in utilizing and updating existing fiber network infrastructure deployed years ago for high speed data communications at 40 Gb/s, 100 Gb/s and beyond. Notably, the majority of the existing optical fiber transport infrastructure worldwide is designed for transporting 10 Gb/s DWDM signals. The system tolerance for various optical signal impairments due to optical loss, optical CD/PMD/OSNR and nonlinear optical effects is designed for 10 Gb/s DWDM signals and therefore the OSNR and BER for transporting high speed DWDM signals at 40 Gb/s and 100 Gb/s may be degraded to be below the acceptable OSNR and BER values. The fiber infrastructure of the existing fiber system for 10 Gb/s can certainly be modified and upgraded for transporting high speed DWDM signals at 40 Gb/s and 100 Gb/s but such modification and upgrading can be expensive, labor intensive and time consuming. The techniques described in this document allow the same fiber infrastructure in the existing 10 Gb/s networks to transport optical DWDM signals carrying data at higher data rates of 40 Gb/s and 100 Gb/s by using new DWDM line card modules with optical transmitters that implement the present parallel lower data rate optical channels and spectrally-efficient signal modulation techniques and respective optical receivers for detecting such optical signals.

Transmitters and receivers based on the system design in FIG. 1A can be built into a 40 GbE/100 GbE switch/router and therefore the switch/router can directly interface with the TDM DEMUX 111, and the TDM DEMUX 121 can directly interface with the long-haul electronic-to-optical converters 113. As an example for implementing the system design in FIG. 1A, a transponder linecard can integrate TDM DEMUX 111, the long-haul electronic-to-optical conversion units 113 and the optical WDM MUX 115 in the optical transmitter part and the WDM DEMUX 125, the long-haul optical-to-electronic conversion units 123 and the TDM MUX 121 for bridging client equipment and the fiber network.

In other system implementations, a short-haul parallel optical physical layer with low-speed parallel optical channels may be deployed between a high-speed switch/router and a high-speed long-haul network. On the transmitter side, the short-haul parallel optical physical layer directly interfaces with the client-side switch or router and a serializer and a long-haul optical transmitter are connected between the short-haul parallel optical physical layer and the high-speed network to perform serial transmission. On the receiver side, an optical receiver is used to receive the high-speed optical WDM signal and a de-serializer is used to transform a high-speed channel signal into low-speed parallel signals that are transmitted via a receiver-side short-haul parallel optical physical layer with low-speed parallel optical channels to the receiver-side client high-speed switch or router. In such a system, the above long-haul parallel transmitter and receiver shown in FIG. 1A can be used to eliminate the serializer and the serial optical transmission on the transmitter side and to eliminate the de-serializer on the receiver side. As such, the electrical driver signals used to drive the long-haul parallel optical transmitters 113 shown in FIG. 1A can be used to directly interface with the short-haul parallel optical channels in a one-to-one correspondence. Same one-to-one correspondence applies to the electrical received signals from the long-haul parallel optical receivers 123 and the short-haul optical parallel optical channels. This design simplifies the interfacing for high-speed switches and routers in high-speed fiber networks.

FIGS. 1B and 1C show an example of this direct one-to-one interface between short-haul parallel optical channels and long-haul parallel optical channels in the transmitter side (assuming one electrical signal from a short-haul O-E converter drives one long-haul E-O converter) and the receiver side, respectively. In the transmitter design in FIG. 1B, a short-haul parallel optical WDM module 130 is implemented between the TDM demux 111 and the long-haul electrical to optical conversion units 113. The short-haul parallel optical WDM module 130 can be used to interface with the client side equipment and includes short-haul electronic to optical conversion modules 132 to use the lower speed electronic signals 112 to produce short-haul optical WDM channels 133 that respectively carry the lower speed electronic signals 112. The short-haul optical WDM channels 133 are directed to optical-to-electrical conversion modules 134, respectively, which produce the low-speed electronic signals 112 that are fed into the long-haul electrical-to-optical conversion modules 113 that produce the parallel long-haul optical signals for transmission over the network. The client side equipment may be configured to include various parts shown in FIG. 1B. For example, the client side equipment can include the electronic TDM DEMUX 111 and the electrical to optical conversion modules 132 in some implementations.

FIG. 1C shows an example of a direct one-to-one interface between short-haul parallel optical channels and long-haul parallel optical channels in the receiver side (assuming each long-haul O-E conversion only generates one electrical signal to interface with short-haul E-O) that corresponds to the transmitter side design in FIG. 1B. In the case when a long-haul O-E converter generates 2 or more electrical signals, the correspondence between the numbers of long-haul O-E to short-haul parallel optical channels becomes 1:N, where N≧2. A short-haul parallel optical WDM module 140 is used to receive the low-speed electronic signals 125 from the long-haul optical-to-electronic conversion modules 123, respectively. The short-haul parallel optical WDM module 140 includes electronic-to-optical conversion modules 144 to produce short-haul optical WDM channels 143 that carry the signals 125, respectively. Short-haul electrical-to-optical conversion modules 142 are used to covert the short-haul optical WDM channels 143 to the low-speed signals 125 which are combined by the TDM MUX 121 into the high-speed electronic signal 102 to the client side switch or router.

FIG. 1D illustrates an example of a high-speed optical WDM system where high-speed switches or routers are connected using both short-haul and long-haul parallel optical WDM channels with an one-to-one correspondence. The long-haul parallel optical signals are implemented in the parts labeled as “MAN/WAN parallel optics” in the transmitter side and the receiver side. For signals at 100 Gb/s, the short-haul and long-haul parallel optical WDM channels can be implemented as ten 10 G parallel optical WDM channels, five 20 G parallel optical WDM channels or four 25 G parallel optical WDM channels. This design of using lower rate optical transceiver modules (e.g., 10 G, 20 G or 25 G transceiver units) to build higher rate optical transceivers (e.g., 100 G) provides a scalable platform for building versatile optical WDM linecards between the client side equipment and the fiber transmission network. Specific examples of optical WDM transponder linecards for various client side equipment configurations are described in later sections of this document.

The above exemplary optical communication systems in FIGS. 1A, 1B, 1C, 1D and other systems based on spectrally efficient parallel WDM signal paths can be implemented in various configurations based on client side equipment configurations. A network communication transponder linecard, for example, can be designed to include selected transmitter side functions and selected receiver side functions and can be connected between the client side equipment and line side fiber network. The network communication transponder linecard can be configured to accommodate specific interfacing requirements of the client side equipment to provide high data transmission by using fiber infrastructure in the network designed for transmitting lower data rate signals.

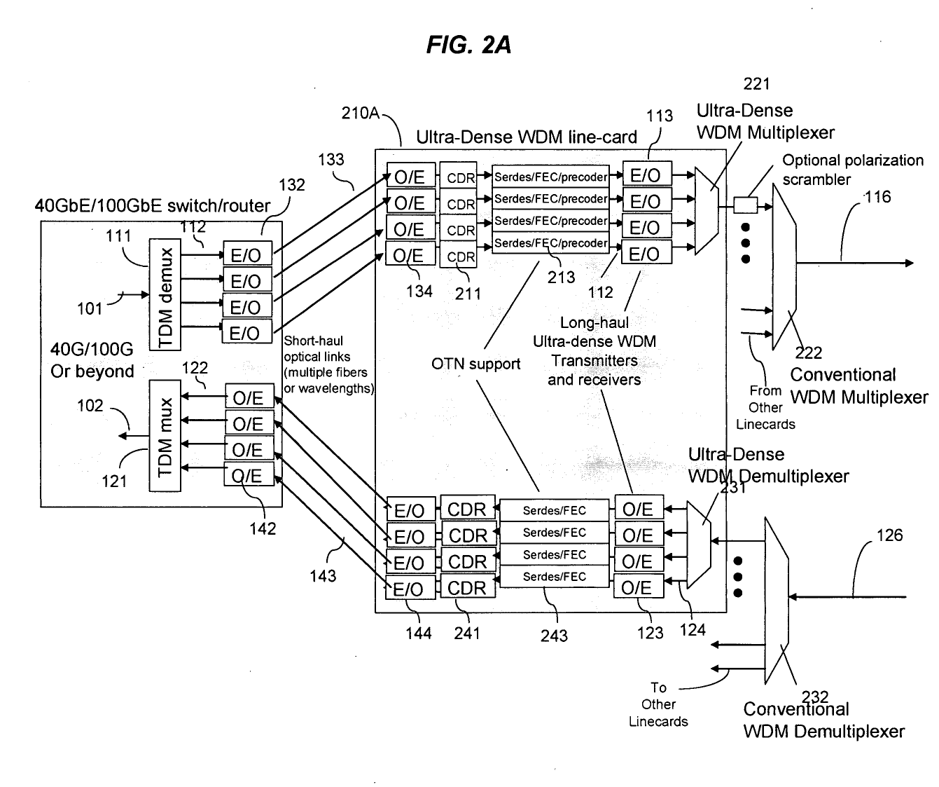

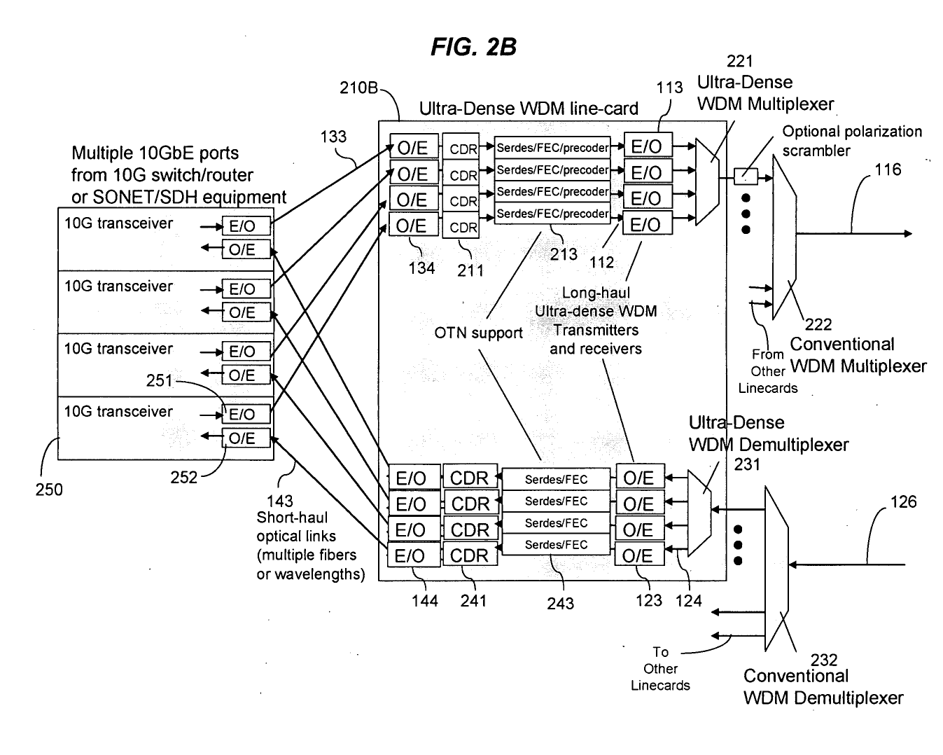

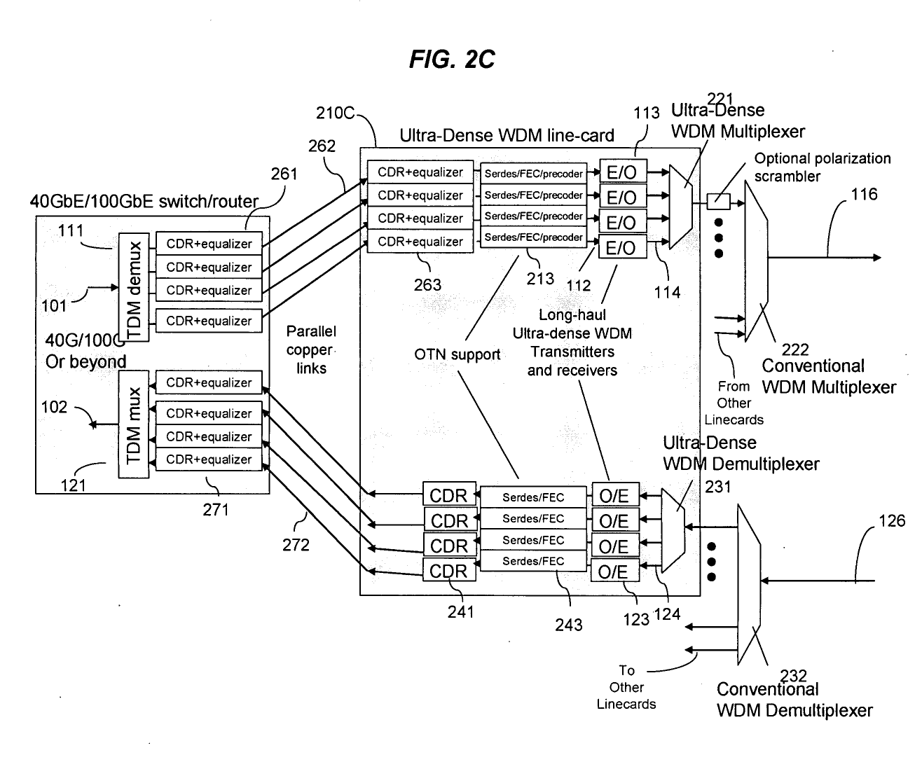

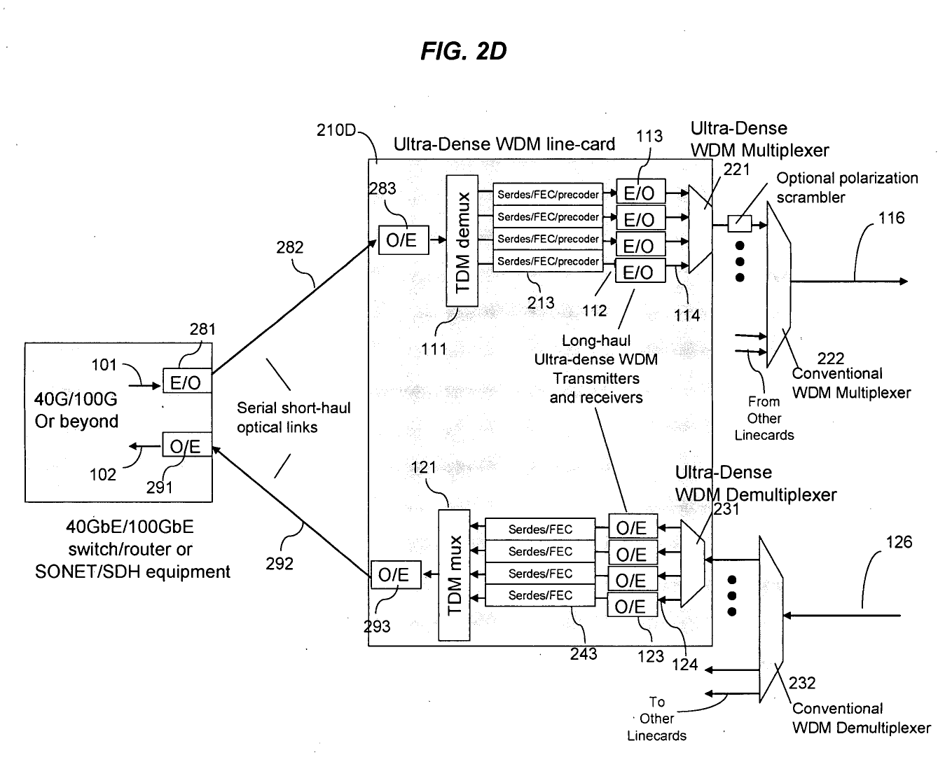

FIGS. 2A, 2B, 2C and 2D show examples of implementations of ultra-dense WDM transponder line cards for different client side equipment configurations for providing spectrally-efficient ultra-dense WDM transmission. Such a linecard has a client side interface that interfaces with the client side signals with the client side equipment and a line side interface that interfaces with the fiber network for communications. The client side signals can be in one or more signal formats, such as a combination of the 10 GbE, OC-192, OUT-2, 10 G Fiber Channel, or other 10 G protocols. As such, the client side receivers are configured to receive a combination of client side signals that are in different 10 G signal protocols, each of which can be, e.g., the 10 GbE, OC-192, OUT-2, 10 G Fiber Channel, or other 10 G protocols. The client side interface includes (1) a client side input port that receives one or more client side communication signals for transmission of data and signals from the client side equipment to the fiber network, and (2) a client side output port that outputs one or more client side communication signals based on data and signals received from the fiber network. Symmetric to the client side interface, the line side interface includes (1) a line side input port that receives a WDM signal that carries WDM channel signals from the fiber network for transmission to the client side equipment, and (2) a line side output port that outputs WDM channel signals for transmitting data received from the client side equipment to the fiber network. As such, each linecard is a 4-port transceiver device that facilitates communications between the client side equipment and the fiber network. Each line side optical transmitter can be operated at approximately 10 Gbaud (or 10 Gsymbols/s), which is equal to the client side data rate plus 7˜25% FEC overhead.

In FIG. 2A, the client side equipment is a switch/router that includes TDM DEMUX 111 and an array of electrical to optical converters 132 (i.e., optical transmitters) on the transmitter side and includes TDM MUX 121 and an array of optical to electrical converters 142 (i.e., optical detectors) on the receiver side. Such a router can be configured to comply with IEEE802.3ba for 40 GbE or 100 GbE transmission, for example. An ultra-dense WDM line card 210A is provided between the IEEE802.3ba 40/100 GbE switch/router and the fiber network. The line card 210A includes a transmitter part with a client side input port and a line side output port and a receiver part with a line side input port and a client side output port. The transmitter part includes an array of optical to electrical converters 134 that include optical detectors as part of the client side input port to receive short-haul parallel optical signals from the client side equipment, an array of electrical signal conditioning circuits such as clock and data recovery (CDR) circuits 211 and circuits 213 with various digital signal processing functions such as serializer/deserializer (Serdes), forward error correction (FEC) and precoder, and an array of electrical to optical converters 113 that include optical transmitters producing the long-haul parallel WDM optical channel signals for the long haul transmission over the fiber network. The array of optical to electrical converters 134 and the array of electrical to optical converters 132 in the client side equipment are linked by short haul optical links 133. The line side output optical signals of the electrical to optical converters 113 for the long haul transmission are closely spaced at an ultra dense WDM spacing and are within one spectral window under a standard of International Telecommunication Union, Telecommunication Sector (ITU-T). These line side output optical signals are directed to an ultra-dense WDM multiplexer 221 as the line side output port which produces an ultra-dense WDM signal as an output of the linecard. The WDM multiplexer can be implemented in various configurations, including an optical coupler or a polarization combiner.

The system may include two or more of the above described linecards arranged in parallel and the ultra-dense WDM signals from these linecards can be directed into a WDM multiplexer 222 that combines the ultra-dense WDM signals from the different linecards into the output WDM signal 116 for transmission over the fiber network or link. The WDM multiplexer 222 can be configured to have a channel spacing in compliance with the ITU-T 100 GHz or 50 GHz grid and may be located outside the linecard as part of a standard interface with the fiber network.

The receiver part of the line card 210A includes client side electrical to optical converters 144 that transmit short-haul parallel optical signals over short haul optical links 143 to the optical to electrical converters 142 on the client side, an array of electrical signal conditioning circuits such as CDR circuits 241 and circuits 243 with various digital signal processing functions such as Serdes and FEC functions, and an array of optical to electrical converters 123 that receive long-haul optical WDM signals from the fiber network. Hence, the optical transmitters in the client side electrical to optical converters 144 form the client side output port for the linecard 210A. A WDM demultiplexer 232 is provided to first separate the received WDM signal 126 from the fiber network into separated WDM signals and each separated WDM signal is an ultra dense WDM signal with closely spaced WDM signals. An ultra dense WDM demultiplexer 231 is placed in the optical path of each separated WDM signal out of the WDM demultiplexer 232 which further separates the ultra dense WDM signals at different wavelengths. The ultra-dense WDM demultiplexer 231 in this example, like the ultra-dense WDM multiplexer 221 in the transmitter part, is included as part of the linecard 210A in this example and is the line side input port for the linecard 210A. Similar to the WDM multiplexer, the WDM demultiplexer 232 can be configured to have a channel spacing in compliance with the ITU-T 100 GHz or 50 GHz grid and may be located outside the linecard as part of a standard interface with the fiber network. The WDM demultiplexer 232 can be implemented in various configurations, including an array-waveguide filter whose passbands repeat in every ITU window.

The linecard 210B in FIG. 2B is an ultra dense WDM linecard to interface between a lower rate signal switch/router as the client side equipment (e.g., a standard 10 GbE switch/router) that includes an array of parallel WDM transponders or transceivers 250 at the lower data rate without the TDM DEMUX 111 in FIG. 2A. Each transponder 250 includes an optical transmitter 251 that receives an electrical signal and produces an optical signal carrying the electrical signal to transmit to the line card 210B via a short haul fiber link 133. Each transponder 250 also includes an optical receiver 252 that receives an optical signal over a short haul fiber link 143 from the line card 210B. The optical fibers 133 can be replaced by copper wires, and the O/E and E/O replaced by electrical transceivers.

To interface with such client side equipment, the linecard 210B includes a transmitter part shown in the upper portion and a receiver part shown in the lower portion. The transmitter part can include an array of optical to electrical converters 134 with an array of optical detectors as the client side input port to receive the short-haul optical signals 133 from the client equipment, an array of electrical signal conditioning circuits such as CDR circuits 211 and circuits 213 with various digital signal processing functions such as Serdes, FEC and precoder. The transmitter part also includes an array of electrical to optical converters 113 that produce long-haul parallel ultra dense WDM signals for the long haul transmission. Similar to FIG. 2A, an ultra dense WDM multiplexer 221 is used as the line side output port and combines the long-haul parallel ultra dense WDM signals into a WDM signal for transmission over the fiber network. The array of optical to electrical converters 134 and the array of optical to electrical converters 252 on the client side are linked by short haul optical links 133. The output optical signals of the electrical to optical converters 113 for the long haul transmission are closely spaced at an ultra dense WDM spacing and are directed to the ultra-dense WDM multiplexer 221. Two or more such linecards may be implemented and the ultra-dense WDM signals from these linecards can be directed to the WDM multiplexer 222 that combines the ultra-dense WDM signals into the output WDM signal 116 for transmission over the fiber network. The receiver part of the line card 210B is similar to the design in the line card 210A in FIG. 2A and uses the ultra dense WDM DEMUX 231 as the line side input port and the optical transmitters in the modules 144 as the client side output port. The electrical to optical converters 144 send the output optical signals via the short haul optical links 143 to the optical receivers 252 on the client side, respectively.

In the above two examples in FIGS. 2A and 2B and other designs with short haul parallel optical signals, the short-haul parallel optical channels 133 and 143 may be either optical signals at different optical wavelengths to carry different channels of data, or, alternatively, optical signals at an arbitrary optical wavelength that carry different channels of data. Parallel optical fiber lines, such as a ribbon of fibers, can be used to transmit such optical channels 133 and 143 between the client side equipment and the linecard 210B. In the latter implementation, the optical transmitters can use lasers with any wavelengths.

FIG. 2C shows an ultra-dense WDM linecard configured to interface with the client side equipment which is a router with electrical signaling interface via parallel conductive links 262 for signals to be transmitted to the fiber network such as copper wires and parallel conductive links 272 for transmitting parallel electrical signals from the linecard to the client side equipment. The client side switch/router has the TDM demultiplexer 111 and an array of signal conditioning circuits 261 such as CDR and equalization circuits on the transmitter side and an array of signal conditioning circuits 271 such as CDR and equalization circuits and TDM multiplexer 121 on the receiver side. The line card 210C includes signal conditioning circuits 263 such as CDR and equalization circuits as the electrical client side input port to interface with the client router via the parallel electrical links 262 and an array of CDR circuits 241 as the client side output port to interface with the client router via the parallel electrical links 272. Ultra dense WDM multiplexer 221 and demultiplexer 231 are included on the line side of the linecard as the optical line side output port and the optical line side input port in this example.

FIG. 2D shows another exemplary ultra-dense WDM linecard configured to interface with the client side equipment which is an optical transponder with an optical transmitter 281 to transmit an optical signal carrying a high speed serial data signal to the WDM linecard over a short haul fiber link 282 and an optical receiver 291 that receives an optical signal carrying a high-speed serial data from the line side over a short haul fiber link 292. This linecard 210D includes an transmitter part with an optical receiver 283 as the client side input port to produce a high data rate electrical signal and an electrical TDM demultiplexer 111 as part of the linecard 210D to transform the high data rate electrical signal into lower data rate signals in parallel that are directed through an array of signal conditioning circuits 213 to the long haul optical transmitters 113. The ultra dense WDM multiplexer 221 is provided as the line side output port and the ultra dense WDM DEMUX 231 is provided as the line side input port. Downstream from the DEMUX 231, the receiver part of the line card 210D includes optical receivers 123, signal conditioning circuits 243 and TDM multiplexer 121 that combines the parallel lower data rate signals into a high data rate signal. The optical transmitter 293 is the client side output port and produces an optical signal that carries the high data rate signal and is directed to the optical receiver 291 via the optical link 292. Ultra dense WDM multiplexer 115 and demultiplexer 125 are included on the line side of the line card in this example.

In the examples of ultra-dense linecards illustrated in FIGS. 2A-2D, each linecard is based on wavelength-division multiplexing of parallel lower data rate long haul optical channels and a spectrally-efficient signal modulation technique in generating such long-haul parallel lower data rate optical channels so that the channel spacing in frequency of the parallel lower data rate optical channels is comparable to the data symbol rate of each parallel optical channel or greater than the data symbol rate up to approximately twice the data symbol rate. Such close channel spacing between two adjacent parallel optical channels is possible without incurring unacceptable cross talk between adjacent channels because the spectrally-efficient signal modulation is provided in such linecards to mitigate the adverse cross talk for transmission at 40 Gb/s or higher.

The following sections describe exemplary implementations for the long-haul electronic-to-optical conversion modules 113 and the corresponding long-haul optical-to-electronic conversion modules 123 based on spectrally efficient signal modulation for achieving acceptable transmission signal quality of the long-haul optical WDM signals carrying low-speed electronic signals 112 over long distances in the network 103. The modulation of each signal 112 used in generating the optical WDM channel 114 can use a spectrally efficient modulation scheme in either the baseband domain or the microwave/mm-wave domain for meeting the signal transmission requirements in the long-haul transmission so that the frequency spacing between any two WDM wavelengths of the signals 114 can be comparable to a data symbol rate or greater than the data symbol rate up to approximately twice the data symbol rate under an ultra-dense WDM configuration while maintaining the optical cross talk between the two adjacent optical WDM channels below a threshold. The long-haul optical-to-electronic conversion unit 123 can implement signal demodulation in either the optical domain or the microwave/millimeter-wave domain. Hence, the following four combinations of signal modulation at the transmitter and signal demodulation at the receiver can be used in implementing the present spectrally-efficient ultra-dense WDM transmission: (1) signal modulation in the baseband domain at the transmitter side and signal demodulation in the optical domain; (2) signal modulation in the baseband domain at the transmitter side and signal demodulation in the microwave/millimeter-wave domain; (3) signal modulation in the microwave/millimeter-wave domain at the transmitter side and signal demodulation in the optical domain; and (4) signal modulation in the microwave/millimeter-wave domain at the transmitter side and signal demodulation in the microwave/millimeter-wave domain. Examples are described below. These examples may be used in any one of the above four combinations beyond the specific combinations in these examples. Various spectrally efficient signal modulation formats may be used based on the requirements in a system implementation. Examples of modulation formats include, but are not limited to, NRZ/OOK, duobinary modulation, multiple level phase shifting keying (M-PSK), and multiple level quadrature amplitude modulation (M-QAM) and differential M-ary phase shift keying (DMPSK) format such as the differential quadrature phase shift keying (DQPSK). A spectrally efficient signal modulation format is selected to densely pack the lower-rate WDM channels within one ITU (International Telecommunication Union) window of 100 GHz or 50 GHz bandwidth while maintaining interferences between two adjacent WDM channels in the signal transmission below a predetermined threshold to achieve an acceptable signal transmission quality at the receiver.

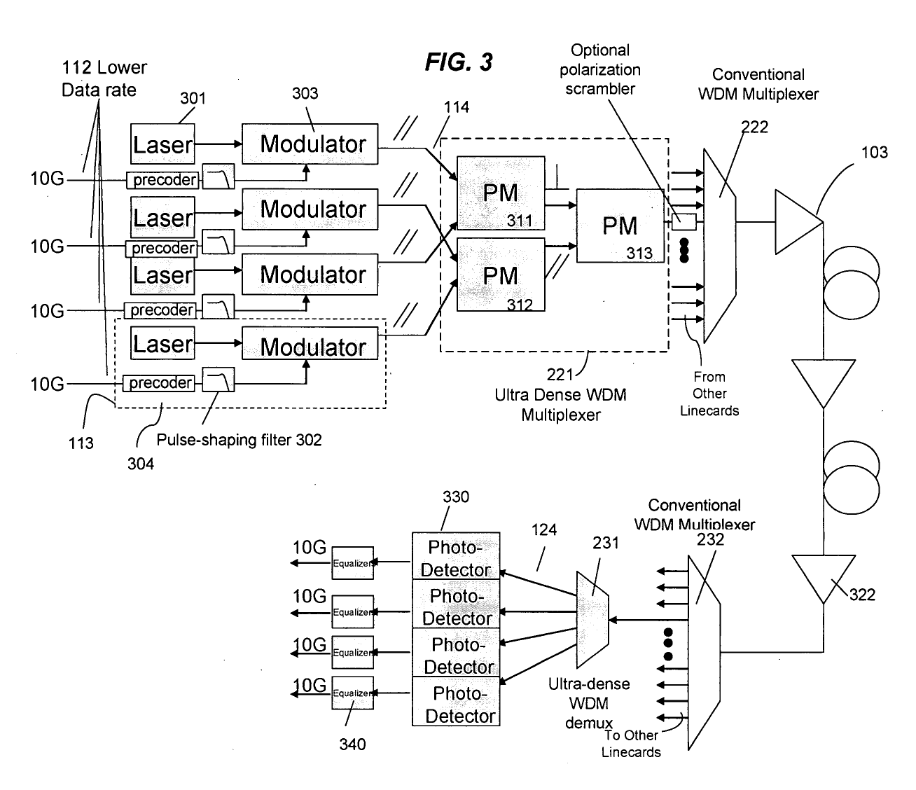

FIG. 3 shows one implementation of the long-haul electronic-to-optical conversion unit 113 and the optical WDM MUX in the optical transmitter unit and the long-haul optical-to-electronic conversion module 330 and the optical DEMUX of the optical receiver unit in FIGS. 1A-1C and 2A-2D. The electronic-to-optical conversion unit 113 may include a laser 301 that produces a CW laser beam, and an optical modulator 303 that modulates the CW laser beam to produce a modulated laser beam that carries the respective lower speed electronic signal 112. Different electronic-to-optical conversion units 113 are configured to have different lasers 301 at different wavelengths. Alternatively, two or more CW laser beams for two or more of the units 113 may be generated by an optical comb generator with a single laser where the single CW laser beam from the laser is modulated based on a subcarrier modulation technique such as optical single sideband (OSSB) modulation or optical double sideband (ODSB) modulation. Examples of optical comb generators are described in U.S. patent application Ser. No. 12/175,439 entitled “Optical Wavelength-Division-Multiplexed (WDM) Comb Generator Using a Single Laser” and filed on Jul. 17, 2008, which is incorporated by reference as part of this document.

The signal 112 is directed through a precoder 304 for duobinary encoding and a pulse-shaping filter 302 to produce a signal that is to be carried by the respective optical signal 114 via optical modulation. The bandwidth (BW) of the pulse-shaping filter 302 can be configured to produce an NRZ on/off keying (OOK) signal (which may have a bandwidth of, e.g., approximately from 0.7 B to 1 B, where B is the lower data rate) in which an electrical modulation signal swings from 0 to V_{π} (with the modulator biased at a quadrature point) or a duobinary signal of a bandwidth of, e.g., approximately from 0.25 B to 0.3 B, in which the electrical baseband modulation signal swings from −V_{π} to +V_{π} (with the modulator biased at a minimum point) The OOK signal or the duobinary signal is then fed into the optical modulator 303 to control the optical modulation which produces the optical WDM signal 114.

In the illustrated example, the optical polarization of each signal 114 is controlled so that two optical WDM channels 114 next to each other in frequency are orthogonally polarized to each other. The optical WDM channels in the same polarization are directed into a beam combiner 311 or 312 to produce a combined signal with optical channels in the same polarization. Two such beam combiners 311 and 312 are used, one for each polarization. The combined signals from the beam combiners 311 and 312 are directed into a polarization beam combiner 313, with either 311 or 312 rotated 90° in polarization, to produce an output signal that has all optical WDM channels 114 with two adjacent channels in orthogonal polarizations. This output signal is transmitted through a single fiber connected to the optical network 103. FIG. 3 shows the line side components for both the transmitter part and the receiver part of a single linecard. Two or more such linecards can be arranged in parallel so that a WDM multiplexer 222 is used to combine WDM signals from different linecards into a WDM signal for transmission over the network 103. The polarization interleaving or scrambling may become unnecessary and thus may be eliminated if the system OSNR requirement is not stringent.

The long-haul optical receiver module in the line card shown in FIGS. 2A-2D may be designed for direct optical detection. Optical filtering, e.g., multi-stage DWDM demultiplexing via DEMUX modules 232 and 125, is performed to extract each individual optical channel and a respective optical detector is used to detect each individual optical channel. In this example, the WDM DEMUX 232 is used to receive the light from the network 103 and separates the received light into different optical WDM signals center at different wavelengths and multiple WDM DEMUX modules 231 further separate the different optical WDM signals into individual optical WDM channel signals. As illustrated, each WDM DEMUX module 231 separates a respective optical WDM signal from the WDM DEMUX module 232 into individual optical WDM channel signals. Multiple optical detectors 330 are used to respectively receive and detect the separated optical WDM channel signals, one channel per detector, to produce electronic signals 122. Each electronic signal path may include an electrical equalizer 340 to mitigate the eye distortion, either due to static band-limiting effect caused by the electrical or optical pre-filtering in the optical transmitter module, or due to fiber chromatic dispersion. The signal modulation in the transmitter uses spectrally efficient signal modulation techniques in either baseband domain or the microwave/millimeter-wave domain and by using electrical low-pass filters and optical bandpass filters to reduce adjacent channel crosstalk. The transmission symbol rate (e.g., 10 Gbaudec) is equivalent to an existing low-data rate (e.g., 10 Gb/sec) which is already running on the incumbent infrastructure in order to limit the signal degradation caused by the given CD/PMD/OSNR within the incumbent optical fiber infrastructure.

In the examples in FIGS. 2A-2D, the fiber infrastructure for the fiber network 103 need not be changed when implementing the optical transmitter module 110 and the optical receiver module 120. The line card in each of FIGS. 2A-2D can be used to replace legacy optical transmitters and receivers for low-speed signal transmission without changing or modifying the network 103. For example, on the transmitter side, the output of the device 221 is directed to an existing WDM MUX 222 in the network 103 which combines the existing signal with other signals to produce a final signal for transmitting in single fiber in the network 103. Optical compensation devices and optical amplifiers 322 (in FIG. 3) in the network 103 can be maintained. At the receiver side, a conventional WDM DEMUX 232, which has a channel spacing following ITU-T 100 GHz or 50 GHz grid, separates received light into multiple optical signals and one such signal is the input to the DEMUX 231 which further separates individual optical WDM channels 124. FIG. 3 is an example of using baseband signal modulation on the transmitter side and optical signal demodulation on the receiver side. In the case when the signal modulation format is either 10 Gb/s NRZ/OOK or duobinary, the channel spacing is typically set between 10 and 12.5 GHz.

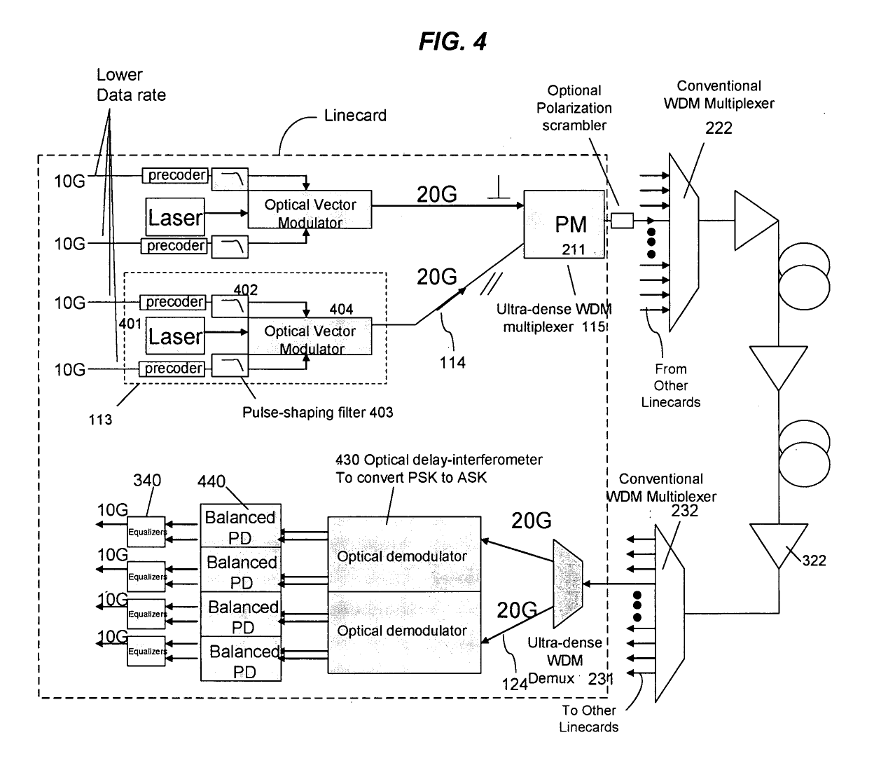

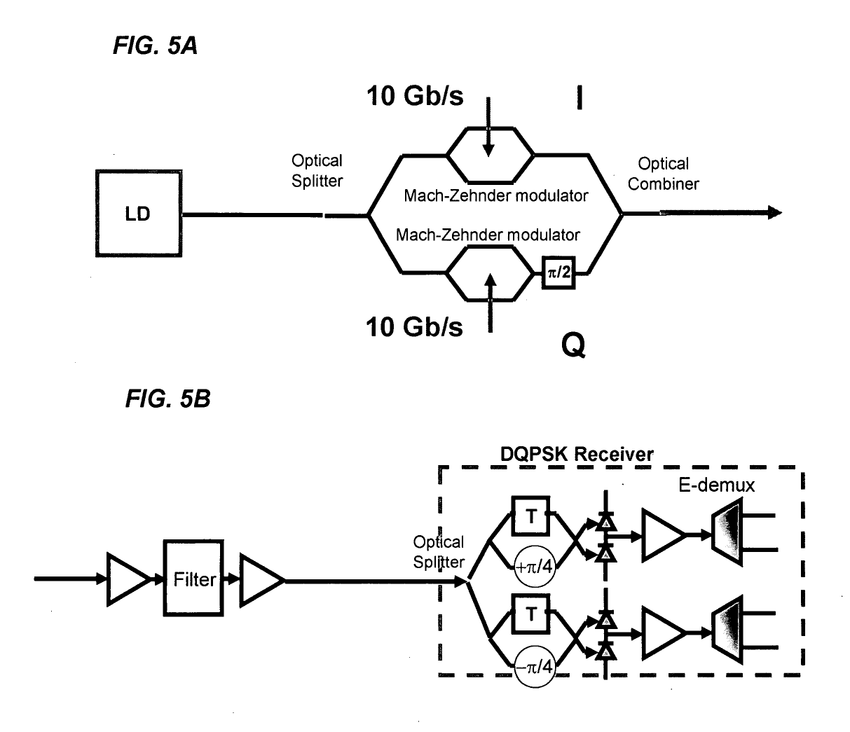

FIG. 4 shows another example of a linecard for implementation of the optical transmitter unit based on differential quadrature phase shift keying (DQPSK)or M-ary quadrature amplitude modulation (M-QAM) modulations. In an implementation of the M-QAM modulation, the precoder in each of the two signal arms should be replaced by the combination of a high-speed digital-to-analog converter for the purpose of generating multi-level signals, and a gray-coded byte-to-m-tuple converter. Each electronic-to-optical conversion unit 113 includes an optical vector modulator 404 (see FIG. 5A) to modulate two lower speed electronic baseband signals in one optical beam at one optical WDM wavelength. The optical vector modulator 404 can be implemented to include two parallel Mach-Zehnder modulators whose inputs and outputs are connected, respectively. The modulated optical beams are then combined into a single fiber connected to the network 103. In this example, the correspondence between the number of client-side electrical signals and the number of long-haul side wavelength is 2:1. For M-QAM modulation, this correspondence can become log₂M:1. The optical receiver unit in FIG. 4 uses an incoherent detection scheme for the optical receiver unit where an optical delay interferometer 430 and a balanced optical detection unit 440 are used to extract signals from the optical WDM channels. FIG. 4 is another example of using baseband signal modulation on the transmitter side and optical signal demodulation on the receiver side. In the case of signal modulation format being 10 Gbaud DQPSK, (D)M-PSK, or M-QAM, the channel spacing is typically set between 12.5 and 25 GHz. The polarization interleaving or scrambling may become unnecessary and thus may be eliminated if the system OSNR requirement is not stringent.

FIGS. 5A and 5B show an example for an optical DQPSK transmitter for baseband modulation using a vector optical modulator with two parallel Mach-Zehnder modulators and a direct optical detection and demodulation of the DQPSK signals. This design can be used to implement the system in FIG. 4 and to reduce the symbol rate by a factor of 2 for the same data rate, thus improving the spectral efficiency. The optical transmitter includes a laser diode (LD) that produces CW laser light. The CW laser light is split into first and second CW beams to be modulated by the two Mach-Zehnder modulators to carry two different low-speed electronic signal channels 125, respectively. The modulated optical beams from the two modulators are phase shifted by 90 degrees to be an in-phase signal (I) and a quadrature phase signal (Q) and are combined to produce an optical WDM signal 114 (see FIG. 4). In FIG. 5B, the optical DQPSK receiver is configured as a delay interferometer which splits the received light into first and second signals in two different optical detection paths. Each optical detection path splits the light into an upper optical arm with an optical delay less than one symbol duration (<T) and a lower optical arm with an optical phase shift of π/4 or −π/4. The optical delay is set to be less than one symbol duration to provide a wider free spectral range so as to partially compensate for the bandpass limiting effect due to the presence of the optical ultra-dense DEMUX. Each detection path includes a balanced pair of photodiodes to measure the constructive output and the destructive output, respectively, to output a demodulated electronic signal at a lower data rate e.g., 10 Gb/s. The channel spacing between DQPSK optical transmitters operating at approximately 10 Gbaud is between 12.5 and 25 GHz. Under DQPSK, each line side optical transmitter with a unique wavelength is coupled to two client side electrical signals.

Notably, designs in FIGS. 1A and 2D and other designs based on the disclosure of this document can use the above vector optical modulation based on DQPSK, M-PSK or M-QAM modulation to carry two channels in one optical WDM signal to be multiplexed with other optical WDM signals for transmission over the fiber network.

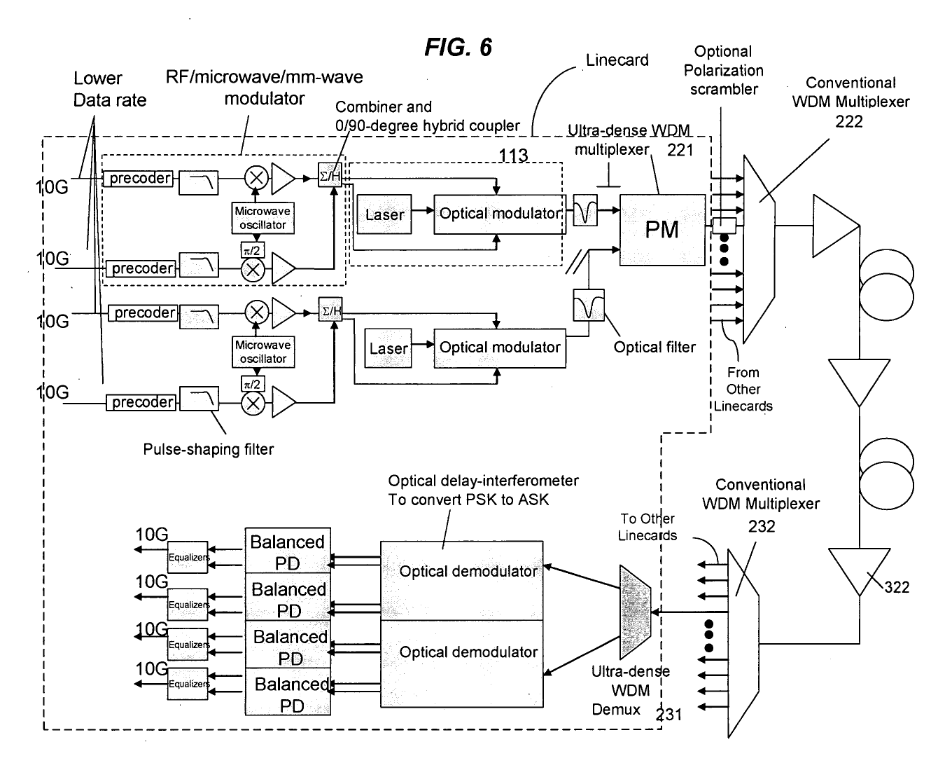

FIG. 6 shows an example for using microwave/millimeter-wave signal DQPSK modulator and optical demodulation in implementing a system, e.g., a system in FIGS. 2A-2D. A vector microwave/millimeter-wave modulator (based on microwave I/Q mixers) is provided in each electronic-to-optical conversion unit 113 to combine two lower speed electronic signals to modulate an external optical modulator (e.g., a Mach-Zehnder modulator) to produce (a) an optical signal that carries multiple subcarriers based on optical single-sideband (OSSB) modulation with a suppressed carrier by using microwave/millimeter-wave 0/90-degree hybrid couplers or (b) optical double-sideband (ODSB) modulation with a suppressed carrier. Details of some implementation examples for OSSB and ODSB modulation techniques are described in U.S. Pat. Nos. 6,525,857 and 7,003,231, U.S. Patent Publication No. 20060269295A1 entitled “Optical Double Sideband Modulation Technique with Increased Spectral Efficiency,” and U.S. patent application Ser. No. 12/109,337 entitled “Dual-modulator WDM signal generator” and filed on Apr. 24, 2008, which are incorporated by reference as part of the disclosure of this document. In OSSB modulation, a single optical carrier can be modulated by a Mach-Zehnder modulator using microwave/millimeter-wave subcarrier modulation to carry a single channel subcarrier on one side of the optical carrier or to carry two different single channel subcarriers on two opposite sides of the optical carrier. Two adjacent optical WDM channel signals produced by two different OSSB Mach-Zehnder modulators are orthogonally polarized relative to each other to reduce the adjacent-channel cross talk. This polarization interleaving scheme may become unnecessary and thus may be eliminated if the system OSNR requirement is not stringent. An optical notch filter with a center frequency at a respective optical carrier is used to filter the output of each OSSB Mach-Zehnder modulator to suppress the optical carrier while allowing the sideband to pass through. In the case of ODSB, the microwave/millimeter-wave 0/90-degree hybrid coupler is not needed, the optical modulator usually is a single-electrode modulator, and the optical filter is a bandpass or edge-filter which allows only one of the two sidebands to pass through. The detection in this example uses the incoherent differential optical detection in FIG. 4 to demodulate each DQPSK signal.

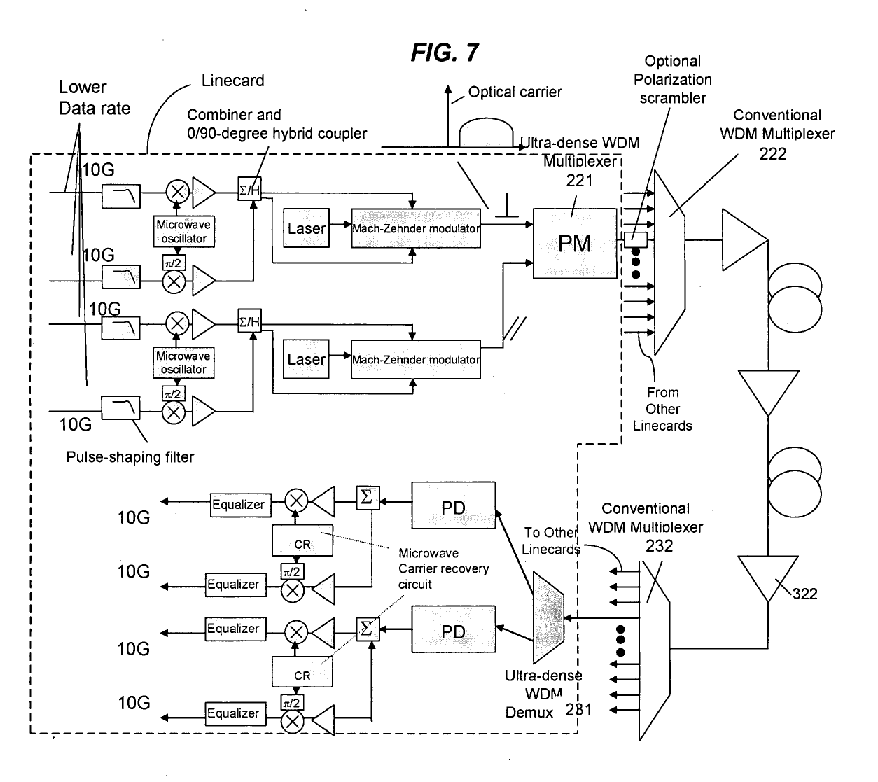

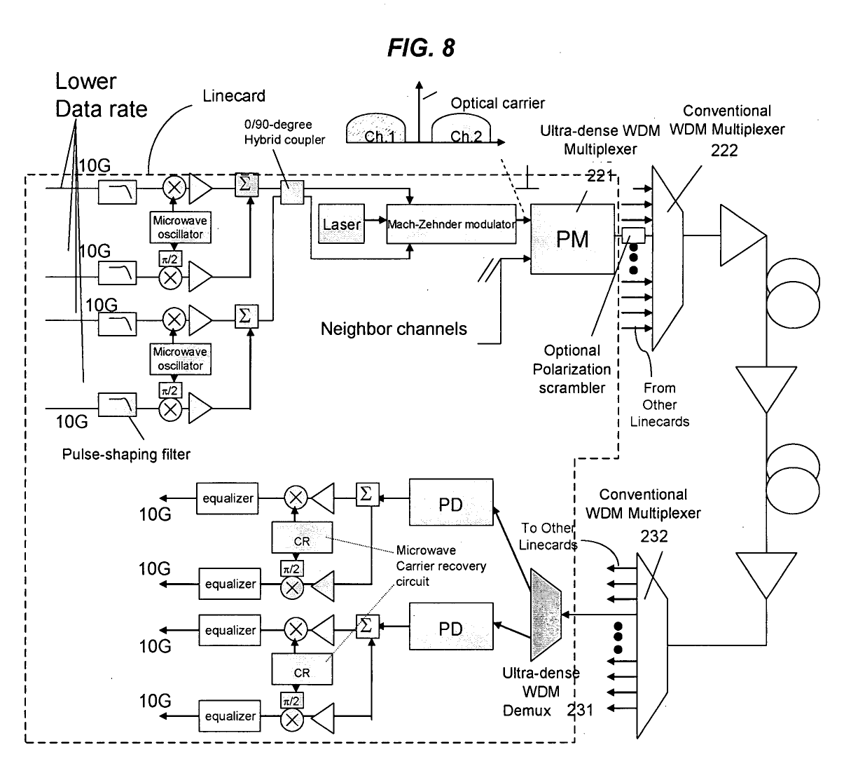

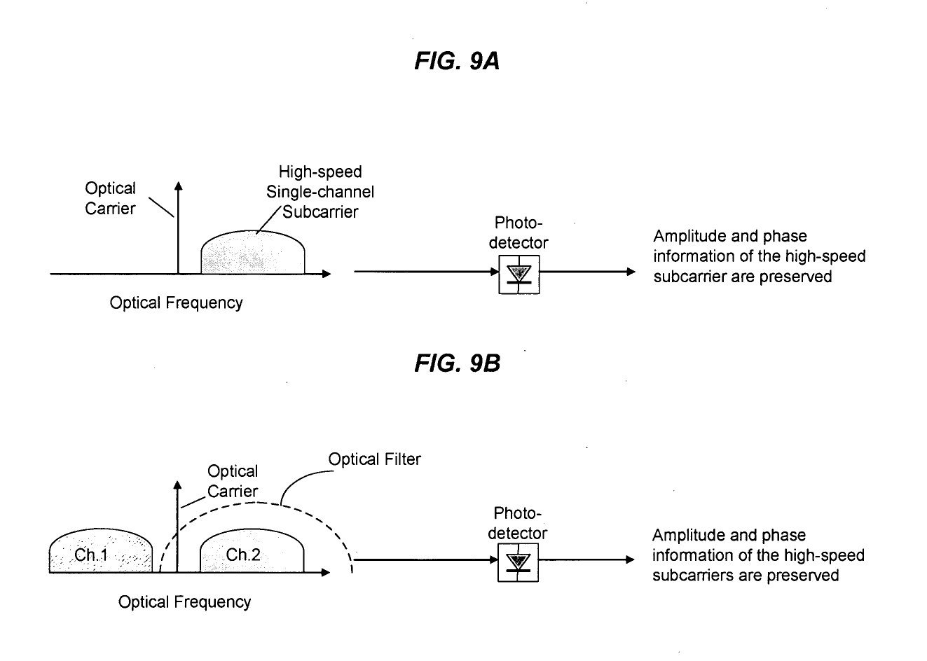

FIGS. 7 and 8 show examples where the microwave-millimeter-wave modulator is used for the signal modulation and the detection is based on a direct optical detection scheme and a microwave/millimeter-wave demodulator. The microwave-millimeter-wave signal modulation in FIG. 7 uses OSSB modulation to carry a single channel subcarrier on one side of the optical carrier as shown in FIG. 9A where the optical carrier is preserved in the OSSB modulation and is not suppressed. The microwave-millimeter-wave signal modulation in FIG. 8 uses OSSB modulation to carry two different single channel subcarriers on two opposite sides of the optical carrier as shown in FIG. 9B where the optical carrier in the OSSB modulation is preserved and is not suppressed. Different from the design in FIG. 6, the optical carrier is preserved at the transmitter side and is used at the receiver side to serve as a “remote” oscillator to achieve optical heterodyne detection at the receiver side. This is an example for a mechanism to generate optical carriers that correspond to line side optical WDM signals at different WDM wavelengths, respectively, and to mix the generated optical carriers with the line side optical WDM signals at the WDM multiplexer to produce the line side output WDM signal that contains the generated optical carriers. With this remote heterodyne operation, all amplitude and phase information of the high-speed subcarrier signal can be preserved. Therefore, this method is applicable to M-ary PSK and QAM modulations in the microwave/millimeter-wave domain.

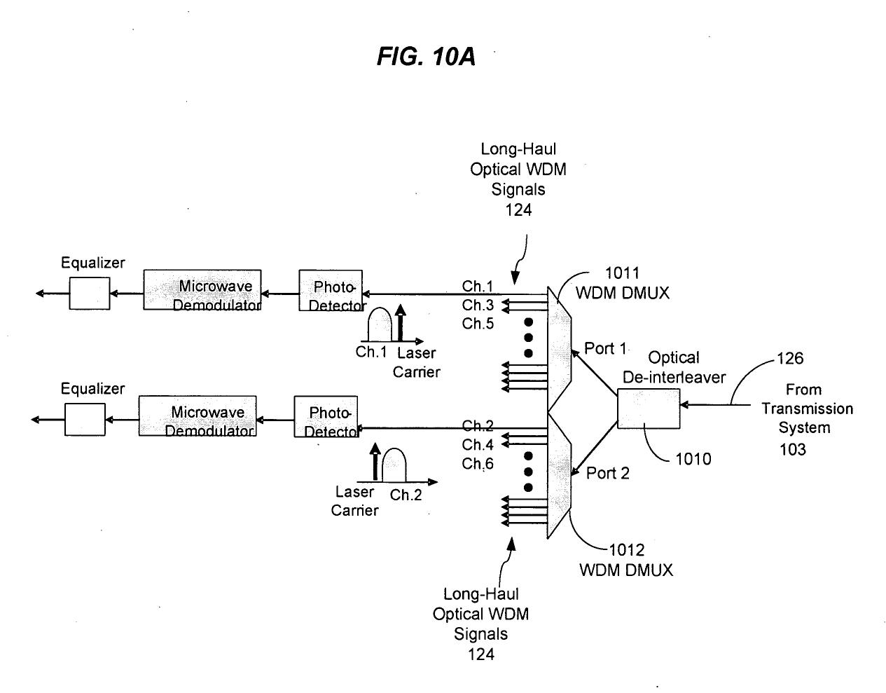

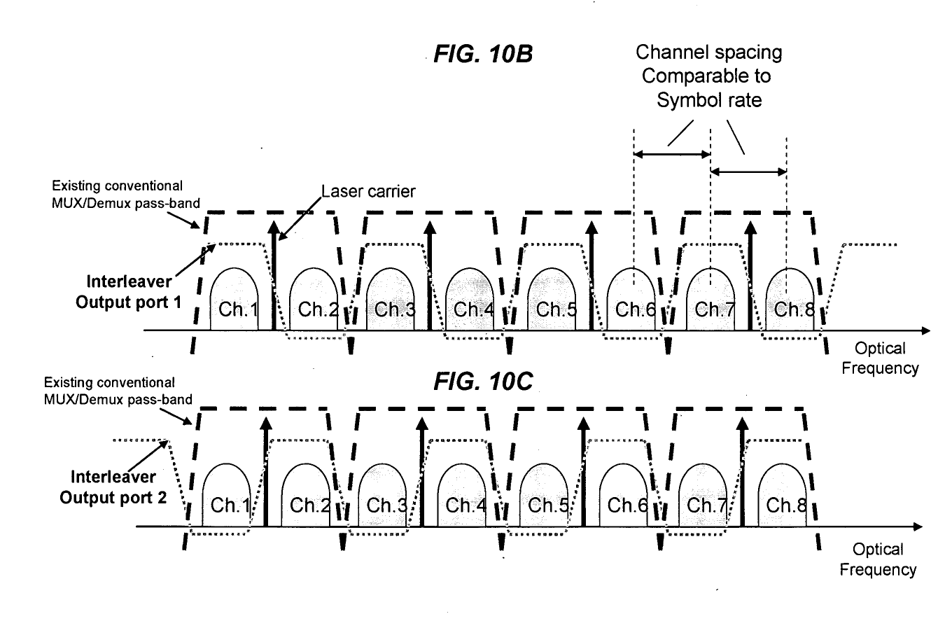

FIG. 10A illustrates an optical receiver based on direct optical detection and microwave/millimeter-wave demodulation for the system in FIG. 8 where the OSSB modulation is used to carry two different channels on two opposite sides of an optical carrier that is preserved. The receiver includes an optical de-interleaver 101 that separates the odd numbered WDM channels in the received signal 126 to the output 1 and even numbered WDM channels in the received signal to the output 2. A first optical WDM DEMUX 1011 is used to separate the odd numbered WDM channels together with their associated laser carriers into different parallel optical channels 124 and a second optical WDM DEMUX 1012 is used to separate the even numbered WDM channels together with their associated laser carriers into different parallel optical channels 124. Optical detectors are provided to perform optical heterodyne detection to detect the parallel optical channels 124 and to produce detector signals, respectively. Each detector signal is then demodulated in the microwave/millimeter-wave domain to recover the lower speed electronic signal 122.

FIGS. 10B and 10C illustrate the spectrum of the received OSSB signal 126 and the operation of the de-interleaver 1010 and the WDM demux 1011. The OSSB signal 126 in FIG. 10A includes multiple optical carriers at ITU WDM grids and each optical carrier carries two different channel signals on two opposite sides of the carrier that are also within ITU WDM grids. The first port 1 of the de-interleaver 1010 has a transmission spectrum as shown in FIG. 10B to receive odd numbered WDM channels while blocking the even numbered channels. The second port 2 of the de-interleaver 1010 is optically complementary to the port 1 and has a transmission spectrum as shown in FIG. 10C to receive even numbered WDM channels while blocking the odd numbered channels.

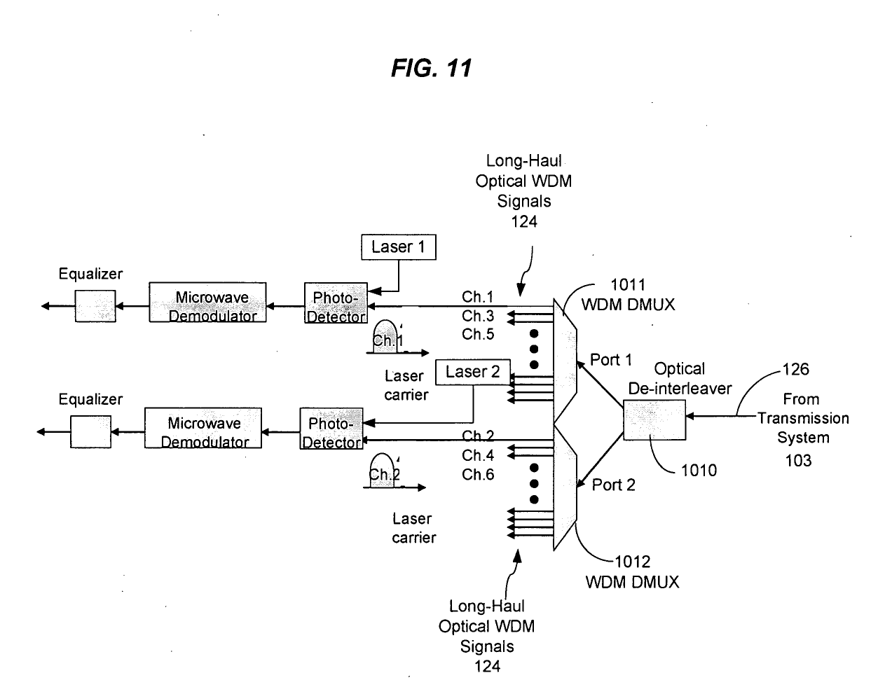

The receiver in FIG. 10A can be modified to include optical local oscillators that produce CW laser beams as the optical carriers in FIGS. 10B and 10C that are missing from the output optical signal produced by the transmitters in FIGS. 3, 4 and 6. FIG. 11 shows an example where local oscillator lasers 1, 2, etc. are provided and each CW laser beam from a respective local oscillator laser is directed to mix with a separated optical WDM channel by each of the DEMUX 1011 and DEMUX 1012 for optical heterodyne detection at a respective optical detector. The signal demodulation is then performed in the microwave/millimeter-wave domain. For example, the microwave/millimeter-wave demodulation shown in FIGS. 7 and 8 can be used. This combination of the optical modulation in FIGS. 3 and 4 and the microwave/millimeter-wave demodulation shown in FIGS. 7 and 8 can be advantageously used in selected system deployments.

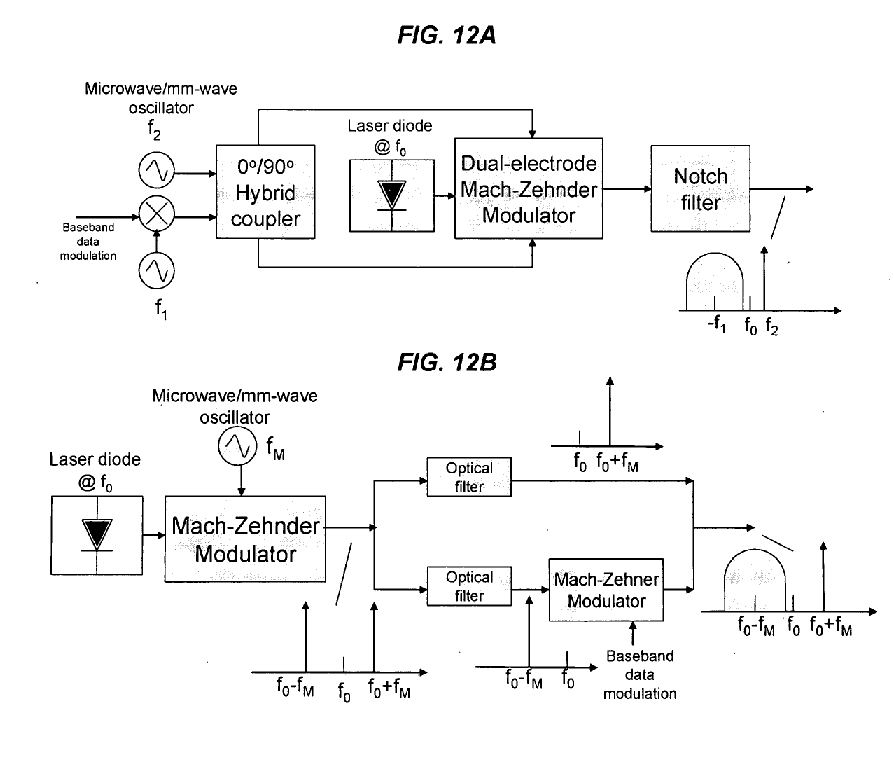

The above methods of adding optical oscillators for optical heterodyne detection at the receiver use lasers to produce the optical oscillators. Alternatively, microwave/millimeter-wave oscillators can be used to generate an optical oscillator carrier for the optical heterodyne detection. Two examples are shown in FIGS. 12A and 12B. Such methods can reduce the number of lasers used in the system, maintain a fixed and stable channel spacing between the optical oscillator and the modulated signal, and reduce the cost.

FIG. 12A shows an optical transmitter that uses microwave/millimeter-wave modulation to perform spectrally efficient signal modulation and to generate an optical tone for the optical heterodyne detection. In this example, a dual electrode Mach-Zehnder modulator is configured under an OSSB configuration to modulate a CW optical carrier beam from a laser at a laser carrier frequency f₀ under 90-degree-shifted control signals applied to the two optical arms with one carrying the microwave tone at f₂ and another carrying a up-converted baseband modulation signal by using the microwave/mm-wave oscillator running at a frequency f₁. The modulated optical output includes a modulation sideband and an optical pilot tone. An optical filter is placed downstream from the Mach-Zehnder modulator to filter out light at the laser carrier frequency f₀ and transmits the light at f₁ and f₂. In one implementation, the frequency spacing between f₀ and f₂ can be much smaller than that between f₀ and f₁ to minimize the bandwidth required to carry the pilot tone at f₂. The optical pilot tone is transmitted to the receiver and is used as a local oscillator signal for the optical heterodyne detection in the receiver.

FIG. 12B shows another method that uses an OSSB Mach-Zehnder modulator to produce an optical beam at the optical carrier that carries a signal sideband on one side of the suppressed optical carrier to carry the baseband signal and another sideband on the other side of the optical carrier as the optical pilot tone for the heterodyne optical detection at the receiver. The OSSB modulator is used to produce the two sidebands on two sides of the optical carrier while suppressing the optical carrier. The signal produced by the OSSB modulator is split into two parallel optical paths. The first optical path includes a first optical passband filter to transmit the first optical sideband as the optical pilot tone while rejecting the second sideband. The second optical path includes a second optical filter to transmit the second optical sideband while rejecting the first sideband. A second Mach-Zehnder modulator is placed downstream of the second optical passband filter and is used to perform the baseband modulation at the second sideband to carry the baseband signal. The outputs of the two paths are combined to produce the output optical signal. FIG. 12B also illustrates the spectra of signals at different stages in the transmitter.

The above examples use 40 Gb/s signals as an example where a 40-Gb/s signal is divided into four 10-Gb/s signals (e.g., FIG. 3) or two 20-Gb/s signals (e.g., FIG. 4) for transmission. Either four optical WDM wavelengths based on OOK or duobinary signal modulation or two optical WDM wavelengths based on DQPSK signal modulation can be used. Similar schemes can be applied to 100 G transmission by adopting 5 channels of 20 Gb/s DQPSK or 4 channels of 25 Gb/s DQPSK transmission. If multiple stabilized lasers are used in the transmitter, 2 or 4 lasers are needed for the 40 G transmission, and 4 or 5 lasers for 100 G transmission. Such designs can use a spectrally efficient laser array to reduce the module size and cost. On the receiver side, if 4 OOK or duobinary sub-wavelengths are used, 4 photo-detectors can be used to detect such signals. If 2, 4, or 5 DQPSK sub-wavelengths, 2, 4, or 5 optical (or microwave) demodulators, and 2, 4, or 5 balanced-detector pairs (or 2, 4, or 5 higher speed detectors for self-heterodyning to achieve the subsequent microwave demodulation) may be used accordingly. Both demodulators (optical or microwave/millimeter-wave) and (balanced) detectors can be built into arrays to reduce package size and cost. In some implementations, an array of lasers can be replaced by a single laser with a comb generator to generate multiple optical carriers. Alternative to the laser and detector array approach, an integrated photonic IC having a complete set of optical transmitters and receivers can be used to align with the intensive development of pluggable optical transceivers.

The above use of parallel lower data rate optical channels and spectrally-efficient signal modulation can transmit signals at data bit rates in an existing infrastructure while still maintaining signal transmission performance with the same tolerance to polarization-mode-dispersion (PMD), chromatic-dispersion (CD), and optical-signal-to-noise ratio (OSNR) for signal transmission at lower data bit rates for which the existing infrastructure is designed. Parallel 40 and 100 G split the higher data rates into multiple 10 Gb/s or 10 Giga-symbols/sec data rates, and therefore exhibit the same PMD/CD/OSNR tolerance during the transmission as the 10 Gb/s signals.

Recent deployments of 40 G fiber networks have been fairly expensive. The 40 G transponders remain relatively expensive in comparison to 10 G transponders. In addition, significant re-engineering is also required on existing 10 G infrastructures. For example, a 40 G transmission system requires single-mode optical fibers with low polarization-mode-dispersion (PMD) (typically less than 0.1 ps/(km)^{1/2}; per-wavelength pre- and post-chromatic dispersion compensators; per-wavelength fast-response PMD compensators; and high-coding gain forward-correction encoders/decoders. Parallel physical layer (PHY) based on multiple lanes of 10 GbE, can reuse the existing 10 G infrastructure to minimize re-engineering of the existing 10 G infrastructure. Also, 10 G optoelectronic components have a significant price advantage because they are in much higher demand, and produced in higher volume than their 20 G, 25 G, 50 G or 100 G counterparts. As a result, parallel 10 G lanes can be advantageously used for implementing 100 GbE/40 GbE parallel physical layer (PHY) for MAN and WAN.

The above described parallel PHY can also be used to use the parallel optical channels to provide failure protection. Instead of using the costly 1+1 protection of 40 G or 100 G linecards based on optical redundancy, the present long-haul parallel transmission can be structured to provide “graceful degradation” when one of the parallel optical channels fails. When such a failure occurs, the other hot-standby parallel optical lanes can serve as a backup for the failed optical lane by changing the initial parallel of one high-speed channel to N parallel low-speed channels to new parallel of the single high-speed channel to (N-1) parallel low-speed channels.

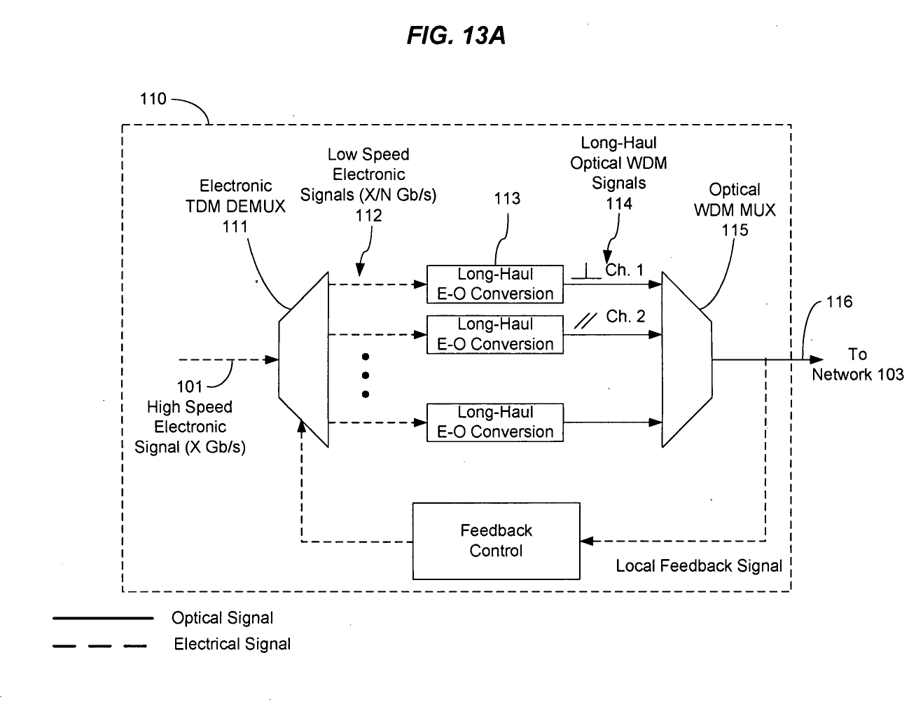

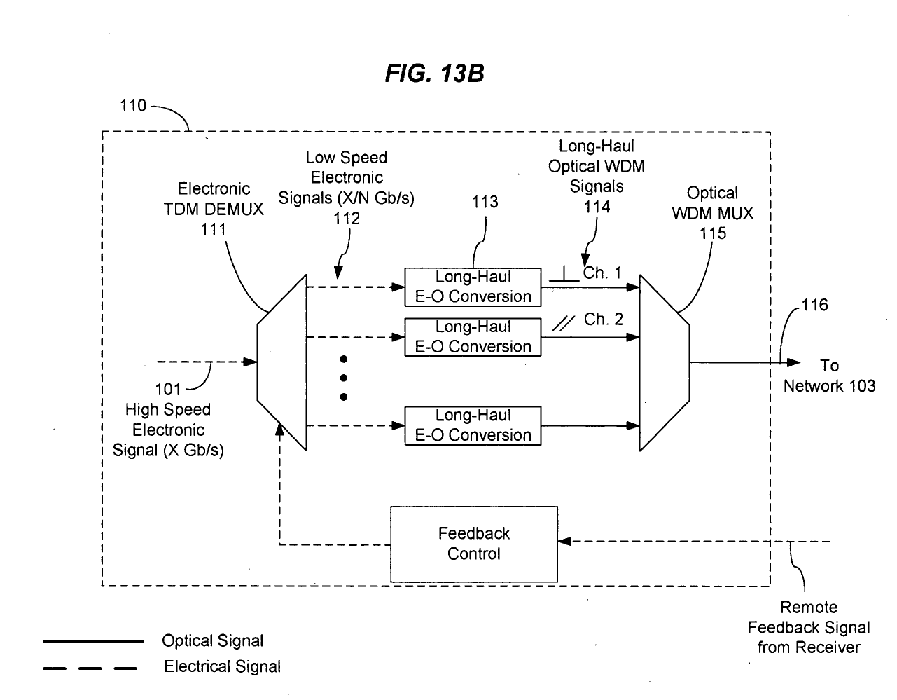

FIG. 13A shows an example of the failure protection mechanism in long-haul parallel optical WDM channels. An optical monitoring mechanism is provided in an optical path of the signals 114, e.g., downstream from the optical MUX 115 within or outside the transmitter 110 to monitor each optical signal 114. An optical coupler may be used to split light from the optical path of the signals 114. The monitored results are fed to a feedback control in the physical layer or a higher protocol layer to process the monitored results of the channels 114. If a channel 114 fails, the feedback control informs the TDM DEMUX 111 or its high level protocol control to cause the N parallel low-speed channels to re-distribute the data to the surviving (N-1) parallel low-speed channels.

FIG. 13B shows another example of the failure protection mechanism in long-haul parallel optical WDM channels where a remote optical monitoring mechanism is provided in a remote receiver to monitor each optical signal 114. The monitored results are carried by an optical feedback channel and is fed back to the transmitter 110 from the remote receiver to enable the feedback control unit in the transmitter to cause the N parallel lower-speed channels to re-distribute the data to the surviving (N-1) parallel lower-speed channels when there is a failure in one of the parallel optical channels 114.

The following sections describe examples of sub-carrier multiplexed (SCM) OSSB and ODSB modulations that can be used to implement microwave or millimeter-wave signal modulation described in this document

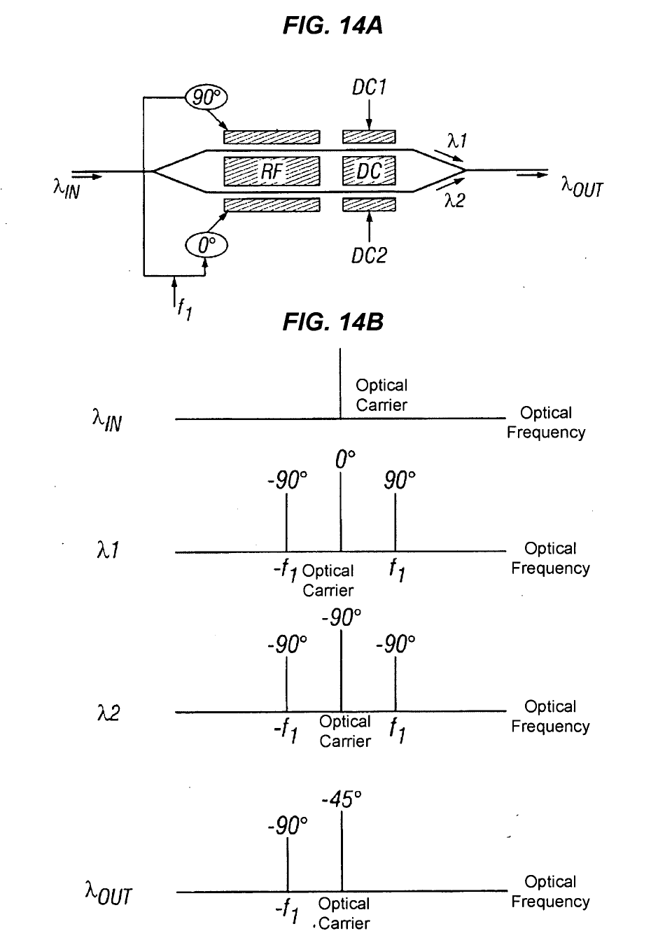

FIGS. 14A and 14B illustrate an example of an OSSB modulator with a dual electrode Mach-Zehnder modulator to carry one channel. An incoming light signal λIN is split into a first optical signal λ1 and a second optical signal λ2. RF alternating current (AC) electrodes modulate the two optical signals with the channel signal to be transmitted at the subcarrier frequency f1. The signal at the subcarrier f1 is applied to the upper optical arm of the modulator is phase-shifted by 90 degrees with respect to the signal applied to the lower optical arm. The DC electrodes of the modulator are used to produce a phase shift of 90 degrees between the two optical carriers in the two optical arms so that the optical carriers of the two optical arms are in quadrature with each other. The two signals in the two optical arms are then combined to produce an output signal rout in which only the carrier and the lower side band are present. This process may be modified so that the lower side band is cancelled and the upper side band is transmitted.

FIG. 14B show spectra of the signals at various stages in the modulator in FIG. 14A. Initially, the input optical signal λIN is a CW beam and includes only the optical carrier. After both the AC and DC electrodes have applied an electric field to the carrier signal in the upper arm, λ1, has an upper and a lower side band, the upper side band at 90 degrees. and the lower side band at −90 degrees, along with the carrier at 0 degree. Likewise, after passing through both electric fields, the lower arm signal λ2 has a carrier at −90 degrees, an upper side band at −90 degrees and a lower side band at −90 degrees. When the two signals λ1 and λ2 are combined to form λOUT, the two upper side bands cancel each other, leaving only the lower side band and the carrier.

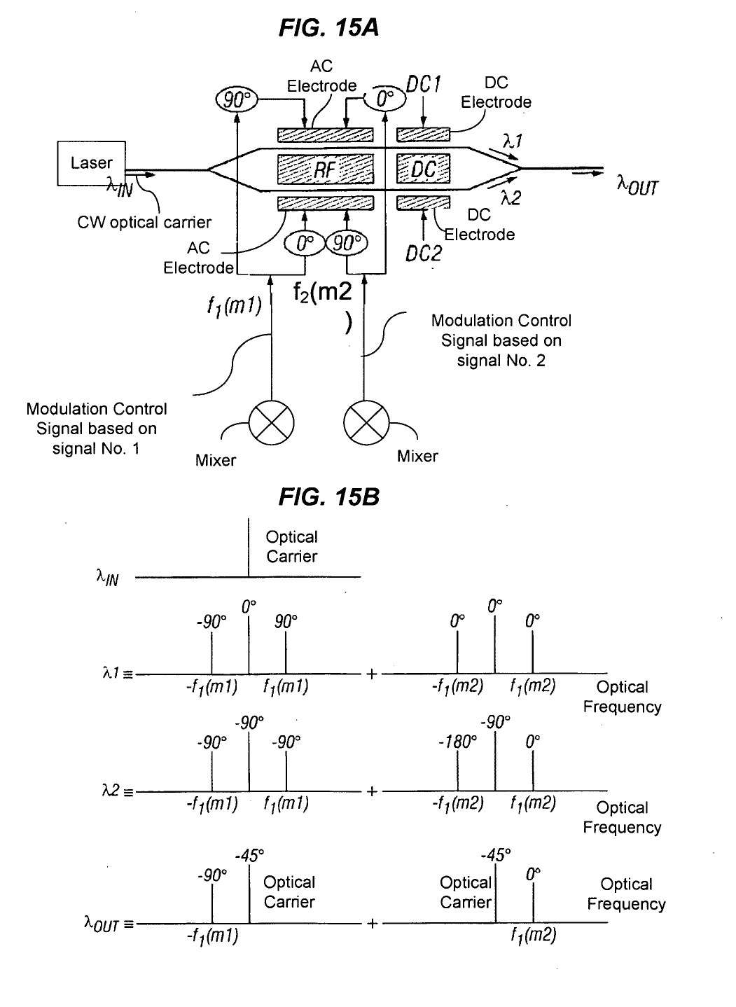

FIGS. 15A and 15B illustrate double OSSB transmission. RF alternating current electrodes are used to modulate the two optical signals with a first signal channel ml to be transmitted in such a way that the ml components of the first and second optical signals are phase-shifted by 90 degrees with respect to each other. At the same time, the RF alternating current electrodes modulate the two optical signals with a second signal channel m2 with the m2 components of the first and second optical signals phase-shifted 90 degrees with respect to each other. In each arm of the modulator, ml is phase-shifted 90 degree with respect to m2. Similar to FIG. 14A, DC electrodes are provided to the two arms so that the two optical carriers in the two arms are shifted 90 degrees with respect to each other. The two signals are then combined to produce an output signal λOUT in which contains the carrier, m2 as the upper side band and m1 as the lower side band. FIG. 15B show the spectra of various signals in the modulator in FIG. 15A to illustrate the operations of the modulator.

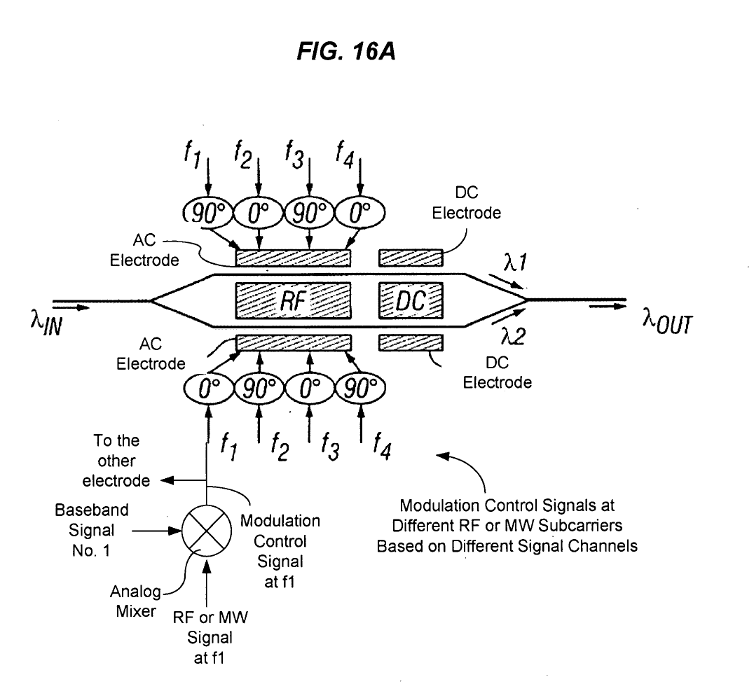

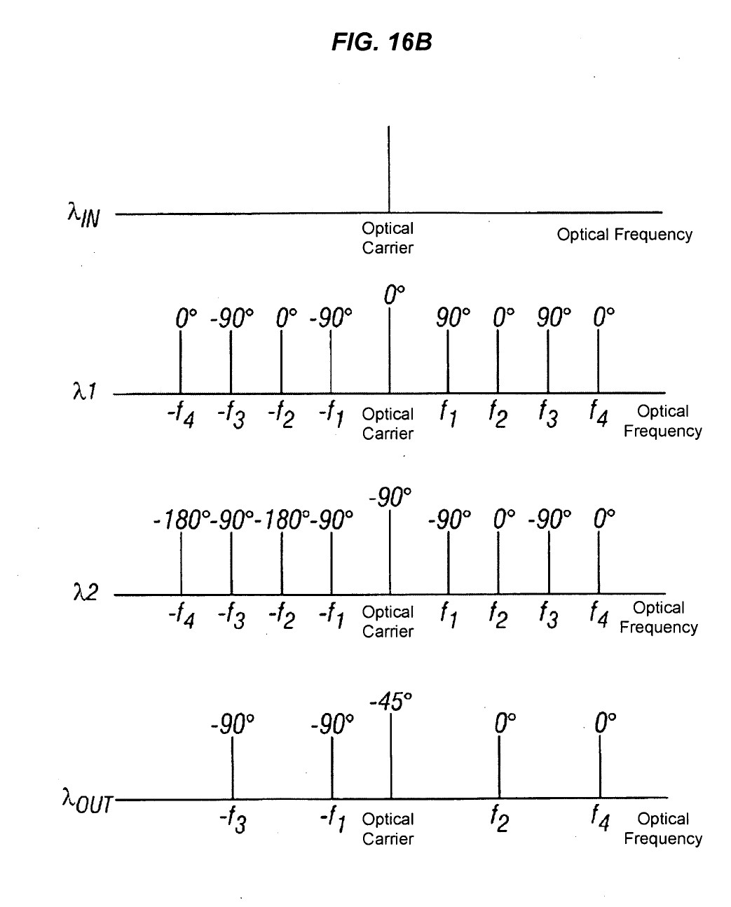

FIG. 16A shows an example of an interleaved OSSB modulator that is shown to modulate an optical beam with four subcarriers at f1, f2, f3 and f4 that carry four different signal channels. For convenience, the labels “f1,” “f2,” “f3” and “f4” are used to represent the channels and their frequencies in the RF/microwave/millimeter wave range and in the optical range. FIG. 16B illustrates the spectral components of various optical signals in FIG. 16A. A Mach-Zehnder modulator using an electro-optic material such as LiNbO₃ other others may be used. Two separate optical paths are provided and an input splitter is used to split the input into two signals for the two optical paths and an optical combiner is used to combine the two modulated optical signals from the two paths into a single output signal. The labels “λ1” and “λ2” are used here to represent the two optical signals in the two optical paths. The optical modulator includes AC electrodes for receiving RF, microwave, or millimeter wave modulation control signals and DC electrodes to receive DC bias. Four RF, microwave (MW) or millimeter wave signal connectors are provided for each arm of the optical modulator. RF, microwave or millimeter wave phase modulators or shifters are used in the signal paths to provide the desired phase shifts as shown in FIG. 16A. A corresponding analog signal mixer is used to supply the corresponding modulation control signal. Only the mixer for the channel f1 is shown and the mixers for other channels are omitted. At the output of the mixer, a signal splitter is used to split the modulation control signal into two parts, one for the AC electrode of the upper optical arm and another for the AC electrode of the lower optical arm.

In FIG. 16A, an input CW laser beam λin includes only the optical carrier as shown in FIG. 4B. The optical phase modulation at the upper optical arm produces the signal λ1 containing the channels to be transmitted. After further application of a DC field by the DC electrode, the output signal λ1 can be represented by the spectrum in FIG. 16B. Four separate signals at carrier frequencies f1, f2, f3, and f4 are multiplexed onto the optical carrier, each producing both an upper side band and a lower side band. Adjacent channels in each optical arm are 90 degrees out of phase with each other. Hence, assuming f1, f2, f3 and f4 are in ascending order in frequency, the channels f1 and f2 are phase shifted by 90 degrees with each other; channels f2 and f3 are phase shifted by 90 degrees with each other; and channels f3 and f4 are phase shifted by 90 degrees with each other. The optical phase modulation also produces two identical sidebands symmetrically on opposite sides of the optical carrier. As such, eight side bands are generated for the four channels and each channel is duplicated in the optical signal.

The channels in the lower optical arm are similarly phase shifted as shown in FIG. 16B. Each of the signals, f1, f2, f3 and f4 is applied to the lower arm in quadrature with the corresponding signal f1, f2, f3 and f4 in the upper arm. In addition, one optical arm is then placed in quadrature with the other optical arm by the DC bias on the DC electrode. As a result, upper sidebands for channels f1 and f3 in the upper optical arm are phase shifted by 180 degrees with respect to upper side bands for channels f1 and f3 in the lower optical arm, respectively. Upper sidebands for channels f2 and f4 in the upper optical arm are in phase with respect to upper side bands for channels f2 and f4 in the lower optical arm, respectively. The lower sidebands for channels f1 and f3 in the upper optical arm are in phase with respect to lower side bands for channels f1 and f3 in the lower optical arm, respectively. The upper sidebands for channels f2 and f4 in the upper optical arm are phase shifted by 180 degrees with respect to lower side bands for channels f2 and f4 in the lower optical arm, respectively.

When the two signals λ1 and λ2 are combined to form the output signal λout, upper side bands for channels f1 and f3 are cancelled in, leaving only f2 and f4. Likewise, in the lower side band, f2 and f2 signals are cancelled, leaving only f1 and f3. Thus, the output signal λout contains the optical carrier and the two side bands, the lower side band carrying f1 and f3 and the upper side band carrying f2 and f4. The system can be easily modified to reverse the order such that the lower side band will carry f2 and f4 and the upper will carry f1 and f3. As can be appreciated from the spectrum for λout in FIG. 16B, each channel has no directly adjacent channels, that is, every other channel has been cancelled. This is a reason for the term “interleaved” for the modulation technique.

In the above OSSB, the optical carrier can be suppressed by optical filtering to reject the optical carrier. Such an optical filter can be placed at the output of the optical modulator. This optical filter may be a fixed bandpass filter to select a particular predetermined optical carrier frequency for detection or processing. The optical filter may also be a tunable optical bandpass filter to tunably select a desired optical carrier frequency and to select different signals to detect at different times if desired. A fiber Bragg grating filter, tunable or fixed, may be used as the optical filter and may be combined with an optical circulator to direct the filtered and rejected light signals.

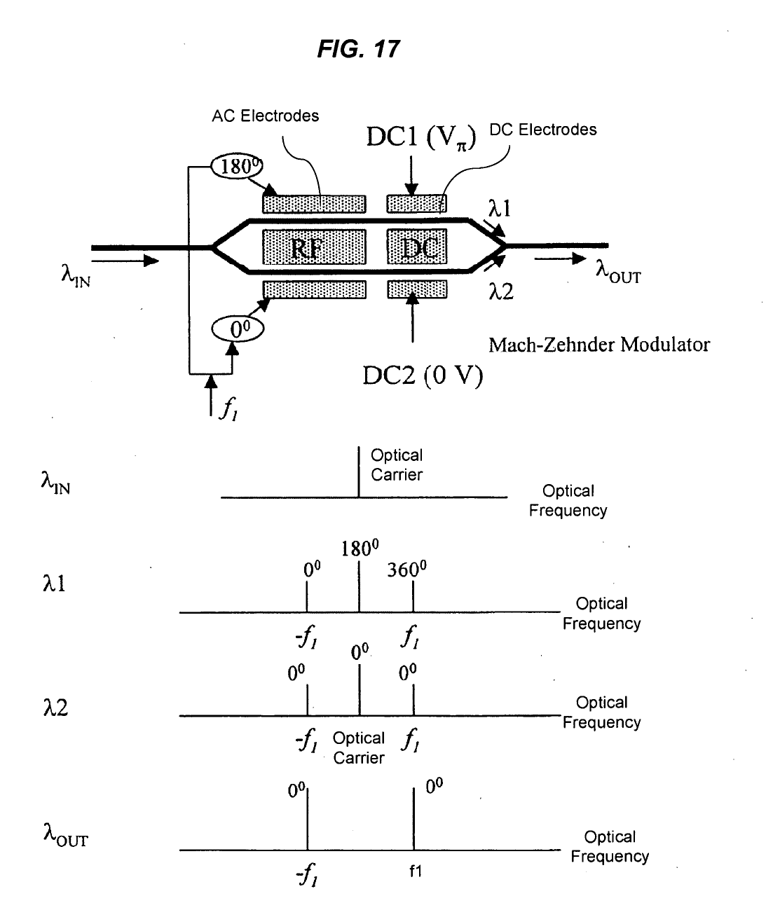

FIGS. 17-22 illustrate various ODSB modulators. The optical double-sideband modulation technique can be used to achieve even higher spectral efficiency than optical single-sideband modulation techniques.

An ODSB modulator, like the examples for the OSSB modulators, may use a Lithium-Niobate Mach Zehnder interferometer (MZI) modulator to carry out the modulation. FIG. 17 illustrates one example of an ODSB modulator. The bias voltages on the DC electrodes of the two optical arms differ in phase by 180 degrees, and the phases of the modulating signals on the AC electrodes of the two arms also differ by 180 degrees. Under these phase conditions, the optical carrier is suppressed in the optical output. This elimination of the optical carrier can reduce or avoid any optical fiber nonlinearity-induced system penalty, and to reduce adjacent channel interference from the optical carrier to the modulated signals. The design in FIG. 17 produces two sidebands representing the same modulating signal, and consequently one half of the available bandwidth in the optical output signal is wasted.

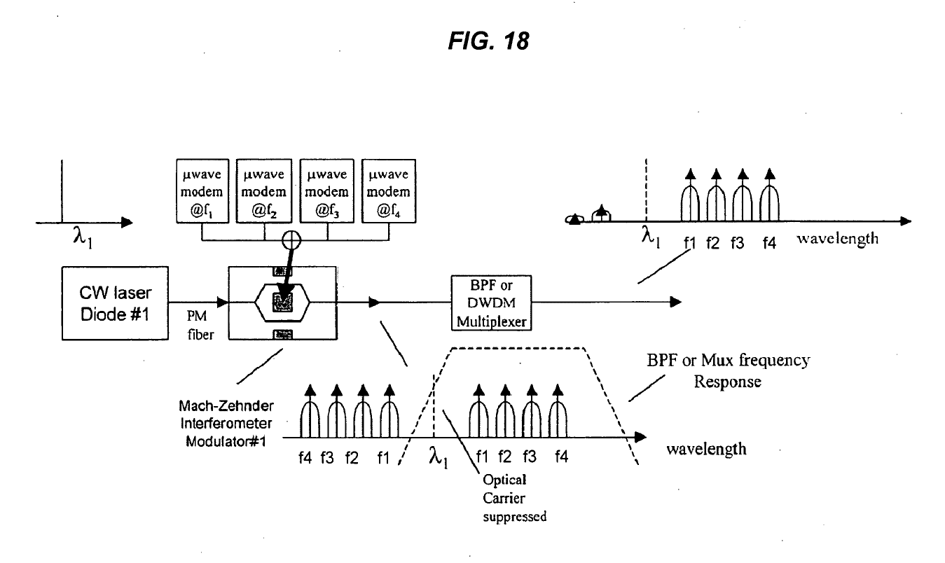

ODSB designs in FIGS. 18-22 can be used achieve higher spectral efficiency than the ODSB modulator in FIG. 17. In some implementations, one or two wavelength-locked CW DFB lasers are used as the optical sources for one or two externally modulated LiNbO3 MZIs, respectively. The center wavelength of each laser is offset from a standard ITU wavelength for WDM, dense WDM, and ultra dense WDM applications. Each MZI is modulated by a few subcarrier multiplexed RF/microwave/millimeter wave signals using ODSB modulation. If one uses only one MZI, the modulated output from the MZI is passed through a narrowband optical filter. If one uses two MZIs, the two sets of ODSB modulated signals are then combined and passed through a narrowband optical filter. The modulating signal center frequencies can be adjusted, depending on (1) the bandwidth of the MZI, (2) the offset of the laser center frequency from a standard ITU grid, (3) the bandwidth of the narrowband optical filter, and (4) the minimization of system performance penalty due to four-wave mixing and other optical nonlinear effects.

In FIG. 18, for an ITU window centered at λ0, a wavelength-locked laser centered at λ1 (equals to λ0−Δλ or λ0+Δλ), where Δλ is the offset wavelength. The output of the laser is connected to the input of an MZI modulator via a polarization-maintaining fiber. The MZI modulator is modulated by multi channel RF/microwave/millimeter wave signals. These RF/microwave/millimeter wave signals can be of any modulation type that can be demodulated by a narrowband channel optical filter and envelop detection. The output of the MZI includes double sideband signals with a suppressed carrier. The double-sideband signals are then sent to a narrowband optical bandpass filter (BPF) or DWDM multiplexer. The center frequency of the BPF or the DWDM multiplexer is at λ0, and its pass-band is just enough to pass one sideband of each modulating signal. The BPF or DWDM multiplexer can be designed such that (1) its pass-band is just enough to pass a group of single sideband signals under all environmental variations (e.g., temperature change), and (2) its edge roll-off can be sharp enough to cut off the unwanted single sidebands on another side of the optical carrier. The wanted single-sidebands should also stay away from the edge of the BPF or DWDM multiplexer to avoid being affected by the nonlinear phase/group delay occurring at the filter band-edges. A single laser is used to produce the sidebands and thus there is no need for locking the relative frequencies of the sidebands.

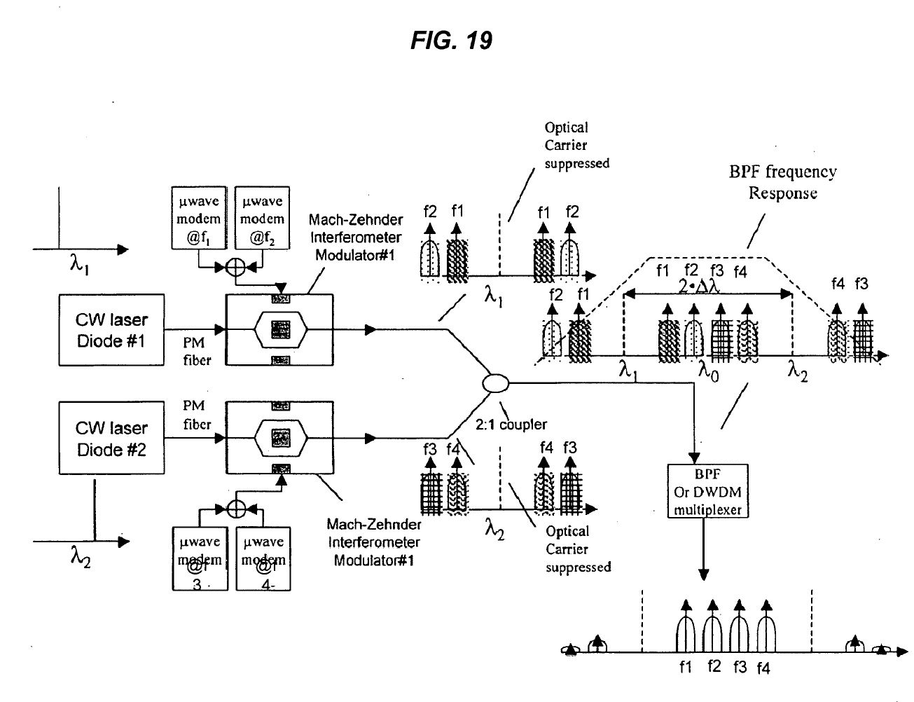

FIG. 19 shows another ODSB design with two wavelength-locked lasers with their laser frequencies centered at λ1 (=λ0−Δλ) and λ2 (=λ0+Δλ), respectively, for an ITU window centered at λ0. Two MZI modulators are used, one for modulating one half of the data channels and the other for modulating the remaining half of the data channels. As such, the modulation bandwidth of each MZI modulator can be one half of that used in FIG. 18. The output of each laser is connected to the input of an MZI modulator via a polarization-maintaining fiber. The outputs of each MZI are also double-sideband signals with suppressed carrier. The first ODSB output from the upper MZI is centered at λ1, and the other ODSB output from the lower MZI is centered at λ2. The two ODSB signals λ1 and λ2 are then combined at an optical combiner (e.g., a 2:1 optical coupler) and sent to an optical bandpass filter (BPF) or a DWDM multiplexer. The center frequency of the BPF or the DWDM multiplexer is at the ITU wavelength λ0, and its pass-band is just wide enough to pass the sidebands of the two ODSB signals λ1 and λ2 between the two optical carriers λ1 and λ2 and narrow enough to reject the two optical carriers and other sidebands. As illustrated, four different modulating signals which can be passed through the BPF or DWDM multiplexer. The final result is an output signal consisting of four different single-sidebands of information. Note that f1 and f2 of the subcarrier multiplexed signals should be high enough such that the unwanted single sidebands can be eliminated more completely.

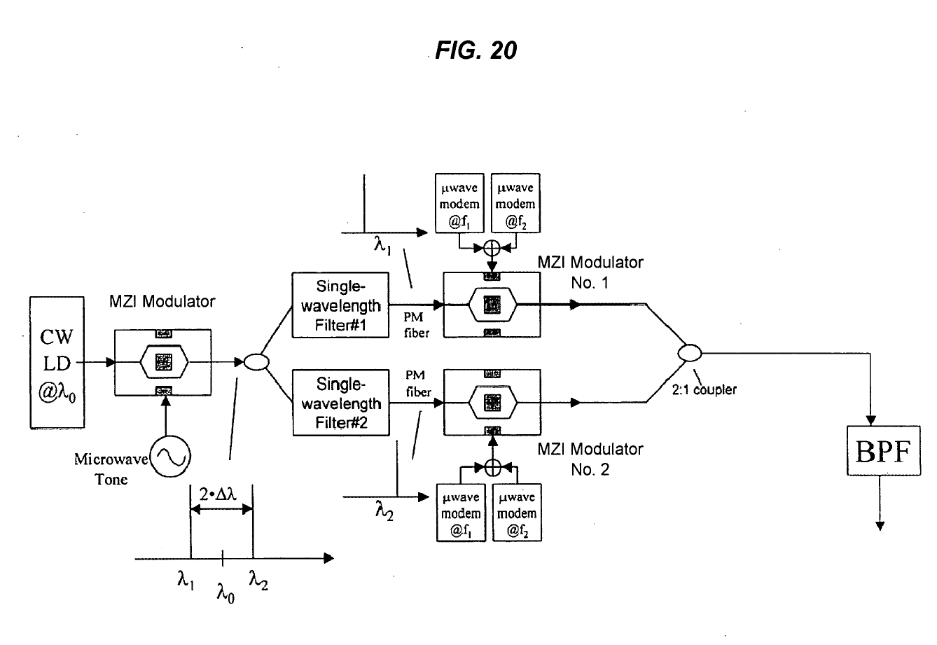

FIG. 20 shows an ODSB modulator using a single optical source such as a CW diode laser to generate two offset optical carriers. A ODSB transmitter, which is a MZI modulator, is being used to generate two offset optical carriers. The ODSB transmitter is modulated by an RF, microwave or millimeter wave tone at a carrier frequency given by (½) (c/λ1−c/λ2)=cΔλ(λ1λ2) where c is the speed of the light. Two narrowband optical filters are used to filter out the optical carriers at λ1 and λ2, respectively. The rest of the operation is the same as the ODSB modulator in FIG. 19.

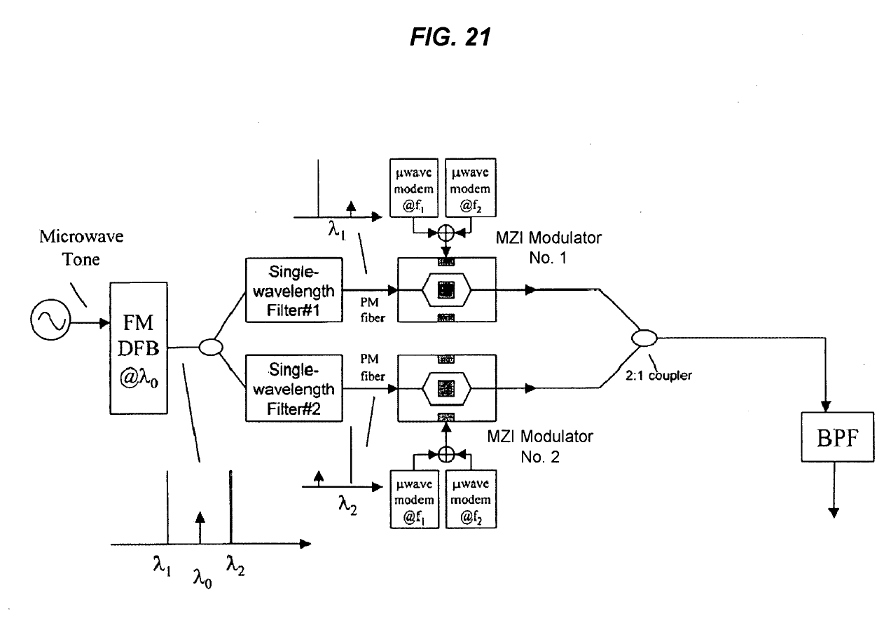

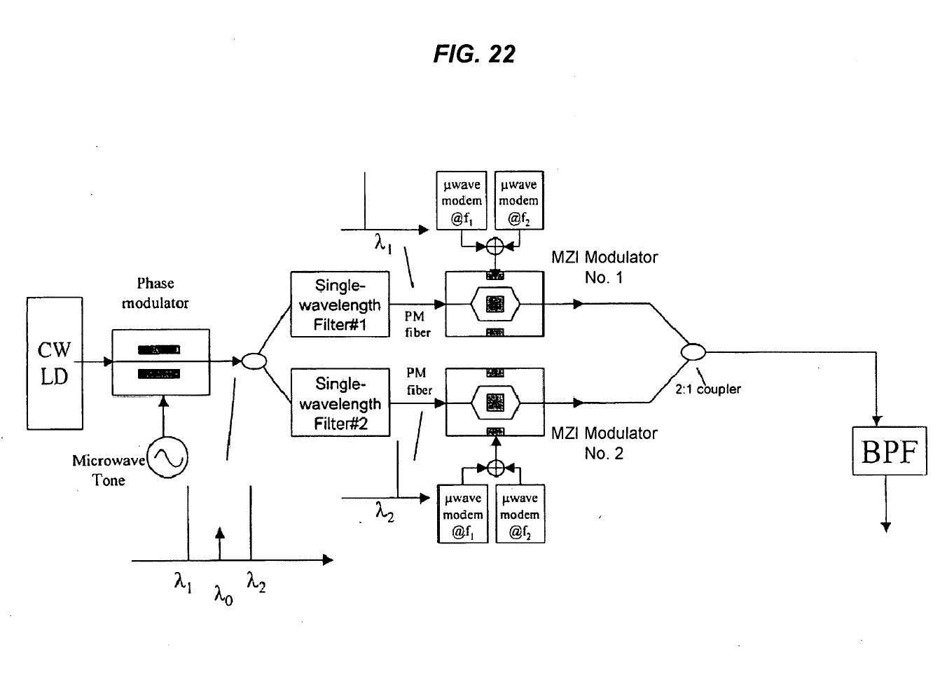

FIG. 21 shows another ODSB modulator using a direct frequency-modulated (FM) laser diode (LD) as the two offset-optical-carrier generating source. According to the basic FM modulation theory, when the FM modulation index β equals 2.4, the center carrier disappears, and the two sidebands at λ1 and λ2 reach a maximum value. Thus, the FM modulation can be controlled to produce the two sidebands at λ1 and λ2 as the two optical carriers. FIG. 22 shows yet another ODSB modulator using a single CW laser diode and an optical phase modulator to modulate the CW laser beam in response to an RF, microwave or millimeter wave tone.

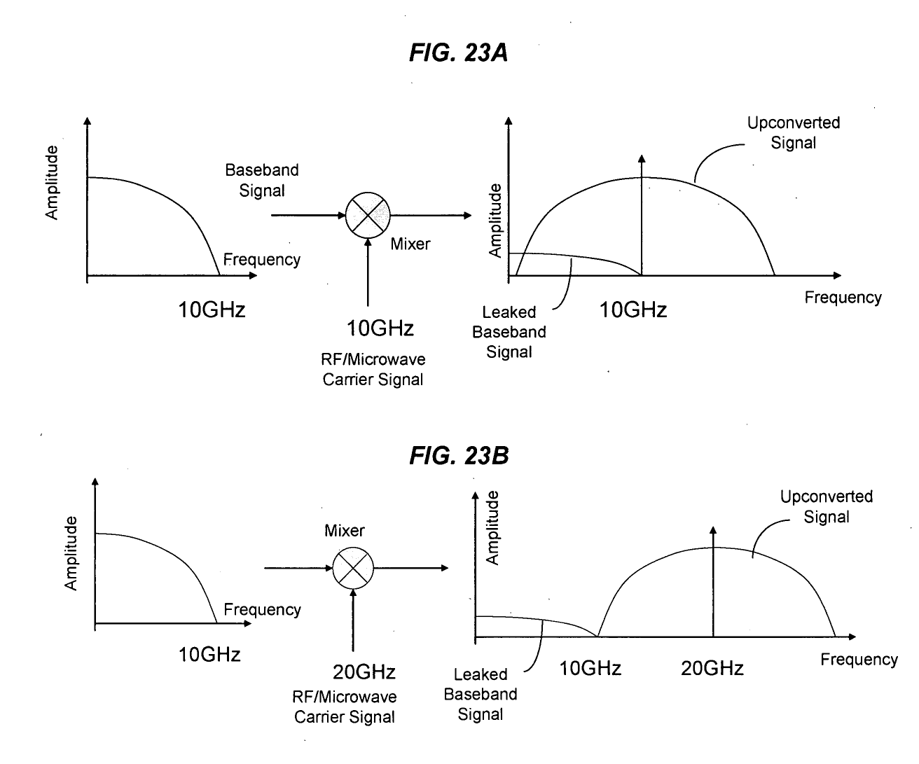

OSSB and ODSB modulations require a guard band between the optical carrier and the microwave/millimeter-wave subcarriers due to various reasons, such as microwave/millimeter-wave mixer IF-to-RF leakage and the minimum group delay requirement within an up-converted bandwidth. FIGS. 23A and 23B illustrate the leakage problem in an microwave/millimeter-wave mixer. In FIG. 23A where a 10-GHz microwave carrier signal and a NRZ 10 Gb/s baseband signal are mixed, the leaked NRZ 10 Gb/s baseband signal overlaps in frequency with the up-converted signal and thus cause interference to degrade the signal quality. In order to reduce this interference, the microwave/millimeter-wave carrier signal can be set at a higher frequency to stay away from the DC baseband signal as shown FIG. 23B. This method essentially creates a guard band between the up-converted signal and the leaked baseband signal. This guard band can significantly reduce the spectral efficiency because there is no useful information in this guard band. Two techniques based on OSSB and ODSB modulations are described below to mitigate this inefficiency in other OSSB and ODSB modulations by placing two signal-carrying sidebands from two modulators close to each other to increase the spectral efficiency.

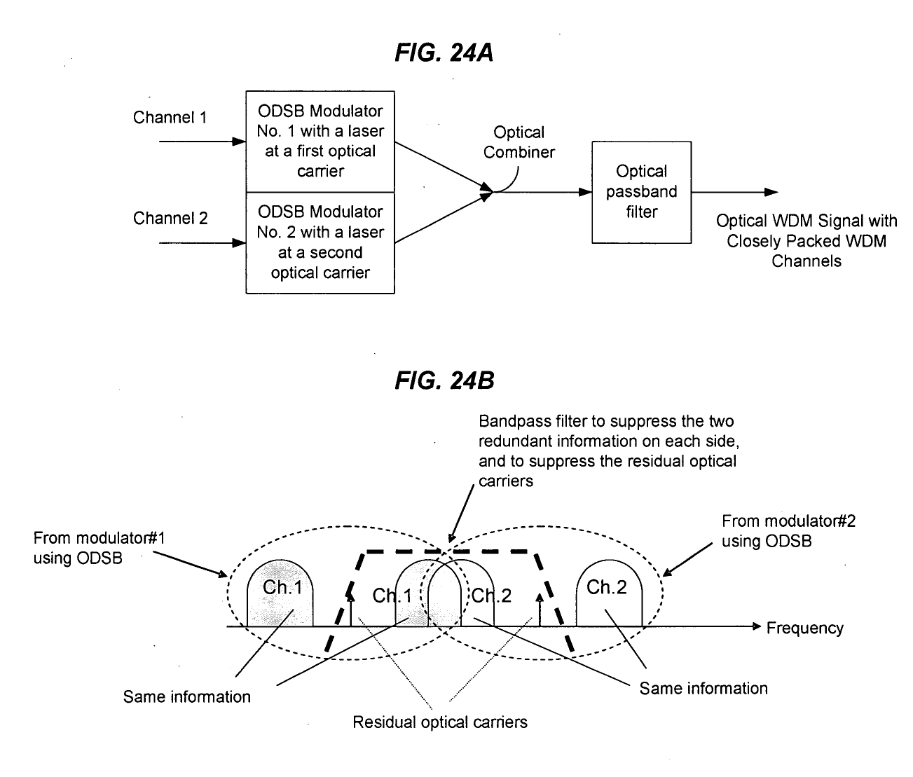

FIGS. 24A and 24B illustrate one modulator with two ODSB modulators. In FIG. 24A, two ODSB modulators are used where the first OSDB modulator is used to produce a first optical signal with a suppressed first optical carrier and two sidebands carrying the same first signal channel and the second ODSB modulator is used to produce a second optical signal with a suppressed second optical carrier and two sidebands carrying the same second signal channel. An optical combiner is used to combine the optical outputs of the two ODSB modulators into a combined signal as shown in FIG. 24B. The first optical signal from the first ODSB modulator is shown on the left side in FIG. 24B and the second optical signal from the second ODSB modulator is shown on the right side in FIG. 24B. The frequencies of the first and second optical carriers are selected relative to each other so that the upper sideband of the first optical signal and the lower side band of the second optical signal are close to each other to increase the spectral efficiency. The two channels, each with X symbols/sec. can be spaced as small as X Hz, provided that the two channels have coherent phases. A narrow optical bandpass filter is placed downstream of the optical combiner to suppress the redundant sidebands at each end of the spectrum.

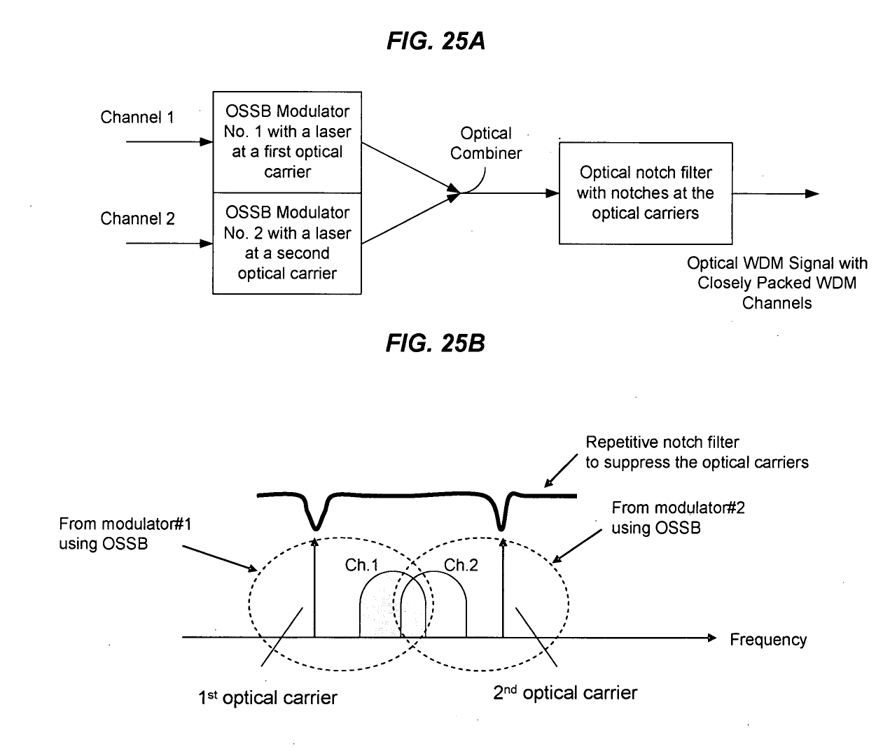

FIGS. 25A and 25B show another example modulator with two OSSB modulators. The two respective optical carrier frequencies used in the two modulators are selected to be close to each other to place the two single sidebands carrying the two channels close to each other. A notch filter with two spectral notches centered at the two optical carriers can be used to suppress the two optical carriers. In general, a repetitive notch filter with notches at the optical carriers can be used to suppress the optical carriers.

In another aspect, optical communications at data bit rates of 40 Gb/s or higher per ITU-window can be implemented by using optical modules designed for operation at lower data bit rates. For example, optical transceivers at 10 Gb/s or 20 Gb/s may be used as building blocks for communications at 40 Gb/s or 100 Gb/s. Two or more 10-Gb/s or 20-Gb/s optical transceivers are arranged to collectively transmit and receive signals at 40 Gb/s or higher. Hence a system that transmits at 40 Gb/s within a 50 GHz ITU-T window can use an optical transceiver that includes four 10-Gb/s optical transceivers or two 20 Gb/s optical transceivers, and a system that transmits at 100 Gb/s within a 100 GH ITU-T window can use an optical transceiver that includes ten 10-Gb/s optical transceivers or five 20 Gb/s optical transceivers. In such systems, a reconfigurable optical add/drop module or multiplexer (ROADM) can be combined with one or more tunable optical filters to drop one or more selected 10-Gb/s or 20-Gb/s signals from the main network while direct the remaining 10-Gb/s or 20-Gb/s signals to continue in the main network. The one or more tunable optical filters can be connected to the drop port of a ROADM with channel spacing of 100 GHz or 50 Hz spacing to transmit the signals to be dropped and to reflect the signals to be maintained in the main network.

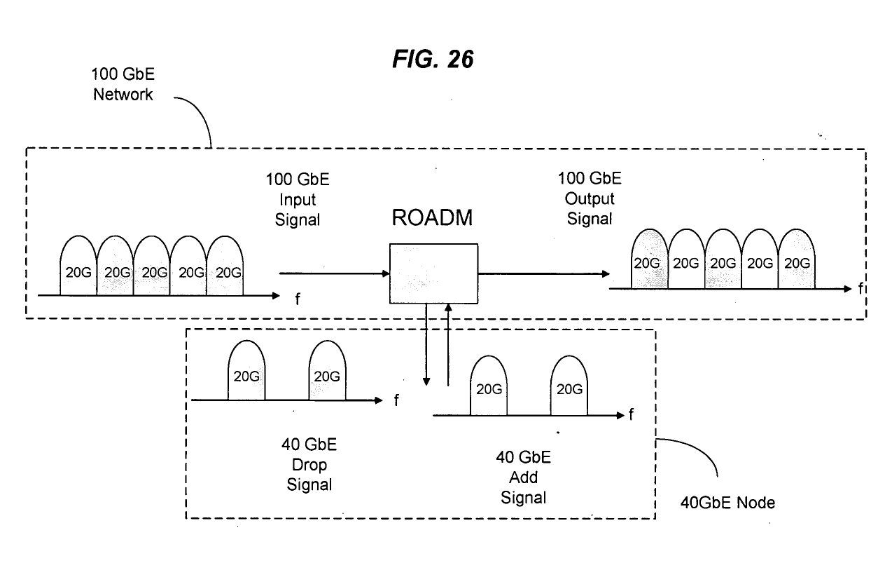

FIG. 26 illustrates an example of a 20 G-based 40 G or 100 G transmission with 20 G add/drop granularity. Consider an example of transmitting a 100 G signal from a starting node A to two intermediate nodes B and C and finally to a destination node D in the network. At the intermediate node B or C in the transmission path of the 100 G signal, an integer multiple of 20 G signals (i.e., 20 G, 40 G, 60 G, 80 G, and 100 G) can be optically dropped or added. The drop and add granularity can be as low as 10 G, and a minimum of 20 G hardware can be equipped at each intermediate add/drop site. The use of two optical channels (2×20 G) within a 50 GHz ITU-T window is compatible in bandwidth with 50 GHz-spaced ROADMs, while the use of five 20 G optical channels (5×20 G) within a 100 GHz ITU-T window is compatible in bandwidth with 100 GHz-spaced ROADMs. In FIG. 26, all five 20 G channels are dropped into a ROADM drop port simultaneously. In a case where two channels out of the five channels are to be dropped at the ROADM, two cascaded tunable filters can be connected downstream from the ROADM drop port to selectively drop these two channels and reflect the remaining three channels. The reflected three channels can then be combined with another two newly generated channels at the optical wavelengths of the two dropped channels to launch into one of the add ports of another ROADM.

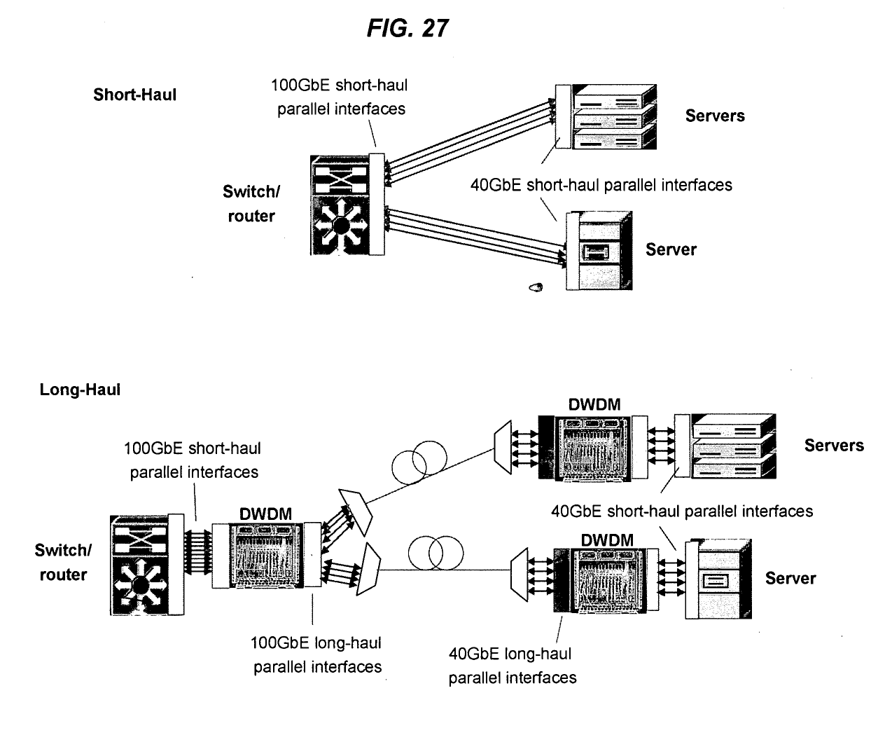

The above described ultra-dense WDM techniques with optical parallel channels can be used to make cost-efficient 100 GbE and 40 GbE systems based on the same 20 G-equipment. FIG. 27 shows that, if both long-haul 40 G networks and 100 G networks use the same modulation format for the main granular module based on 20 G optical parallel channels, it is possible that 40 GbE infrastructure and 100 GbE infrastructure can be compatible with each other. Under this design, a 40 GbE transmission uses two channels of 20 Gb/s DQPSK signals with a baud rate at 10 Gbaud and the 100 GbE transmission uses five channels of 20 Gb/s DQPSK signals with a baud rate at 10 Gbaud, then the 40 GbE is simply a “subset” of the 100 GbE, and they can be mutually compatible at the optical layer.

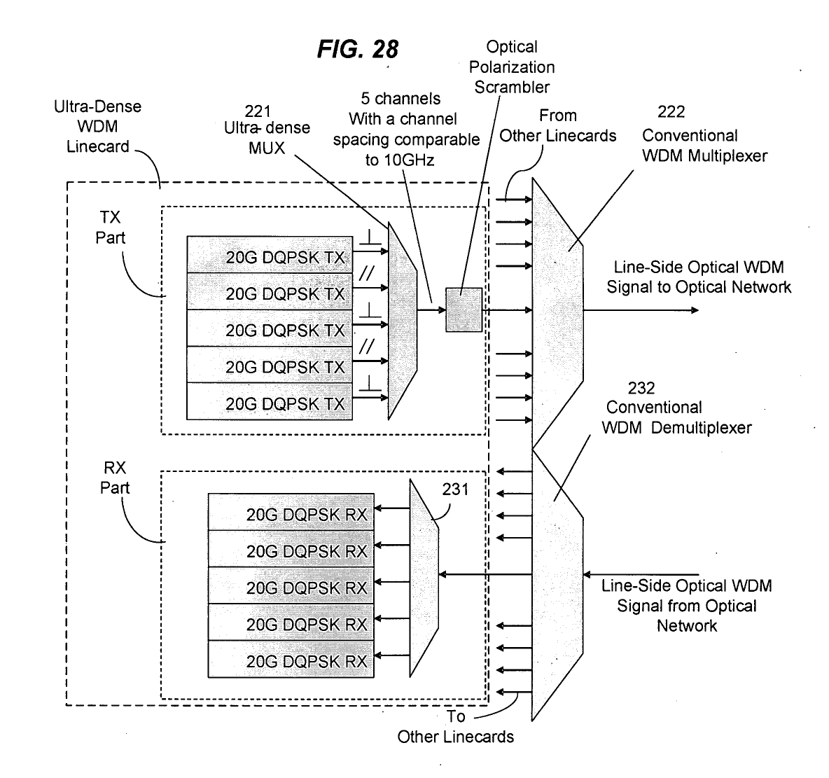

FIG. 28 shows another example of a system where 20 G WDM units are used as building blocks for a 100 G transceiver line card. The transmitter part of the line card includes five 20 G DQPSK transmitters based on, e.g., the design in FIGS. 4, 6, 7, and 8, to produce five 20 G optical channels with two adjacent channels being orthogonally polarized to each other. The ultra-dense MUX 115 or a polarization combiner is used to combine the five 20 G optical channels to form a 100 G optical signal. The WDM multiplexer 222 is then used to combine multiple such 100 G optical signals into a WDM output signal to the optical network. The receiver part of the line card includes five 20 G DQPSK receivers each of which may be implemented based on the receiver design in FIGS. 4,6,7, and 8.

To mitigate the polarization-dependent gain(PDG), polarization-dependent loss (PDL), and PMD effects, a polarization scrambler can be placed at the output of each ultra dense MUX 221, either as the client side output port or as component outside the linecard, to randomize the optical polarization at a high speed. This polarization scrambling can be implemented as an optional feature in each of the exemplary systems as illustrated in FIG. 28 and other selected figures to improve the system's tolerance to the PDG/PDL/PMD effect in the fiber links. Notably, it is sufficient to implement a polarization scrambler at the output of each ultra dense MUX 221 in the transmitter side of the line card without modifying either the fiber links in the network or the client side equipment. This can be implemented by using a line card equipped with polarization scramblers in the parallel line side optical channels to replace a legacy line card. Therefore, the upgrade and installation are simple and changes are localized without affecting the client side equipment and the fiber infrastructure of the network.

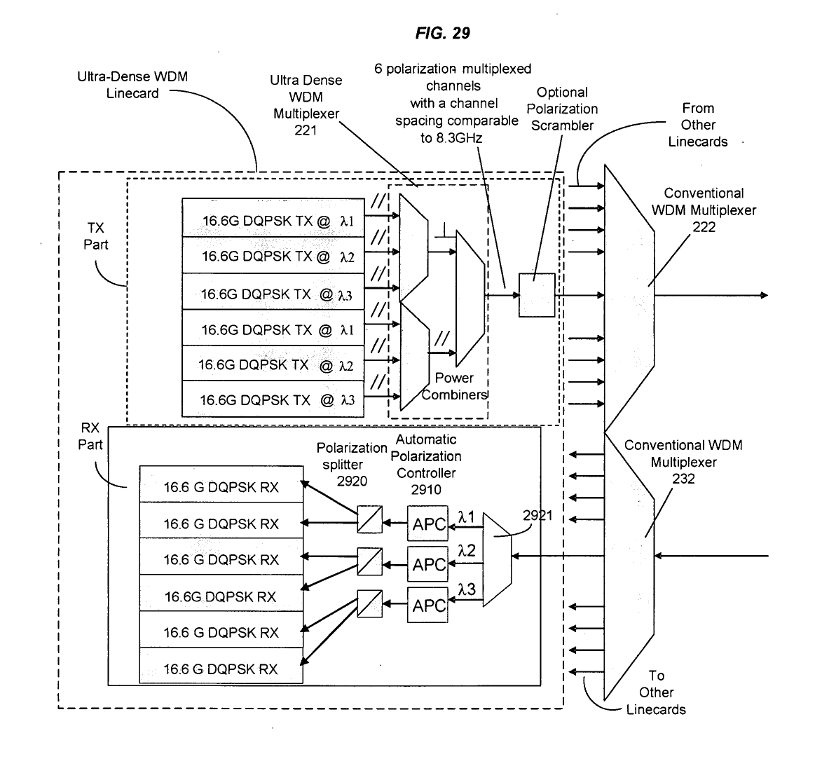

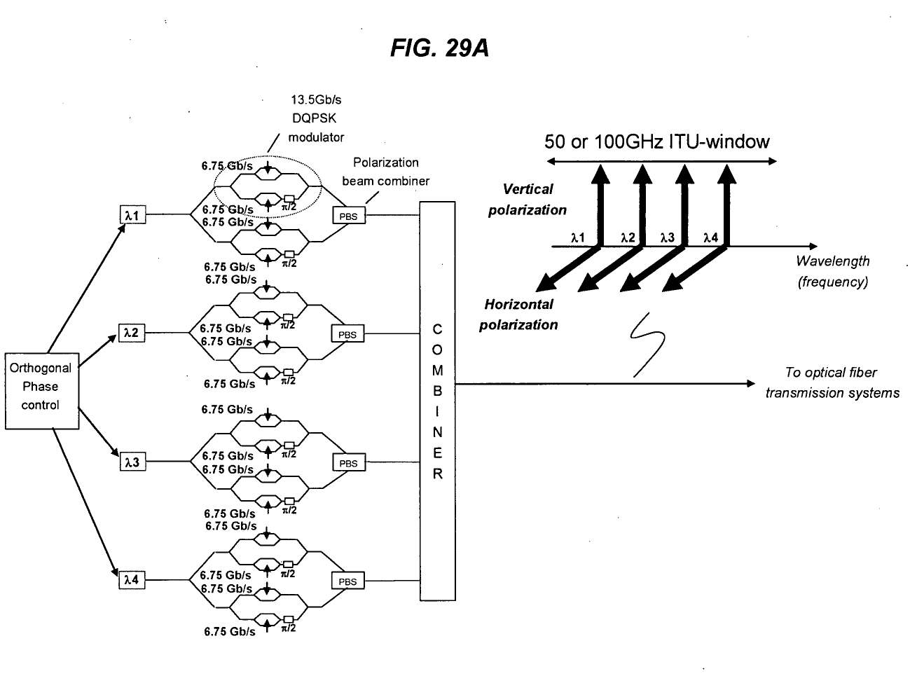

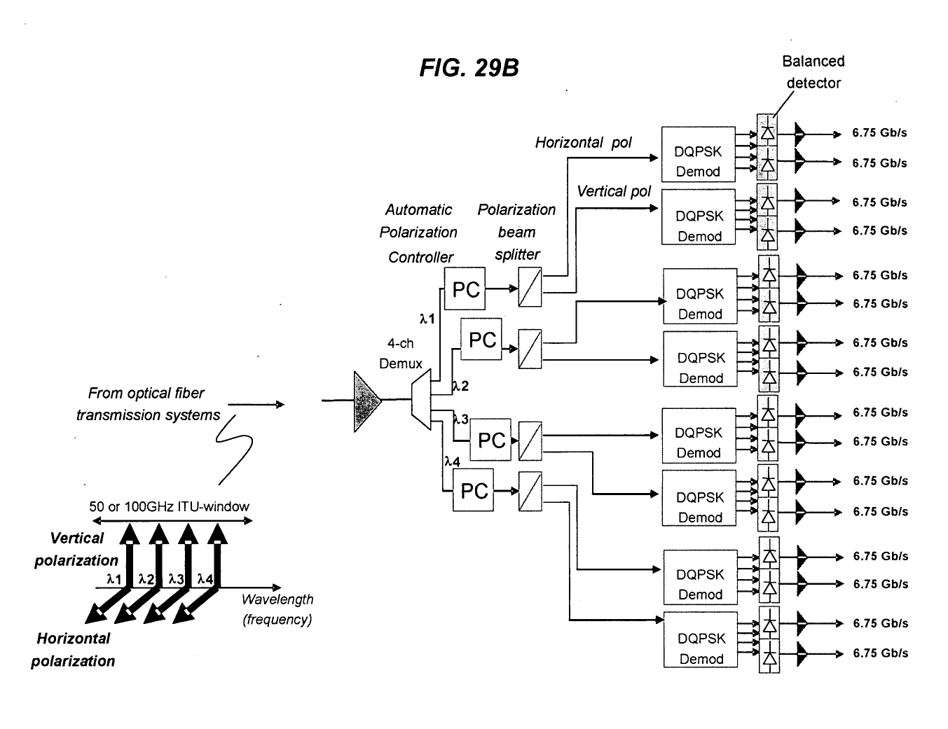

FIG. 29 shows an example of a linecard where each optical transmitter implements both polarization multiplexing and polarization scrambling. Two groups of optical signals with the same optical wavelengths are used to carry different signals for the two optical signals at the same wavelength in the two groups. The signals within each group have the same optical polarization. A first polarization combiner is used to combine the optical signals in the first group into a first combined optical signal and a second polarization combiner is used to combine the optical signals in the second group into a second combined optical signal. A third polarization combiner is then used to combine the outputs from the first and second polarization combiners in a way that the signals in the first group are in a first optical polarization and the signals in the second group are in a second polarization orthogonal to the first polarization. This combining operation produces an optical WDM signal where two signals at the same optical wavelength are polarization multiplexed. Therefore, at each optical wavelength in the optical WDM signal output by the third optical polarization combiner, there are two optical signals carrying different channels. An optional polarization scrambler can be placed in the path of the output of the third polarization combiner to scramble the optical polarization of the optical WDM signal. The polarization scrambled optical WDM channel is then combined with other polarization scrambled optical WDM channels from other linecards by the WDM MUX 222. The polarization scrambler is used as the line side output port for the linecard. This polarization multiplexing of multiple parallel WDM signals can be used to double the channels within a bandwidth of a standard ITU-T window of 50 GHz or 100 GHz. In the specific example illustrated in FIG. 29, where each of the two groups of signals has three different optical wavelengths, the above polarization multiplexing technique allows three channels in the first optical polarization (e.g., the vertical polarization) and three channels in the second optical polarization (e.g., the horizontal polarization). As such, the required data rate for each channel can be one half of the channel data rate without the polarization multiplexing for the same total transmission capacity. For transmission at 100 Gbps, each channel can just carry 100 Gbps/6=16.67 Gbps or 8.35 Gbaud under the DQPSK modulation.

At the receiver side of the line card in FIG. 29, an ultra dense DEMUX 2921 is provided as the line side input port of the linecard in each optical path of the separated optical WDM signals out of the WDM DEMUX 232. Three polarization controllers 2910 are placed at each output port of the DEMUX 2921, and are used to control the polarization of each optical signal to optimally separate two polarization multiplexed signals at each common optical wavelength. A polarization splitter 2920 is placed down stream from each of the polarization controller 2910 to split the received light into two light signals with orthogonal polarizations, for signal demodulation and detection.

This polarization multiplexing design can be implemented in the line side optical transmission part and line side optical receiving part in the ultra dense WDM linecard examples described in this document, including the linecards illustrated in FIGS. 2A-2D where the electronic-to-optical conversion units 113 and the optical-to-electronic conversion units 123 can be implemented as shown in FIG. 29. Notably, due to the polarization multiplexing on the line side, the line-side data rate for each channel can be one half of the channel data rate of each channel on the client side. This feature improves the signal quality for the line side transmission.

FIGS. 29A and 29B show an example of an optical transmitter part and an example of an optical receiver part based on the above polarization multiplexing design. The optical transmitter part in FIG. 29A includes multiple DQPSK optical modulators with two DQPSK optical modulators for generating two signal channels at each WDM wavelength. For each pair of DQPSK optical modulators at a common WDM wavelength, a PBS combiner is placed downstream to combine the two WDM signals at the common wavelength in mutually orthogonal polarizations to produce a polarization multiplexed signal. Multiple such polarization multiplexed signals from different pairs are then combined by a beam combiner, such as a WDM multiplexer, to form the output WDM signal for transmission to the fiber system. The optical receiver part in FIG. 29B includes an ultra-dense DEMUX at the receiver input, followed by an automatic polarization controller and a polarization beam splitter for each wavelength that separates the received wavelength into two orthogonal polarizations for detection.

As discussed above, an optical WDM comb generator based on a single laser can be used to generate ultra dense optical comb carriers in the transmitter part of line card. Such comb generators can be based on OSSB modulation. Notably, the phase of each of the multiple comb carriers can be controlled.

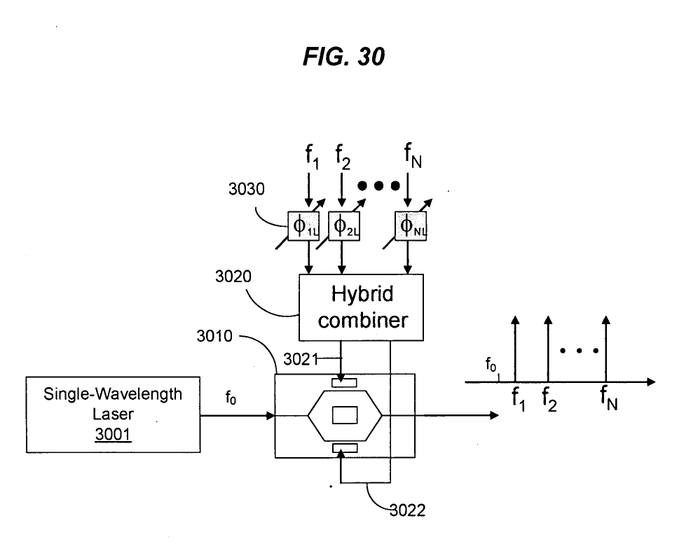

FIG. 30 shows an exemplary optical WDM comb generators based on OSSB modulation to provide such phase control. In this example, the laser out at f0 from a laser 3001 is split into two optical branches of the MZI modulator 3010. The two optical branches are applied with, respectively, two microwave/mmwave signals 3021 and 3022 each carrying multiple RF carriers f1, f2, . . . , fN. Under OSSB, the two microwave/mmwave signals 3021 and 3022 are phase shifted relative to each other by 90 degrees and the two optical branches are DC biased relative to each other by 90 degrees. One or more microwave/millimeter-wave hybrid signal combiners 3020 are provided to combine the multiple microwave/mmwave carriers f1, f2, . . . , fN and to produce the two phase-shifted microwave/mmwave signals 3021 and 3022. The optical interference between the two modulated optical carrier signals from the two optical branches suppressed the optical carrier at f0 and sidebands on one side of the optical carrier. In the example shown, the upper sidebands are preserved as the output optical comb carriers. The spacing of the optical comb carriers are determined by the microwave/mmwave carrier frequencies f1, f2, . . . , fN and the spacing between different adjacent carriers can be different depending on the values of the microwave/mmwave carrier frequencies f1, f2, . . . , fN. This provides flexibility in generating desired comb frequency spacings.

Notably, adjustable microwave/mmwave phase control units 3030 are provided in the signal paths of the multiple microwave/mmwave carriers f1, f2, . . . , fN upstream from the microwave/mmwave signal combiner 3020. Each RF phase control unit 3030 can independently control the phase for a respective microwave/mmwave carrier. Consequently, the phase values of the output comb carriers at f1, f2, . . . , fN can be individually controlled at desired values for specification applications.

One application of such a comb generator for producing phase-controlled comb carriers, for example, is a transmitter for communications based on orthogonal frequency division multiplexing (OFDM) where two adjacent carriers are orthogonal to each other in phase. For example, the coherent phases of the two optical carriers in FIGS. 24 and 25 can use the comb generator mentioned here. In various OFDM systems, the phase values of OFDM carriers are generated and controlled digitally, i.e., using DFT and IDFT. The device in FIG. 30, however, can be used to generate OFDM carriers in the analog domain, or analog OFDM. In the analog OFDM, the channel spacing between microwave/millimeter-wave carriers (and consequently the optical carriers) is set to be equal to the symbol rate, and the phase of each carrier is coherently adjusted. Such phase adjustment can be implemented based on the same principle used in the digital OFDM. This microwave/mmwave phase control can be implemented in the above described line cards to improve the device performance.

The above examples illustrate systems where the client side signal rate and the number of parallel optical lanes match the line side signal rate and the number of parallel optical lanes. For example, in FIG. 2A, the client side equipment may have a signal rate of 25 Gb/s and have four parallel optical channels to provide a total signal rate of 100 Gb/s. Symmetrically, the line side also has a signal rate of 25 Gb/s and have four parallel optical channels to provide a total signal rate of 100 Gb/s.

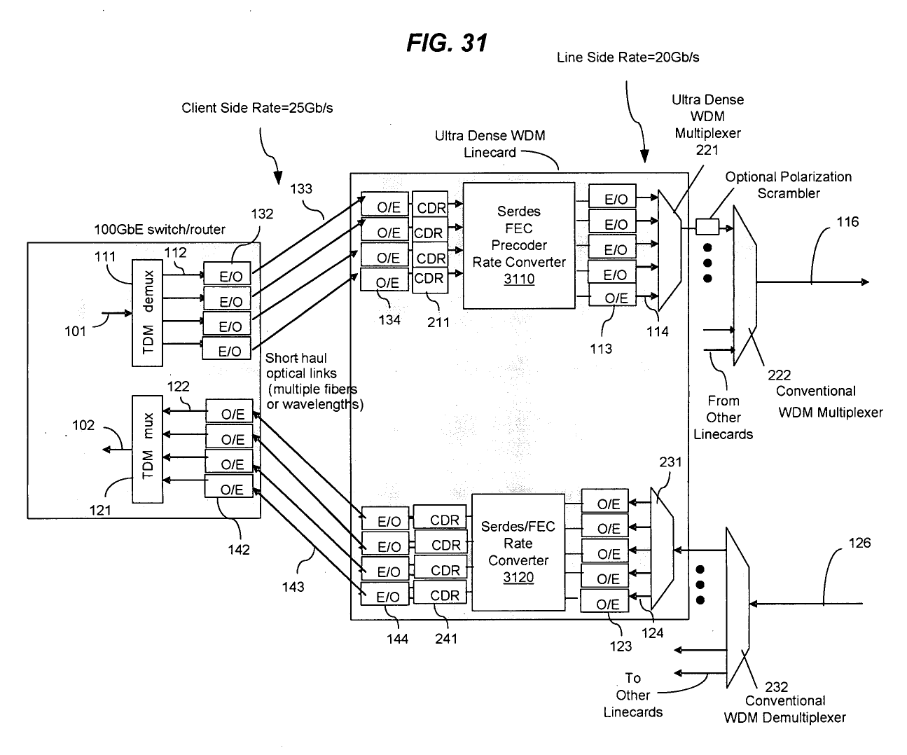

In some systems, however, the client side equipment and the line side signals may not match in their signal rates and the number of parallel optical channels. FIG. 31 shows an example where the line side rate is 20 Gb/s and there are five parallel optical channels on the line side. This arrangement also supports a total rate of 100 Gb/s just like the 4-channel and 25-Gb/s per channel arrangement on the client side. Under this mismatch between the client side and the line side, a rate conversion can be implemented to accommodate this difference. In the example in FIG. 31, an electronic circuit module 3110 includes a rate converter function in addition to the serdes, FEC and precoder functions. This rate converter converts the 4 parallel channel signals at 25 Gb/s each into 5 parallel channels at 20 Gb/s each. Similarly, an electronic circuit module 3120 is implemented on the receiver part of the line card and also includes a rate converter function in addition to the serdes and FEC functions. This rate conversion mechanism allows the line card designs described in this document to have versatile applications in various systems configurations. For example, the linecard examples in FIGS. 2A-2D can implement this rate conversion mechanism. In the above described examples where the correspondence between the number of client-side electrical signals and the number of long-haul side wavelengths or line side optical signals is greater than 1, such as 2:1 when the optical vector modulator is used and log₂M:1 for M-QAM modulation. In the presence of the rate converters, the above correspondence between the number of client-side electrical signals and the number of long-haul side wavelength becomes the correspondence between the number of electrical signals output from the line converter and the number of long-haul side wavelengths or line side optical signals.

In FIG. 2A, for example, the client side optical signals have a number of optical signals different from a number of line side optical signals, and the client side data rate is different from a line side data rate of the line side optical signals. Under this condition, the linecard in FIG. 2A can include a first electronic rate conversion mechanism that processes the electrical signals at the client side data rate to produce first converted electrical signals at the line side data rate to the line side optical transmitters, and a second electronic rate conversion mechanism that processes the line side electrical signals at the line side data rate to produce second converted electrical signals at the client side data rate to the client side optical transmitters.

In FIG. 2C, for another example, the client side electrical signals have a number of electrical signals different from a number of line side optical signals, and the client side data rate is different from a line side data rate of the line side optical signals. Under this condition, the linecard in FIG. 2C can include a first electronic rate conversion mechanism that processes the electrical signals at the client side data rate to produce first converted electrical signals at the line side data rate to the line side optical transmitters, and a second electronic rate conversion mechanism that processes the line side electrical signals at the line side data rate to produce second converted electrical signals at the client side data rate to the client side electrical ports.

In the above examples, different optical channels for the long-haul transmission use the same signal modulation format. In some applications, different optical channels for the long-haul transmission may use the different signal modulation formats and the data bit rates for different channels can be different. As such, not all channels are designed in the expensive signal modulation and demodulation techniques and certain parallel channels can use less expensive signal modulation and demodulation techniques when possible, e.g., the signal degradation is less than other channels.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination.

Only a few implementations are disclosed. However, it is understood that variations and enhancements of the described implementations and other implementations can be made based on what is described and illustrated.

What is claimed is:

1. An optical WDM communication device for providing communications between client side equipment and a fiber network, comprising:
a plurality of client side optical receivers as client side input ports to receive from the client side equipment, respectively, a plurality of parallel client side optical signals each having a client side data rate at approximately 10 Gb/s and to produce a plurality of electrical signals that respectively correspond to the optical WDM signals, wherein a sum of the client side data rates of the client side optical WDM signals is comparable to or greater than 40 Gb/s;
a plurality of transmitter signal processing circuits that respectively receive and process the electrical signals to produce output electrical signals;
a plurality of line side optical transmitters that receive the output electrical signals from the transmitter signal processing circuits, respectively, to produce a plurality of line side optical WDM signals at different WDM wavelengths carrying the electrical signals at a data symbol rate with a total capacity comparable to or greater than 40 Gb/s and with a total bandwidth within an International Telecommunication Union (ITU) spectral window;
a WDM multiplexer that multiplexes the line side optical WDM signals to produce a line side output WDM signal for transmission over the fiber network;
a WDM demultiplexer that receives from the fiber network an input line side optical WDM signal containing a plurality of line side optical WDM signals and separates the received input line side optical WDM signal into the plurality of line side optical WDM signals;
a plurality of line side optical receivers to receive, respectively, the line side optical WDM signals and to produce a plurality of line side electrical signals that respectively correspond to the line side optical WDM signals;
a plurality of receiver signal processing circuits that respectively receive and process the line side electrical signals to produce output electrical signals; and
a plurality of client side optical transmitters that receive the output electrical signals from the receiver signal processing circuits, respectively, to produce a plurality of client side parallel optical signals to the client side equipment carrying the line side electrical signals each at the client side data rate of approximately 10 Gb/s.

2. The device as in claim 1, wherein:
the ITU spectral window is 50 GHz or 100 GHz.

3. The device as in claim 1, wherein:
the line side optical transmitters make the line side optical WDM signals at different WDM wavelengths have a frequency spacing between two adjacent optical WDM signals comparable to the symbol date rate.

4. The device as in claim 1, wherein:
the line side optical transmitters make the line side optical WDM signals at different WDM wavelengths have a frequency spacing between two adjacent optical WDM signals greater than the symbol data rate up to approximately two times of the data symbol rate.

5. The device as in claim 1, wherein:
each line side optical transmitter performs a signal modulation in the microwave/millimeter-wave domain and applies a modulated microwave/millimeter-wave signal to modulate an optical beam to produce a respective line side optical WDM signal at an optical WDM wavelength.

6. The device as in claim 5, wherein:
the signal modulation in the microwave/millimeter-wave domain performed is a microwave/millimeter-wave subcarrier modulation that produces the modulated microwave/millimeter-wave signal; and
the line side optical transmitter comprises a Mach-Zehnder optical modulator that performs an optical single sideband (OSSB) modulation in response to the modulated microwave/millimeter-wave signal to produce a respective line side optical WDM signal.

7. The device as in claim 6, comprising:
a plurality of receiver lasers to produce local laser carrier beams at different local laser carrier frequencies, respectively, that correspond to line side optical WDM signals, respectively; and
wherein each line side optical receiver comprises an optical detector that receives and detects both a respective line side optical WDM signal and a respective local laser carrier beam and performs an optical heterodyne detection to produce a respective line side electrical signal.

8. The device as in claim 5, wherein:
the signal modulation in the microwave/millimeter-wave domain is a microwave/millimeter-wave subcarrier modulation that produces the modulated microwave/millimeter-wave signal; and
the line side optical transmitter comprises a Mach-Zehnder optical modulator that performs an optical double sideband (ODSB) modulation in response to the modulated microwave/millimeter-wave signal to produce a respective line side optical WDM signal.

9. The device as in claim 8, comprising:
a plurality of receiver lasers to produce local laser carrier beams at different local laser carrier frequencies, respectively, that correspond to line side optical WDM signals, respectively; and
wherein each line side optical receiver comprises an optical detector that receives and detects both a respective line side optical WDM signal and a respective local laser carrier beam and performs an optical heterodyne detection to produce a respective line side electrical signal.

10. The device as in claim 5, wherein:
each line side optical receiver performs a signal demodulation in the optical domain in processing a respective line side optical WDM signal to produce a respective line side electrical signal to a respective client side optical transmitter.

11. The device as in claim 1, wherein:
each line side optical transmitter performs a signal baseband modulation in the optical domain to produce a respective line side optical WDM signal at an optical WDM wavelength; and
each line side optical receiver performs a signal demodulation in the microwave/millimeter-wave domain in processing a respective line side optical WDM signal to produce a respective line side electrical signal directed to a corresponding client side optical transmitter.

12. The device as in claim 11, wherein:
each line side optical transmitter operates to preserve an optical carrier separate in frequency from a respective line side optical WDM signal for transmission, and
each line side optical receiver comprises an optical detector that detects both a respective line side optical WDM signal and a respective optical carrier and performs an optical heterodyne detection to produce a respective line side electrical signal.

13. The device as in claim 12, wherein:
each line side optical transmitter comprises:
a laser to produce a CW laser beam at a laser frequency;
a Mach-Zehnder optical modulator to modulate the CW laser beam under control of a first electrical oscillation signal at a first frequency and carrying a baseband signal and a second electrical oscillation signal at a second, different frequency without carrying a baseband signal to produce a modulated optical signal; and
an optical filter downstream from the Mach-Zehnder modulator to suppress light at the laser frequency and to transmit light at a modulation sideband carrying the baseband signal as the respective line side optical WDM signal and another modulation sideband corresponding to the second electrical oscillation signal as the optical carrier.

14. The device as in claim 12, wherein:
each line side optical transmitter comprises:
a laser to produce a CW laser beam at a laser frequency;
a Mach-Zehnder optical modulator to modulate the CW laser beam under control of a first electrical oscillation signal at a first frequency to produce a modulated optical signal carrying first and second modulation sidebands on two sides of the laser frequency while suppressing light at the laser frequency;
an optical splitter to split the modulated optical signal into a first optical signal and a second optical signal in two separate optical paths;
a first optical filter that filters the first optical signal to transmit the first modulation sideband while suppressing the second modulation sideband to produce a first filtered optical signal;
a second optical filter that filters the second optical signal to transmit the second modulation sideband while suppressing the first modulation sideband to produce a second filtered optical signal;
a baseband optical modulator located downstream from the second optical filter to receive the second filtered optical signal and to perform a baseband optical modulation to impose a baseband signal onto the second modulation sideband in the second filtered optical signal; and
an optical combiner that combines the first filtered optical signal and the second filtered optical signal to produce a respective line side optical WDM signal where the respective optical WDM wavelength is at a wavelength of the second modulation sideband and the optical carrier is at the first modulation sideband.

15. The device as in claim 1, wherein:
each line side optical transmitter performs a signal baseband modulation in the optical domain to produce a respective long-haul optical signal at an optical WDM wavelength; and
each line side optical receiver performs a signal demodulation in the optical domain in processing a respective line side optical WDM signal to produce a respective line side electrical signal directed to a corresponding client side optical transmitter.

16. The device as in claim 15, wherein:
each line side optical transmitter performs a differential quadrature phase shift keying (DQPSK) modulation, and
each line side optical receiver performs a direct optical detection and demodulation of a DQPSK signal received by the line side optical receiver.

17. The device as in claim 16, wherein:
the line side optical transmitters are selected to have operating wavelengths with a channel spacing between 12.5 and 25 GHz when each line side optical transmitter is operated at approximately 10 Gbaud, and
each line side optical transmitter is coupled to two of client side electrical signals.

18. The device as in claim 16, wherein:
the line side optical receiver comprises a delay interferometer with an optical delay less than one symbol duration to increase a free spectral range of the delay interferometer.

19. The device as in claim 15, wherein:
each line side optical transmitter performs a differential M-ary PSK modulation (DMPSK) modulation, and
each line side optical receiver performs a direct optical detection and demodulation of a DMPSK signal received by the line side optical receiver.

20. The device as in claim 1, wherein:
two line side optical WDM signals at two adjacent optical WDM wavelengths have orthogonal optical polarizations.

21. The device as in claim 1, wherein:
each line side optical transmitter performs the signal modulation in a duobinary modulation format.

22. The device as in claim 1, wherein:
each line side optical transmitter performs a configurable signal modulation between a duobinary and a DPSK modulation format by changing the delay of a delay-and-add device located after the modulator driver.

23. The device as in claim 1, wherein:
each line side optical transmitter performs the signal modulation in a multiple level phase shifting keying (M-PSK) format.

24. The device as in claim 23, wherein:
the line side optical transmitters are selected to have operating wavelengths with a channel spacing between 12.5 and 25 GHz when each line side optical transmitter is operated at approximately 10 Gbaud, and
each line side optical transmitter is coupled to log₂M of client side electrical signals.

25. The device as in claim 1, wherein:
each line side optical transmitter performs the signal modulation in a multiple level quadrature amplitude modulation (M-QAM) format.

26. The device as in claim 25, wherein:
the line side optical transmitters are selected to have operating wavelengths with a channel spacing between 12.5 and 25 GHz when each line side optical transmitter is operated at approximately 10 Gbaud, and
each line side optical transmitter with a unique wavelength is coupled to log₂M of the output electrical signals.

27. The device as in claim 1, wherein:
each line side optical transmitter performs the signal modulation in a differential M-ary phase shift keying (DMPSK) format, and
each line side optical receiver receives, respectively, a respective line side optical WDM signal and a respective optical carrier to perform a coherent optical detection in generating a respective line side electrical signal.

28. The device as in claim 27, wherein:
the line side optical transmitters are selected to have operating wavelengths with a channel spacing between 12.5 and 25 GHz when each line side optical transmitter is operated at approximately 10 Gbaud, and
each line side optical transmitter is coupled to log₂M of the output electrical signals.

29. The device as in claim 27, comprising:
a mechanism to generate optical carriers and to mix the generated optical carriers with the line side optical WDM signals, respectively, at the line side optical receivers, for the coherent optical detection.

30. The device as in claim 27, comprising:
a mechanism to generate optical carriers that correspond to line side optical WDM signals at different WDM wavelengths, respectively, to mix the generated optical carriers with the line side optical WDM signals at the WDM multiplexer to produce the line side output WDM signal that contains the generated optical carriers.

31. The device as in claim 1, wherein:
each line side optical transmitter comprises:
a signal monitoring mechanism that monitors line side optical WDM signals and produces a feedback signal indicating whether one of the line side optical WDM signals fails; and
a feedback control unit that receives the feedback signal from the signal monitoring mechanism and operates to respond to a failure in a line side optical WDM signal by distributing data carried by the failed line side optical WDM signal to other line side optical WDM signals.

32. The device as in claim 1, comprises:
a signal monitoring mechanism that monitors line side optical WDM signals at the line side receivers and produces a feedback signal indicating whether one of the line side optical WDM signals fails; and
a feedback control unit that receives the feedback signal from the signal monitoring mechanism and operates to respond to a failure in a line side optical WDM signal by controlling the line side optical transmitters to distribute data carried by the failed line side optical WDM signal to other line side optical WDM signals.

33. The device as in claim 1, wherein:
each of the signal processing circuits comprises a low pass electrical filter to spectrally shape a respective electrical signal.

34. The device as in claim 33, comprising:
a polarization scrambler in the optical path of the line side output WDM signal downstream from the WDM multiplexer to scramble polarization of the line side output WDM signal before the line side output WDM signal is transmitted a fiber network.

35. The device as in claim 1, wherein:
the line side output WDM signal comprises two orthogonally polarized signals at each WDM wavelength and each of the two orthogonally polarized signals has a line side data rate that is one half of the client side data rate in each client optical signal, and
the device comprises:
a receiver polarization controller upstream from the WDM demultiplexer, one for each WDM wavelength, to receive the input line side optical WDM signal, and
a polarization splitter coupled between the receiver polarization controller and the WDM demultiplexer to separate light from the receive polarization controller into a first optical signal part and a second optical signal part that are orthogonally polarized to each other to separate the polarization multiplexed signals in combination of a polarization control by the receiver polarization controller, and
wherein the WDM demultiplexer separates the first optical signal part and the second optical signal part into the line side optical WDM signals into different optical paths, and
the line side optical receivers directly receive, respectively, the line side optical WDM signals to produce a plurality of line side electrical signals that respectively correspond to the line side optical WDM signals.

36. The device as in claim 35, comprising:
a polarization scrambler in the optical path of the line side output WDM signal downstream from the WDM multiplexer to scramble polarization of the line side output WDM signal before the line side output WDM signal is transmitted to a fiber network.

37. The device as in claim 1, wherein:
each line side optical transmitter performs the signal modulation in a NRZ/OOK modulation format.

38. The device as in claim 37:
the channel spacing between the line side optical wavelengths is between 10 and 12.5 GHz.

39. The device as in claim 1, comprising:
a polarization scrambling mechanism to scramble polarization of the line side output WDM signal to reduce one or more optical polarization dependent effects on a signal detected at a respective line side receiver.

40. The device as in claim 1, wherein:
a signal modulation mechanism in the line side optical transmitters to perform a signal modulation on light and to control a relative phase between two adjacent optical signals to be orthogonal to each other.

41. The device as in claim 40, wherein:
the signal modulation mechanism comprises an optical comb generator to produce optical combs at the different WDM wavelengths based optical single-sideband modulation of a single CW laser beam, and
the optical comb generator comprises a single CW laser that produces the single CW laser beam at a laser wavelength, microwave/millimeter-wave oscillators to produce oscillation signals at different frequencies with a frequency spacing equal to the data symbol rate and an optical modulator responsive to the oscillation signals in modulating the single CW laser beam to produce the optical combs.

42. The device as in claim 41, wherein:
the optical comb generator comprises adjustable phase control units respectively in the microwave/millimeter-wave oscillators to control individual phase values of the oscillation signals applied to the optical modulator to render a relative phase between two adjacent optical combs to be orthogonal to each other.

43. The device as in claim 1, wherein:
the client side optical signals have a number of optical signals different from a number of line side optical signals, and the client side data rate is different from a line side data rate of the line side optical signals, and
the device comprises:
a first electronic rate conversion mechanism that processes the electrical signals at the client side data rate to produce first converted electrical signals at the line side data rate to the line side optical transmitters, and
a second electronic rate conversion mechanism that processes the line side electrical signals at the line side data rate to produce second converted electrical signals at the client side data rate to the client side optical transmitters.

44. The device as in claim 1, wherein:
each line side optical transmitter has an operating data rate equal to the client side signal data rate plus 7% to 25% feed forward error correction (FEC) overhead.

45. The device as in claim 1, wherein:
the client side receivers are configured to receive a combination of client side signals that are in different 10 G signal protocols.

46. The device as in claim 45, wherein:
a client side signal is in a 10 GbE, OC-192, OUT-2, or 10 G Fiber Channel protocol.

47. The device as in claim 1, wherein:
the WDM multiplexer includes an optical coupler.

48. The device as in claim 1, wherein:
the WDM multiplexer includes a polarization combiner.

49. The device as in claim 1, wherein:
the WDM demultiplexer is an array-waveguide filter whose passbands repeat in every ITU window.

50. The device as in claim 1, wherein:
a line side optical receiver is configured to directly detect a respective line side optical WDM signal without using an optical coherent oscillator signal.

51. The device as in claim 1, wherein:
a line side optical receiver is configured to detect a respective line side optical WDM signal by using a coherent detection that uses an optical coherent oscillator signal.

52. The device as in claim 1, comprising:
a transmitter convert circuit coupled to the transmitter signal processing circuits to render the output electrical signals to have (1) a different number than a number of the electrical signals from the client side optical receivers and (2) a different data bit rate than a data bit rate of the electrical signals from the client side optical receivers.

53. The device as in claim 1, comprising:
a receiver convert circuit coupled to the receiver signal processing circuits to render the output electrical signals to have (1) a different number than a number of the line side electrical signals from the line side optical receivers and (2) a different data bit rate than a data bit rate of the line side electrical signals from the line side optical receivers.

54. An optical WDM communication device for providing communications between client side equipment and a fiber network, comprising:
a plurality of client side electrical input ports to receive from the client side equipment, respectively, a plurality of client side electrical signals each having a client side data rate at approximately 10 Gb/s, wherein a sum of the client side data rates of the client side electrical signals is comparable to or greater than 40 Gb/s;
a plurality of transmitter signal processing circuits that respectively receive and process the electrical signals to produce output electrical signals;
a plurality of line side optical transmitters that receive the output electrical signals from the transmitter signal processing circuits, respectively, to produce a plurality of line side optical WDM signals at different WDM wavelengths carrying the electrical signals at a data symbol rate with a total capacity greater than 40 Gb/s, the line side optical WDM signals at different WDM wavelengths being located within a spectral window of 50 GHz or 100 GHz under the International Telecommunication Union, Telecommunication Sector (ITU-T) and having a frequency spacing between two adjacent optical WDM signals comparable to the symbol date rate or greater than the symbol data rate up to approximately two times of the data symbol rate;
a WDM multiplexer that multiplexes the line side optical WDM signals to produce a line side output WDM signal;
a WDM demultiplexer that receives an input line side optical WDM signal containing a plurality of line side optical WDM signals at the data symbol rate comparable to a frequency spacing between two adjacent optical WDM signals or less than the frequency spacing but greater than one half of the frequency spacing and separates the received input line side optical WDM signal into the plurality of line side optical WDM signals;
a plurality of line side optical receivers to receive, respectively, the line side optical WDM signals and to produce a plurality of line side electrical signals that respectively correspond to the line side optical WDM signals;
a plurality of receiver signal processing circuits that respectively receive and process the line side electrical signals from the line side optical receivers to produce client side electrical signals each at the client side data rate of approximately 10 Gb/s; and
a plurality of client side electrical ports that receive the client side electrical signals from the line side signal processing circuits, respectively.

55. The device as in claim 54, wherein:
the line side optical transmitters are selected to have a channel spacing of between 12.5 and 25 GHz when each line side optical transmitter is operated at approximately 10 Gbaud.

56. The device as in claim 54, wherein:
each line side optical transmitter has an operating data rate equal to the client side signal data rate plus 7% to 25% feed forward error correction (FEC) overhead.

57. The device as in claim 54, wherein:
the client side receivers are configured to receive a combination of client side signals that are in different 10 G signal protocols.

58. The device as in claim 57, wherein:
a client side signal is in a 10 GbE, OC-192, OUT-2, or 10 G Fiber Channel protocol.

59. The device as in claim 54, wherein:
the WDM multiplexer includes an optical coupler.

60. The device as in claim 54, wherein:
the WDM multiplexer includes a polarization combiner.

61. The device as in claim 54, wherein:
the WDM demultiplexer is an array-waveguide filter whose passbands repeat in every ITU window.

62. The device as in claim 51, wherein:
a line side optical receiver is configured to directly detect a respective line side optical WDM signal without using an optical coherent oscillator signal.

63. The device as in claim 54, wherein:
a line side optical receiver is configured to detect a respective line side optical WDM signal by using a coherent detection that uses an optical coherent oscillator signal.

64. The device as in claim 54, wherein:
each line side optical transmitter performs a signal modulation in the microwave/millimeter-wave domain and applies a modulated microwave/millimeter-wave signal to modulate an optical beam to produce a respective line side optical WDM signal at an optical WDM wavelength.

65. The device as in claim 64, wherein:
the signal modulation in the microwave/millimeter-wave domain performed is a microwave subcarrier modulation that produces the modulated microwave/millimeter-wave signal; and
the line side optical transmitter comprises a Mach-Zehnder optical modulator that performs an optical single sideband (OSSB) modulation in response to the modulated microwave/millimeter-wave signal to produce a respective line side optical WDM signal.

66. The device as in claim 65, comprising:
a plurality of receiver lasers to produce local laser carrier beams at different local laser carrier frequencies, respectively, that correspond to line side optical WDM signals, respectively; and
wherein each line side optical receiver comprises an optical detector that receives and detects both a respective line side optical WDM signal and a respective local laser carrier beam and performs an optical heterodyne detection to produce a respective line side electrical signal.

67. The device as in claim 64, wherein:
the signal modulation in the microwave/millimeter-wave domain is a microwave subcarrier modulation that produces the modulated microwave/millimeter-wave signal; and
the line side optical transmitter comprises a Mach-Zehnder optical modulator that performs an optical double sideband (ODSB) modulation in response to the modulated microwave/millimeter-wave signal to produce a respective line side optical WDM signal.

68. The device as in claim 67, comprising:
a plurality of receiver lasers to produce local laser carrier beams at different local laser carrier frequencies, respectively, that correspond to line side optical WDM signals, respectively; and
wherein each line side optical receiver comprises an optical detector that receives and detects both a respective line side optical WDM signal and a respective local laser carrier beam and performs an optical heterodyne detection to produce a respective line side electrical signal.

69. The device as in claim 64, wherein:
each line side optical receiver performs a signal demodulation in the optical domain in processing a respective line side optical WDM signal to produce a respective line side electrical signal to a respective client side optical transmitter.

70. The device as in claim 54, wherein:
each line side optical transmitter performs a signal baseband modulation in the optical domain to produce a respective line side optical WDM signal at an optical WDM wavelength; and
each line side optical receiver performs a signal demodulation in the microwave/millimeter-wave domain in processing a respective line side optical WDM signal to produce a respective line side electrical signal directed to a corresponding client side optical transmitter.

71. The device as in claim 70, wherein:
each line side optical transmitter operates to preserve an optical carrier separate in frequency from a respective line side optical WDM signal for transmission, and
each line side optical receiver comprises an optical detector that detects both a respective line side optical WDM signal and a respective optical carrier and performs an optical heterodyne detection to produce a respective line side electrical signal.

72. The device as in claim 71, wherein:
each line side optical transmitter comprises:
a laser to produce a CW laser beam at a laser frequency;
a Mach-Zehnder optical modulator to modulate the CW laser beam under control of a first electrical oscillation signal at a first frequency and carrying a baseband signal and a second electrical oscillation signal at a second, different frequency without carrying a baseband signal to produce a modulated optical signal; and
an optical filter downstream from the Mach-Zehnder modulator to suppress light at the laser frequency and to transmit light at a modulation sideband carrying the baseband signal as the respective line side optical WDM signal and another modulation sideband corresponding to the second electrical oscillation signal as the optical carrier.

73. The device as in claim 71, wherein:
each line side optical transmitter comprises:
a laser to produce a CW laser beam at a laser frequency;
a Mach-Zehnder optical modulator to modulate the CW laser beam under control of a first electrical oscillation signal at a first frequency to produce a modulated optical signal carrying first and second modulation sidebands on two sides of the laser frequency while suppressing light at the laser frequency;
an optical splitter to split the modulated optical signal into a first optical signal and a second optical signal in two separate optical paths;
a first optical filter that filters the first optical signal to transmit the first modulation sideband while suppressing the second modulation sideband to produce a first filtered optical signal;
a second optical filter that filters the second optical signal to transmit the second modulation sideband while suppressing the first modulation sideband to produce a second filtered optical signal;
a baseband optical modulator located downstream from the second optical filter to receive the second filtered optical signal and to perform a baseband optical modulation to impose a baseband signal onto the second modulation sideband in the second filtered optical signal; and
an optical combiner that combines the first filtered optical signal and the second filtered optical signal to produce a respective line side optical WDM signal where the respective optical WDM wavelength is at a wavelength of the second modulation sideband and the optical carrier is at the first modulation sideband.

74. The device as in claim 54, wherein:
each line side optical transmitter performs a signal baseband modulation in the optical domain to produce a respective long-haul optical signal at an optical WDM wavelength; and
each line side optical receiver performs a signal demodulation in the optical domain in processing a respective line side optical WDM signal to produce a respective line side electrical signal directed to a corresponding client side optical transmitter.

75. The device as in claim 74, wherein:
each line side optical transmitter performs a differential quadrature phase shift keying (DQPSK) modulation, and
each line side optical receiver performs a direct optical detection and demodulation of a DQPSK signal received by the line side optical receiver.

76. The device as in claim 75, wherein:
the line side optical transmitters are selected to have operating wavelengths with a channel spacing between 12.5 and 25 GHz when each line side optical transmitter is operated at approximately 10 Gbaud, and
each line side optical transmitter is coupled to log₂M of the output electrical signals.

77. The device as in claim 75, wherein:
the line side optical receiver comprises a delay interferometer with an optical delay less than one symbol duration to increase a free spectral range of the delay interferometer.

78. The device as in claim 77, wherein:
each line side optical transmitter performs a differential M-ary PSK modulation (DMPSK) modulation, and
each line side optical receiver performs a direct optical detection and demodulation of a DMPSK signal received by the line side optical receiver.

79. The device as in claim 78, wherein:
the line side optical transmitters are selected to have operating wavelengths with a channel spacing between 12.5 and 25 GHz when each line side optical transmitter is operated at approximately 10 Gbaud, and
each line side optical transmitter is coupled to log₂M of the output electrical signals.

80. The device as in claim 54, wherein:
two line side optical WDM signals at two adjacent optical WDM wavelengths have orthogonal optical polarizations.

81. The device as in claim 54, wherein:
each line side optical transmitter performs the signal modulation in a duobinary modulation format.

82. The device as in claim 54, wherein:
each line side optical transmitter performs the signal modulation in an NRZ/OOK modulation format.

83. The device as in claims 82:
the channel spacing between the lineside optical wavelengths is between 10 and 12.5 GHz.

84. The device as in claims 81:
the channel spacing between the lineside optical wavelengths is between 10 and 12.5GHz.

85. The device as in claim 54, wherein:
each line side optical transmitter performs a configurable signal modulation between a duobinary and a DPSK modulation format by changing the delay of a delay-and-add device located after the modulator driver.

86. The device as in claim 54, wherein:
each line side optical transmitter performs the signal modulation in a multiple level phase shifting keying (M-PSK) format.

87. The device as in claim 86, wherein:
the line side optical transmitters are selected to have operating wavelengths with a channel spacing between 12.5 and 25 GHz when each line side optical transmitter is operated at approximately 10 Gbaud, and
each line side optical transmitter (is coupled to log₂M of output electrical signals.

88. The device as in claim 54, wherein:
each line side optical transmitter performs the signal modulation in a multiple level quadrature amplitude modulation (M-QAM) format.

89. The device as in claim 88, wherein:
the line side optical transmitters are selected to have operating wavelengths with a channel spacing between 12.5 and 25 GHz when each line side optical transmitter is operated at approximately 10 Gbaud, and
each line side optical transmitter (is coupled to log₂M of output electrical signals.

90. The device as in claim 54, wherein:
each line side optical transmitter performs the signal modulation in a differential M-ary phase shift keying (DMPSK) format, and
each line side optical receiver receives, respectively, a respective line side optical WDM signal and a respective optical carrier to perform a coherent optical detection in generating a respective line side electrical signal.

91. The device as in claim 90, wherein:
the line side optical transmitters are selected to have operating wavelengths with a channel spacing between 12.5 and 25 GHz when each line side optical transmitter is operated at approximately 10 Gbaud, and
each line side optical transmitter is coupled to log₂M of the output electrical signals.

92. The device as in claim 90, comprising:
a mechanism to generate optical carriers and to mix the generated optical carriers with the line side optical WDM signals, respectively, at the line side optical receivers, for the coherent optical detection.

93. The device as in claim 90, comprising:
a mechanism to generate optical carriers that correspond to line side optical WDM signals at different WDM wavelengths, respectively, to mix the generated optical carriers with the line side optical WDM signals at the WDM multiplexer to produce the line side output WDM signal that contains the generated optical carriers.

94. The device as in claim 54, wherein:
each line side optical transmitter comprises:
a signal monitoring mechanism that monitors line side optical WDM signals and produces a feedback signal indicating whether one of the line side optical WDM signals fails; and
a feedback control unit that receives the feedback signal from the signal monitoring mechanism and operates to respond to a failure in a line side optical WDM signal by distributing data carried by the failed line side optical WDM signal to other line side optical WDM signals.

95. The device as in claim 54, wherein:
a signal monitoring mechanism that monitors line side optical WDM signals at the line side receivers and produces a feedback signal indicating whether one of received line side optical WDM signals fails; and
a feedback control unit that receives the feedback signal from the signal monitoring mechanism and operates to respond to a failure in a line side optical WDM signal by controlling the line side optical transmitters to distribute data carried by the failed line side optical WDM signal to other line side optical WDM signals.

96. The device as in claim 54, wherein:
each of the signal processing circuits comprises a low pass electrical filter to spectrally shape a respective electrical signal.

97. The device as in claim 54, wherein:
two adjacent optical WDM signals in the line side output WDM signal are orthogonally polarized to each other.

98. The device as in claim 97, comprising:
a polarization scrambler in the optical path of the line side output WDM signal downstream from the WDM multiplexer to scramble polarization of the line side output WDM signal before the line side output WDM signal is transmitted a fiber network.

99. The device as in claim 54, wherein:
the line side output WDM signal comprises two orthogonally polarized signals at each WDM wavelength and each of the two orthogonally polarized signals has a line side data rate that is one half of the client side data rate in each client optical signal, and
the device comprises:
a receiver polarization controller upstream from the WDM demultiplexer, one for each sub-wavelength to receive the input line side optical WDM signal, and
a polarization splitter coupled between the receiver polarization controller and the WDM demultiplexer to separate light from the receive polarization controller into a first optical signal part and a second optical signal part that are orthogonally polarized to each other to separate the polarization multiplexed signals in combination of a polarization control by the receiver polarization controller, and
wherein the WDM demultiplexer separates the first optical signal part and the second optical signal part into the line side optical WDM signals into different optical paths, and
the line side optical receivers directly receive, respectively, the line side optical WDM signals to produce a plurality of line side electrical signals that respectively correspond to the line side optical WDM signals.

100. The device as in claim 99, comprising:
a polarization scrambler in the optical path of the line side output WDM signal downstream from the WDM multiplexer to scramble polarization of the line side output WDM signal before the line side output WDM signal is transmitted to a fiber network.

101. The device as in claim 54, comprising:
a polarization scrambling mechanism to scramble polarization of the line side output WDM signal to reduce an adverse optical polarization dependent effect on a signal detected at a respective line side receiver.

102. The device as in claim 54, wherein:
a signal modulation mechanism in the line side optical transmitters to perform a signal modulation on light and to control a relative phase between two adjacent optical signals to be orthogonal to each other.

103. The device as in claim 102, wherein:
the signal modulation mechanism comprises an optical comb generator to produce optical combs at the different WDM wavelengths based optical single-sideband modulation of a single CW laser beam, and
the optical comb generator comprises a single CW laser that produces the single CW laser beam at a laser wavelength, microwave/millimeter-wave oscillators to produce oscillation signals at different frequencies with a frequency spacing equal to the data symbol rate and an optical modulator responsive to the oscillation signals in modulating the single CW laser beam to produce the optical combs.

104. The device as in claim 103, wherein:
the optical comb generator comprises adjustable phase control units respectively in the microwave/millimeter-wave oscillators to control individual phase values of the oscillation signals applied to the optical modulator to render a relative phase between two adjacent optical combs to be orthogonal to each other.46Z. The device as in claim 24, wherein:
the client side electrical signals have a number of electrical signals different from a number of line side optical signals, and the client side data rate is different from a line side data rate of the line side optical signals, and
the device comprises:
a first electronic rate conversion mechanism that processes the electrical signals at the client side data rate to produce first converted electrical signals at the line side data rate to the line side optical transmitters, and
a second electronic rate conversion mechanism that processes the line side electrical signals at the line side data rate to produce second converted electrical signals at the client side data rate to the client side electrical ports.

105. The device as in claim 54, comprising:
a transmitter convert circuit coupled to the transmitter signal processing circuits to render the output electrical signals to have (1) a different number than a number of the electrical signals from the client side optical receivers and (2) a different data bit rate than a data bit rate of the electrical signals from the client side optical receivers.

106. The device as in claim 54, comprising:
a receiver convert circuit coupled to the receiver signal processing circuits to render the client side electrical signals to have (1) a different number than a number of the line side electrical signals from the line side optical receivers and (2) a different data bit rate than a data bit rate of the line side electrical signals from the line side optical receivers.

107. An optical WDM communication device, comprising: an electrical time-division-multiplexing (TDM) demultiplexer connected to receive a client side electrical signal having a client side data rate at approximately 40 Gb/s and to split the client side electrical signal into a plurality of parallel electrical signals at approximately 10 Gb/s;
a plurality of signal processing circuits that respectively receive and process the electrical signals;
a plurality of line side optical transmitters that receive the electrical signals from the signal processing circuits, respectively, to produce a plurality of line side optical WDM signals at different WDM wavelengths, the line side optical WDM signals at different WDM wavelengths being located within an ITU spectral window and each line side optical WDM signal carrying data in log₂M different client side electrical signals so that a number of the line side optical WDM signals is 1/log₂M of a number of client side electrical signals where M is the number of constellations;
a WDM multiplexer that multiplexes the line side optical WDM signals to produce a line side output WDM signal;
a WDM demultiplexer that receives an input line side optical WDM signal containing a plurality of line side optical WDM signals and separates the received input line side optical WDM signal into the plurality of line side optical WDM signals;
a plurality of line side optical receivers to receive, respectively, the line side optical WDM signals and to produce a plurality of line side electrical signals from the line side optical WDM signals;
a plurality of signal processing circuits that respectively receive and process the line side electrical signals;
a TDM multiplexer with skew control that combines the line side electrical signals into a client electrical signal at a data rate that is a sum of data rates of the line side electrical signals.

108. The device as in claim 107, wherein:
the line side optical transmitters are selected to have a channel spacing of between the per channel symbol rate and approximately two times of the symbol rate when each line side optical transmitter is operated at approximately 10 Gbaud.

109. The device as in claim 107, wherein:
each line side optical transmitter has an operating data rate equal to the client side signal data rate plus 7% to 25% feed forward error correction (FEC) overhead.

110. The device as in claim 107, wherein:
the client side receivers are configured to receive a combination of client side signals that are in different 10 G signal protocols.

111. The device as in claim 110, wherein:
a client side signal is in a 10 GbE, OC-192, OUT-2, or 10 G Fiber Channel protocol.

112. The device as in claim 107, wherein:
the WDM multiplexer includes an optical coupler.

113. The device as in claim 107, wherein:
the WDM multiplexer includes a polarization combiner.

114. The device as in claim 107, wherein:
the WDM demultiplexer is an array-waveguide filter whose passbands repeat in every ITU window.

115. The device as in claim 107, wherein:
a line side optical receiver is configured to directly detect a respective line side optical WDM signal without using an optical coherent oscillator signal.

116. The device as in claim 107, wherein:
a line side optical receiver is configured to detect a respective line side optical WDM signal by using a coherent detection that uses an optical coherent oscillator signal.

117. The device as in claim 107, wherein the line side optical transmitters are operable to make line side optical WDM signals have a frequency spacing between two adjacent optical WDM signals comparable to the symbol date rate or greater than the symbol data rate up to approximately two times of the data symbol rate.

118. The device as in claim 107, wherein each line side optical transmitter comprises a NRZ/OOK modulator, or a duobinary modulator, or a vector optical modulator that applies log₂M client side electrical signals to modulate a laser beam based on a M-ary multi-level (M-QAM) or multi-phase (M-PSK) signal modulation to produce a modulated laser beam as a line side optical WDM signal.

119. The device as in claim 107, wherein each line side optical transmitter comprises a vector optical modulator that applies two client side electrical signals to modulate a laser beam based on a M-PSK signal modulation to produce a modulated laser beam as a line side optical WDM signal.

120. The device as in claim 107, wherein each line side optical transmitter comprises a vector optical modulator that applies two client side electrical signals to modulate a laser beam based on a M-QAM signal modulation to produce a modulated laser beam as a line side optical WDM signal.

121. The device as in claim 107, comprising:
a polarization scrambling mechanism to scramble polarization of the line side output WDM signal to reduce an effect of polarization mode dispersion on a signal detected at a respective line side receiver.

122. The device as in claim 107, wherein:
a signal modulation mechanism in the line side optical transmitters to perform a signal modulation on light and to control a relative phase between two adjacent optical signals to be orthogonal to each other.

123. The device as in claim 122, wherein:
the signal modulation mechanism comprises an optical comb generator to produce optical combs at the different WDM wavelengths based optical single-sideband modulation of a single CW laser beam, and
the optical comb generator comprises a single CW laser that produces the single CW laser beam at a laser wavelength, microwave/millimeter-wave oscillators to produce oscillation signals at different frequencies with a frequency spacing equal to the data symbol rate and an optical modulator responsive to the oscillation signals in modulating the single CW laser beam to produce the optical combs.

124. The device as in claim 123, wherein:
the optical comb generator comprises adjustable phase control units respectively in the microwave/millimeter-wave oscillators to control individual phase values of the oscillation signals applied to the optical modulator to render a relative phase between two adjacent optical combs to be orthogonal to each other.

125. A method for providing long-haul optical communications at data bit rates of 40 Gb/s or higher in a fiber system designed for low data bit rates approximately at 10 Gb/s, comprising:
performing low-pass signal filtering to each of a plurality of low rate electronic signals with a data bit rate approximately at 10 Gb/s to produce a plurality of filtered electronic signals, thus reducing adjacent-channel interference and an inter-symbol-interference effect;
applying a spectrally efficient signal modulation scheme to modulate a plurality of CW laser beams at different optical carrier wavelengths by using the filtered electronic signals to produce optical WDM channel signals that respectively carry data of low rate electronic signals and have a channel spacing comparable to a data symbol rate of the low speed electronic signals or greater than the data symbol rate up to approximately twice the data symbol rate;
controlling polarization of each of the optical WDM channel signals to make two optical WDM channel signals adjacent in optical frequency orthogonally polarized to each other; and
combining the optical WDM channel signals into a single fiber connected to the fiber system designed for the low data bit rate to transmit the optical WDM channel signals in the fiber system.

126. The method as in claim 125, wherein:
the spectrally efficient signal modulation format is an NRZ/OOK modulation format.

127. The method as in claim 125, wherein:
the spectrally efficient signal modulation format is a duobinary modulation format.

128. The method as in claim 125, wherein:
the spectrally efficient signal modulation format is a multiple level phase shifting keying (M-PSK) format.

129. The method as in claim 125, wherein:
the spectrally efficient signal modulation format is a multiple level quadrature amplitude modulation (M-QAM) format.

130. The method as in claim 125, wherein:
the spectrally efficient signal modulation format is a differential M-ary phase shift keying (DMPSK) format.

131. The method as in claim 1125, comprising:
using a direct or coherent detection to detect received optical WDM channel signals that carry the low rate electronic signals and to recover the electronic signal at the high data bit rate from the low rate electronic signals.

132. The method as in claim 125, comprising:
scrambling the optical WDM channel signals prior to sending the optical WDM channel signals into the single fiber to reduce an adverse optical polarization dependent effect on detection of each optical WDM channel signal at an optical receiver.

133. A method for upgrading a long-haul optical fiber communication system designed for aggregating 10 Gb/s signals to transmit signals at high data bit rates of 40 Gb/s or higher, comprising:
maintaining existing fiber network infrastructure without modification;
in each communication node in the system, converting a high speed signal at a high data bit rate of 40 Gb/s or higher to be transmitted in the system into a plurality of low speed electronic signals at the low data bit rate, applying a spectrally efficient signal modulation scheme to modulate a plurality of optical carriers at different optical carrier wavelengths to produce optical WDM channel signals that carry the low speed electronic signals at a data symbol rate approximately equal to 10 Gbaud and with a total capacity greater than 40 Gb/s, the optical WDM channel signals at different WDM wavelengths being located within an ITU spectral window under ITU-T and having a frequency spacing between two adjacent optical WDM channel signals comparable to the symbol date rate or greater than the symbol data rate up to approximately two times of the data symbol rate, and combining the optical WDM channel signals into a single fiber connected to the fiber system to transmit the optical WDM channel signals through the existing fiber network infrastructure to another node.

134. The method as in claim 133, comprising:
scrambling the optical WDM channel signals prior to sending the optical WDM channel signals into the single fiber to reduce the effects of PDG, PDL, and PMD on detection of each optical WDM channel signal at an optical receiver.

135. The method as in claim 133, comprising:
using an optical comb generator in the line side optical transmitters, where the optical combs are generated via optical single-sideband modulation and multiple microwave/millimeter-wave oscillators. The frequency spacing between microwave/millimeter-wave oscillators is made equal to the symbol rate, and the phase of each microwave/millimeter-wave oscillator is controlled similar to the digital OFDM technique in such a way that any two neighbor channels are orthogonal to each other.

136. An optical WDM communication device, comprising:
a plurality of client side optical receivers as client side input ports to receive, respectively, a plurality of client side optical WDM signals at different WDM wavelengths and to produce a plurality of client side electrical signals that respectively correspond to the optical WDM signals;
a transmitter signal processing circuit that receives and processes the client side electrical signals to produce a different number of line side electrical signals each at a line side data rate that is different from a data rate of each client side electrical signal;
a plurality of line side optical transmitters that receive the line side electrical signals, respectively, to produce a plurality of line side optical WDM signals at different WDM wavelengths carrying the electrical signals at a data symbol rate with a total capacity greater than 40 Gb/s, the line side optical WDM signals at different WDM wavelengths being located within a spectral window of 50 GHz or 100 GHz and having a frequency spacing between two adjacent optical WDM signals comparable to the symbol date rate or greater than the symbol data rate up to approximately two times of the data symbol rate;
a WDM multiplexer that multiplexes the line side optical WDM signals to produce a line side output WDM signal;
a WDM demultiplexer that receives an input line side optical WDM signal containing a plurality of line side optical WDM signals at the data symbol rate comparable to a frequency spacing between two adjacent optical WDM signals or less than the frequency spacing but greater than one half of the frequency spacing and separates the received input line side optical WDM signal into the plurality of line side optical WDM signals;
a plurality of line side optical receivers to receive, respectively, the line side optical WDM signals and to produce a plurality of line side electrical signals that respectively correspond to the line side optical WDM signals;
a receiver signal processing circuit that receives and processes the line side electrical signals to produce a different number of client side electrical signals each at the client side data rate that is different from the line side data rate of each line side electrical signal; and
a plurality of client side optical transmitters that receive the client side electrical signals, respectively, to produce a plurality of client side optical WDM signals at different WDM wavelengths carrying the client side electrical signals.

137. The device as in claim 136, comprising:
a polarization scrambling mechanism to scramble polarization of the line side output WDM signal to reduce an effect of polarization mode dispersion on a signal detected at a respective line side receiver.

138. The device as in claim 136, wherein:
an RF or microwave/millimeter-wave modulation mechanism in the line side optical transmitters to perform microwave/millimeter-wave modulation on light and to control a relative phase between two adjacent line side optical signals to be orthogonal to each other.

139. The device as in claim 136, wherein:
a line side optical receiver is configured to directly detect a respective line side optical WDM signal without using an optical coherent oscillator signal.

140. The device as in claim 136, wherein:
a line side optical receiver is configured to detect a respective line side optical WDM signal by using a coherent detection that uses an optical coherent oscillator signal.

141. An optical fiber communication system for long-haul communications at high data bit rates of 40 Gb/s or higher, comprising:
an optical fiber transport network comprising long-haul fiber communication links that are designed for transmitting optical WDM signals at 10 Gb/s with acceptable signal transmission quality under optical impairments caused by optical effects including at least chromatic dispersion, polarization mode dispersion and optical noise associated with the low data bit rate;
a first communication node connected to the optical fiber transport network and comprising:
an electronic communication device that produces a high-speed electronic signal at a high data bit rate of 40 Gb/s or higher to be transmitted in the optical fiber transport network;
an electronic time-division-multiplexing (TDM) demultiplexer connected to receive the high-speed electronic signal and splits the high-speed electronic signal into a plurality of parallel low-speed electronic signals at a data rate of approximately 10 Gb/s;
a plurality of short-haul electronic-to-optical conversion modules that respectively receive the parallel low-speed electronic signals and respectively convert the received parallel low-speed electronic signals into a plurality of parallel optical signals that respectively carry the parallel low-speed electronic signals;
a short-haul optical link that connects to the short-haul electronic-to-optical conversion modules to transmit the parallel optical signals;
a plurality of short-haul optical-to-electronic conversion modules connected to the short-haul optical link to respectively receive and convert the parallel optical signals into intermediate parallel low-speed electronic signals at a predetermined low data bit rate of approximately 10 Gb/s;
a plurality of long-haul electronic-to-optical conversion modules that respectively receive the parallel intermediate low-speed electronic signals at approximately 10 Gb/s and respectively convert the received parallel intermediate low-speed electronic signals into a plurality of parallel long-haul optical signals of different optical WDM wavelengths at a data rate of approximately at 10 Gb/s that respectively carry the parallel intermediate low-speed electronic signals, wherein the long-haul electronic-to-optical conversion modules perform a spectrally efficient signal modulation in either the electronic domain or the optical domain at the approximately 10 Gbaud in producing the parallel long-haul optical signals, and wherein a frequency spacing between two adjacent WDM wavelengths is comparable to 10 GHz or greater than the data symbol rate up to approximately twice the data symbol rate; and
an optical WDM multiplexer that receives the parallel long-haul optical signals from the long-haul electronic-to-optical conversion modules and combines the parallel long-haul optical signals into a single optical fiber link to the optical fiber transport network; and
a second communication node connected to the optical fiber transport network and comprising:
an optical WDM demultiplexer that receives the parallel long-haul optical signals from the optical fiber transport network and separates the parallel long-haul optical signals along parallel optical paths, one long-haul optical signal per path, respectively;
a plurality of long-haul optical-to-electronic conversion modules that are respectively connected in the parallel optical paths to convert the parallel long-haul optical signals into low-speed electronic signals at approximately 10 Gb/s, respectively;
a plurality of short-haul electronic-to-optical conversion modules that respectively receive the parallel 10 Gb/s electronic signals and respectively convert the received parallel 10 Gb/s electronic signals into a plurality of parallel optical signals that respectively carry the parallel 10 Gb/s electronic signals;
a short-haul optical link that connects to the short-haul electronic-to-optical conversion modules to transmit the parallel optical signals;
a plurality of short-haul optical-to-electronic conversion modules connected to the short-haul optical link to respectively receive and convert the parallel optical signals into intermediate parallel 10 Gb/s electronic signals; and
an electronic TDM multiplexer with skew control connected to receive the intermediate low-speed electronic signal and combine the intermediate 10 Gb/s electronic signal into a high-speed electronic signal at a high data rate greater than approximately 40 Gb/s.

142. The system as in claim 141, wherein:
the optical WDM demultiplexer in the second communication node comprises:
an optical de-interleaver that selects odd numbered long-haul optical signals and their associated carriers to output as a first output optical beam and even numbered long-haul optical signals and their associated carriers to output as a second, separate output optical beam;
a first optical WDM demultiplexer that receives the first output optical beam and separates the odd numbered long-haul optical signals to separately propagate along a first portion of the parallel optical paths, one long-haul optical signal per path; and
a second optical WDM demultiplexer that receives the second output optical beam and separates the even numbered long-haul optical signals to separately propagate along a second portion of the parallel optical paths, one long-haul optical signal per path.

143. The system as in claim 142, wherein:
each long-haul optical-to-electronic conversion module comprises:
an optical detector in a respective optical path from one of the first and the second optical WDM demultiplexers to convert a respective long-haul optical signal into a detector signal;
a microwave/millimeter-wave demodulator that receives the detector signal from the optical detector and demodulates the detector signal to produce a respective low-speed electronic signal at approximately 10 Gb/s that is received by a corresponding short-haul electronic-to-optical conversion module.

144. The system as in claim 142, wherein:
each long-haul optical-to-electronic conversion module comprises:
an optical detector in a respective optical path from one of the first and the second optical WDM demultiplexers to convert a respective long-haul optical signal into microwave/millimeter-wave signal via self-heterodyned detection;
an microwave/millimeter-wave demodulator that receives the detector signal from the optical detector and demodulates the detector signal to produce a respective low-speed electronic signal at approximately 10 Gb/s that is received by a corresponding short-haul electronic-to-optical conversion module.

145. The system as in claim 142, wherein:
each long-haul electronic-to-optical conversion in the first communication node comprises:
a signal monitoring mechanism that monitors the parallel long-haul optical signals and produces a feedback signal indicating whether one of the parallel long-haul optical signals fails; and
a feedback control unit that receives the feedback signal from the signal monitoring mechanism and operates to respond to a failure in a long-haul optical signal by distributing data carried by the failed long-haul optical signal to other long-haul optical signals.

146. The system as in claim 141, wherein:
the second communication node comprises a signal monitoring mechanism that monitors the parallel long-haul optical signals received from the first communication node and produces a feedback signal indicating whether one of the parallel long-haul optical signals fails; and
each long-haul electronic-to-optical conversion in the first communication node comprises a feedback control unit that receives the feedback signal from the second communication node and operates to respond to a failure in a long-haul optical signal by distributing data carried by the failed long-haul optical signal to other long-haul optical signals.

147. An optical DWDM optical transceiver for providing optical communications at data bit rates of 40 Gb/s or higher per ITU-window, comprising:
two or more optical transceivers arranged to collectively transmit and receive signals at 40 Gb/s or higher, each optical transceiver operating at 20 Gb/s.

148. The system as in claim 147, wherein the system transmits at 40 Gb/s within a 50 GHz ITU-T window, and wherein each optical transceiver comprises two 20 Gb/s optical transceivers.

149. The system as in claim 147, wherein the system transmits at 100 Gb/s within a 100 GHz ITU-T window, and wherein each optical transceiver comprises five 20 Gb/s optical transceivers.

150. The system as in claim 147, wherein:
The basic add/drop granularity in the optical network with multiple optical nodes is 20 Gb/s;
at the drop port of a ROADM with channel spacing of 100 GHz or 50 Hz spacing, one or more tunable optical filters are connected to drop one or more selected 20 Gb/s signals, and reflected the remaining 20 Gb/s signals back to the main network.

151. An optical fiber communication system for long-haul communications at high data bit rates of 40 Gb/s or higher, comprising:
an optical fiber transport network comprising long-haul fiber communication links that are designed for transmitting optical WDM signals at approximately 10 Gb/s with acceptable signal transmission quality under optical impairments caused by optical effects including at least chromatic dispersion, polarization mode dispersion and optical noise associated with the low data bit rate;
a first communication node connected to the optical fiber transport network and comprising:
an electronic communication device that produces a high-speed electronic signal at a high data bit rate of 40 Gb/s or higher to be transmitted in the optical fiber transport network;
an electronic time-division-multiplexing (TDM) demultiplexer connected to receive the high-speed electronic signal and splits the high-speed electronic signal into a plurality of parallel low-speed electronic signals at a data rate not greater than approximately 10 Gb/s;
a plurality of long-haul electronic-to-optical conversion modules that respectively receive the parallel low-speed electronic signals into a plurality of parallel long-haul optical signals of different optical WDM wavelengths at a data rate at a data rate of approximately 10 Gbaud; and
an optical WDM multiplexer that receives the parallel long-haul optical signals from the long-haul electronic-to-optical conversion modules and combines the parallel long-haul optical signals into a single optical fiber link to the optical fiber transport network; and
a second communication node connected to the optical fiber transport network and comprising:
an optical WDM demultiplexer that receives the parallel long-haul optical signals from the optical fiber transport network and separates the parallel long-haul optical signals along parallel optical paths, one long-haul optical signal per path, respectively;
a plurality of long-haul optical-to-electronic conversion modules that are respectively connected in the parallel optical paths to convert the parallel long-haul optical signals into low-speed electronic signals, respectively; and
an electronic TDM multiplexer connected to receive the low-speed electronic signal and combine the low-speed electronic signal into a high-speed electronic signal at a high data rate.

152. The system as in claim 151, wherein:
a long-haul optical-to-electronic conversion module includes an optical receiver that is configured to directly detect a respective parallel long-haul optical without using an optical coherent oscillator signal.

153. The system as in claim 151, wherein:
a long-haul optical-to-electronic conversion module includes an optical receiver that is configured to detect a respective parallel long-haul optical by using a coherent detection that uses an optical coherent oscillator signal.

154. An optical DWDM optical transceiver for providing optical communications at data bit rates of 40 Gb/s or higher per ITU-window, comprising:
two or more optical transceivers arranged to collectively transmit and receive signals at 40 Gb/s or higher, each optical transceiver operating at 10 Gb/s.

155. The system as in claim 154, wherein the system transmits at 40 Gb/s within a 50 GHz ITU-T window, and wherein each optical transceiver comprises four 10 Gb/s optical transceivers.

156. The system as in claim 154, wherein the system transmits at 100 Gb/s within a 100 GHz ITU-T window, and wherein each optical transceiver comprises ten 10 Gb/s optical transceivers.

157. The system as in claim 154, wherein:
the basic add/drop granularity in the optical network with multiple optical nodes is 10 Gb/s;
at the drop port of a ROADM with channel spacing of 100 GHz or 50 Hz spacing, one or more tunable optical filters are connected to drop one or more selected 10 Gb/s signals, and reflected the remaining 10 Gb/s signals back to the main network.
